(19) United States
(12) Patent Application Publication
(10) Pub. No.: US 2020/0378491 A1
(43) Pub. Date: Dec. 3, 2020

(54) CONTROL SYSTEM FOR AN INFINITELY VARIABLE TRANSMISSION

(71) Applicant: DANA LIMITED, Maumee, OH (US)

(72) Inventors: JEFFREY M. DAVID, CEDAR PARK, TX (US); JYOTHSNA GANDHAM, HUNTINGTON BEACH, CA (US); GORDON M. MCINDOE, VOLENTE, TX (US); T. NEIL MCLEMORE, GEORGETOWN, TX (US); SIDHARTH RENGANATHAN, COLUMBUS, IN (US); VINAY SIKKA, PEORIA, IL (US); JAVIER SOLIS, LEANDER, TX (US)

(21) Appl. No.: 15/750,902

(22) PCT Filed: Aug. 5, 2016
(86) PCT No.: PCT/US2016/045857

§ 371 Date: Feb. 7, 2018

Related U.S. Application Data
(60) Provisional application No. 62/202,400, filed on Aug. 7, 2015.
(60) Provisional application No. 62/202,402, filed on Aug. 7, 2015.
(60) Provisional application No. 62/202,405, filed on Aug. 7, 2015.
(60) Provisional application No. 62/202,408, filed on Aug. 7, 2015.
(60) Provisional application No. 62/202,413, filed on Aug. 7, 2015.
(60) Provisional application No. 62/202,415, filed on Aug. 7, 2015.
(60) Provisional application No. 62/222,033, filed on Sep. 22, 2015.

(51) Int. Cl. F16H 59/70; F16H 59/44; F16H 59/42; F16H 59/54; F16H 59/18; F16H 61/02; F16H 61/664

(52) U.S. Cl. CPC F16H 59/70; F16H 59/44; F16H 59/42; F16H 59/54; F16H 2059/366; F16H 61/0213; F16H 61/664; F16H 2059/443; F16H 59/18

(57) ABSTRACT

Described herein is a control system for a vehicle having an infinitely variable transmission (WT) having a ball planetary variator (CVP), providing a smooth and controlled operation. In some embodiments, the vehicle is a fork lift truck. An operator commands a brake pedal, an accelerator pedal, and a direction switch (or gear selector), which are evaluated by the control system to determine a current operating state of the vehicle. Some operating states include, forward drive, reverse drive, vehicle braking, automatic deceleration, inching, power reversal, vehicle hold, and park, among others.

### CROSS-REFERENCES TO RELATED APPLICATIONS

The present application claims the benefit of U.S. Provisional Patent Application No. 62/202,400, filed Aug. 7, 2015 and U.S. Provisional Patent Application No. 62/202,402, filed Aug. 7, 2015, and U.S. Provisional Patent Application No. 62/202,405, filed Aug. 7, 2015, and U.S. Provisional Patent Application No. 62/202,408, filed Aug. 7, 2015, and U.S. Provisional Patent Application No. 62/202,413, filed Aug. 7, 2015, and U.S. Provisional Patent Application No. 62/202,415, filed Aug. 7, 2015, and U.S. Provisional Patent Application No. 62/222,033, filed Sep. 22, 2015, which applications are incorporated herein by reference.

### BACKGROUND OF THE INVENTION

Infinitely variable transmissions (IVT) and continuously variable transmissions (CVT) are becoming more in demand for a variety of vehicles as they offer performance and efficiency improvements over standard fixed gear transmissions. Certain types of IVTs and CVTs that employ ball-type continuously variable planetary (CVP) transmissions often have shift actuators coupled to the CVP for control of speed ratio during operation of the transmission. Implementation of an IVT into a vehicle such as a forklift truck can improve vehicle performance and efficiency. However, the process of controlling the ratio provided by the CVP is complicated due to the unique vehicle maneuvers known for operating a forklift truck. It is desirable for the transmission control system to manage the IVT under all common fork lift maneuvers. Therefore a new control method is needed to control the IVT during an inching maneuver, vehicle deceleration, and power reversal, among other driving conditions.

### SUMMARY OF THE INVENTION

Described herein is a control system for a vehicle having an infinitely variable transmission (IVT) having a ball planetary variator (CVP), providing a smooth and controlled operation. In some embodiments, the vehicle is a fork lift truck. An operator commands a brake pedal, an accelerator pedal, and a direction switch (or “gear selector”), which are evaluated by the control system to determine a current operating state of the vehicle. Some operating states include, forward drive, reverse drive, vehicle braking, automatic deceleration, inching, power reversal, vehicle hold, and park, among others.

Provided herein is a computer-implemented control system for a vehicle having an engine coupled to an infinitely variable transmission having a ball-planetary variator (CVP), the computer-implemented control system comprising: a digital processing device comprising an operating system configured to perform executable instructions and a memory device; a computer program including the instructions executable by the digital processing device, the computer program comprising a software module configured to control a plurality of operating conditions of the CVP; a plurality of sensors comprising: a vehicle direction sensor configured to sense a direction of the vehicle and provide the vehicle direction to the software module, a vehicle speed sensor configured to sense a vehicle speed and provide the vehicle speed to the software module, a brake pedal position sensor configured to sense a brake pedal position and provide the brake pedal position to the software module, an accelerator pedal position sensor configured to sense an accelerator pedal position and provide the accelerator pedal position to the software module, an engine speed sensor configured to sense an engine speed and provide the engine speed to the software module, a CVP input speed sensor configured to sense a CVP input speed and provide the CVP input speed to the software module, and a CVP output speed sensor configured to sense a CVP output speed and provide the CVP output speed to the software module, wherein the software module determines a current CVP speed ratio based on the CVP input speed and the CVP output speed, wherein the software module is configured to determine a target CVP speed ratio signal based on the accelerator pedal position, wherein the software module is configured to transmit a commanded CVP speed ratio signal based on the target CVP speed ratio signal to thereby adjust the operating condition of the CVP, wherein the software module comprises: a normal operation control sub-module configured to calculate the target CVP speed ratio based on the vehicle speed and the accelerator pedal position; an inching control sub-module configured to calculate the target CVP speed ratio based on the vehicle direction, the brake pedal position, and the engine speed; a power reversal control sub-module configured to calculate the target CVP speed ratio based on the current CVP speed ratio and the engine speed; and an automatic deceleration control sub-module configured to calculate the target CVP speed ratio based on the current CVP speed ratio, the vehicle speed, and the engine speed. In some embodiments of the computer-implemented control system, the software module further comprises a transition control sub-module configured to calculate the target CVP speed ratio based on the engine speed and the current CVP speed ratio. In some embodiments of the computer-implemented control system, the software module further comprises a hold control sub-module configured to calculate a target CVP speed ratio based on the accelerator pedal position, the brake pedal position, and the vehicle speed. In some embodiments of the computer-implemented control system, the software module further comprises a vehicle braking control sub-module configured to calculate a target CVP speed ratio based on the brake pedal position, the vehicle direction, and the current CVP speed ratio. In some embodiments of the computer-implemented control system, the normal operation control sub-module comprises a driving ratio map configured to determine a target CVP speed ratio based at least in part on the accelerator pedal position and the vehicle speed. In some embodiments of the computer-implemented control system, the normal operation control sub-module comprises a rate limit function configured to limit a rate of change of the target CVP speed ratio based at least in part on the vehicle speed. In some embodiments of the computer-implemented control system, the power reversal control sub-module further comprises an engine overspeed protection sub-module configured to command a hold of the commanded CVP speed ratio based at least in part on the engine speed and the vehicle direction. In some embodiments of the computer-implemented control system, the inching control sub-module comprises at least one calibration table defining a relationship between the brake pedal position and the vehicle speed. In some embodiments of the computer-implemented control system, the inching control sub-module comprises a function configured to determine the target CVP speed ratio based at least in part on a target vehicle speed and the engine speed. In some embodiments of the computer-implemented control system, the inching control sub-module comprises a rate limit function configured to limit a rate of change of the target CVP speed ratio based at least in part on the vehicle speed. In some embodiments of the computer-implemented control system, the automatic deceleration control sub-module comprises an engine overspeed protection sub-module configured to command a hold of the commanded CVP speed ratio based at least in part on the engine speed and the vehicle direction. In some embodiments of the computer-implemented control system, the automatic deceleration control sub-module comprises a rate limit function configured to limit a rate of change of the target CVP speed ratio based at least in part on the vehicle speed. In some embodiments of the computer-implemented control system, the vehicle direction, vehicle speed, brake pedal position, and accelerator pedal position are received from a vehicle CAN bus. In some embodiments of the computer-implemented control system, the normal operation control sub-module comprises a vehicle speed calibration map, the vehicle speed calibration map configured to store values of a target vehicle speed based at least in part on the accelerator pedal position. In some embodiments of the computer-implemented control system, the normal operation control sub-module comprises an engine speed calibration map, the engine speed calibration map configured to store values of a target engine speed based at least in part on the accelerator pedal position. In some embodiments of the computer-implemented control system, the inching control sub-module comprises an engine speed calibration map, the engine speed calibration map configured to store values for a target engine speed based at least in part on the accelerator pedal position. In some embodiments of the computer-implemented control system, the power reversal control sub-module comprises an engine speed calibration map, the engine speed calibration map configured to store values of a target engine speed based at least in part on the accelerator pedal position. In some embodiments of the computer-implemented control system, the transition control sub-module comprises an engine speed calibration map, the engine speed calibration map configured to store values for a target engine speed based at least in part on the accelerator pedal position. In some embodiments of the computer-implemented control system, the inching control sub-module further comprises an inching shift rate calibration map, the inching shift rate calibration map configured to store values of a commanded shift rate based at least in part on a shift error, wherein the shift error is calculated by the software module based at least in part on the current CVP speed ratio. In some embodiments of the computer-implemented control system, the normal operation control sub-module further comprises an inching shift rate calibration map, the inching shift rate calibration map configured to store values of a commanded shift rate based at least in part on a shift error, wherein the shift error is calculated by the software module based at least in part on the current CVP speed ratio. In some embodiments of the computer-implemented control system, the power reversal control sub-module further comprises a plurality of shift rate calibration maps, each shift rate calibration map configured to store values of a commanded shift rate based at least in part on a vehicle speed and a shift rate level, wherein the shift rate level is a calibratable value stored in the memory device.

Provided herein is a computer-implemented system for controlling an auto-deceleration of a vehicle having an engine coupled to an infinitely variable transmission having a ball-planetary variator (CVP), the computer-implemented system comprising: a digital processing device comprising an operating system configured to perform executable instructions and a memory device; a computer program including the instructions executable by the digital processing device, the computer program comprising a software module configured to control the auto-deceleration of the vehicle; a plurality of sensors comprising: a vehicle speed sensor adapted to sense a vehicle speed and provide the vehicle speed to the software module, a brake pedal position sensor adapted to sense a brake pedal position and provide the brake pedal position to the software module, an accelerator pedal position sensor adapted to sense an accelerator pedal position and provide an accelerator pedal position to the software module, an engine speed sensor adapted to sense an engine speed and provide an engine speed to the software module, a CVP input speed sensor configured to sense a CVP input speed and provide the CVP input speed to the software module, and a CVP output speed sensor configured to sense a CVP output speed and provide the CVP output speed to the software module, wherein the software module determines a current CVP speed ratio based on the CVP input speed and the CVP output speed, and wherein the software module determines a commanded CVP speed ratio during the auto-deceleration of the vehicle, wherein the commanded CVP speed ratio signal is based on a current operating state of vehicle, the vehicle speed, the brake pedal position, the accelerator pedal position, the engine speed, and the current CVP speed ratio; and wherein the software module is configured to control the current speed ratio of CVP based on the commanded CVP speed ratio. In some embodiments of the computer-implemented system, the vehicle direction, vehicle speed, brake pedal position, and accelerator pedal position are received from a vehicle CAN bus. In some embodiments of the computer-implemented system, the software module further comprises a rate limit function configured to limit a rate of change of the commanded CVP speed ratio based at least in part on the vehicle speed.

Provided herein is a computer-implemented system for changing direction of a vehicle having an engine coupled to an infinitely variable transmission having a ball-planetary variator (CVP), the computer-implemented system comprising: a digital processing device comprising an operating system configured to perform executable instructions and a memory device; a computer program including the instructions executable by the digital processing device, the computer program comprising a software module configured to control the change of direction of the vehicle; a plurality of sensors comprising: a vehicle direction sensor adapted to sense a vehicle direction and provide the vehicle direction to the software module, a vehicle speed sensor adapted to sense a vehicle speed and provide the vehicle speed to the software module, an engine speed sensor adapted to sense an engine speed and provide the engine speed to the software module, a CVP input speed sensor configured to sense a CVP input speed and provide the CVP input speed to the software module, and a CVP output speed sensor configured to sense a CVP output speed and provide the CVP output speed to the software module, wherein the software module determines a current CVP speed ratio based on the CVP input speed and the CVP output speed, wherein the software module determines a commanded CVP speed ratio during the change of the direction of the vehicle, wherein the commanded CVP speed ratio is based at least in part on the vehicle direction, the vehicle speed, the engine speed, and the current CVP speed ratio; wherein the software module is configured to command an engine speed limit based at least in part on the vehicle direction and the vehicle speed; and wherein the software module is configured to control the current speed ratio of CVP based on the commanded CVP speed ratio. In some embodiments of the computer-implemented system, the vehicle speed is received from a vehicle CAN bus. In some embodiments of the computer-implemented system, the software module further comprises a rate limit function configured to limit a rate of change of the commanded CVP speed ratio based at least in part on the vehicle speed.

Provided herein is a computer-implemented system for generating an inching maneuver mode in a vehicle having an engine coupled to an infinitely variable transmission having a ball-planetary variator (CVP), the computer-implemented system comprising: a digital processing device comprising an operating system configured to perform executable instructions and a memory device; a computer program including the instructions executable by the digital processing device, the computer program comprising a software module configured to control the vehicle during the inching maneuver; a plurality of sensors comprising: a vehicle direction sensor adapted to sense a vehicle direction and provide the vehicle direction to the software module, a brake pedal position sensor adapted to sense a brake pedal position and provide the brake pedal position to the software module, an engine speed sensor adapted to sense an engine speed and provide the engine speed to the software module, wherein the software module determines a commanded CVP speed ratio during the inching maneuver, wherein the commanded CVP speed ratio is based at least in part on the vehicle direction, the brake pedal position, the accelerator pedal position, and the engine speed; and wherein the software module is configured to control the CVP based on the commanded CVP speed ratio. In some embodiments of the computer-implemented system, the vehicle direction and brake pedal position are received from a vehicle CAN bus. In some embodiments of the computer-implemented system, the software module further comprises a rate limit function configured to limit a rate of change of the commanded CVP speed ratio based at least in part on the vehicle speed.

Provided herein is a computer-implemented control system for regulating a deceleration of a vehicle having an engine coupled to an infinitely variable transmission (IVT) having a ball-planetary variator (CVP), the computer-implemented control system comprising: a digital processing device comprising an operating system configured to perform executable instructions and a memory device; a computer program including the instructions executable by the digital processing device, the computer program comprising a software module configured to control vehicle deceleration; a plurality of sensors comprising: a vehicle speed sensor adapted to sense a vehicle speed and provide the vehicle speed to the software module, a brake pedal position sensor adapted to sense a brake pedal position and provide the brake pedal position to the software module, a CVP input speed sensor configured to sense a CVP input speed and provide the CVP input speed to the software module, and a CVP output speed sensor configured to sense a CVP output speed and provide the CVP output speed to the software module, wherein the software module determines a current CVP speed ratio based on the CVP input speed and the CVP output speed; wherein the software module determines a commanded CVP speed ratio during the deceleration of the vehicle, wherein the commanded CVP speed ratio is based at least in part on the vehicle speed and the brake pedal position; and wherein the software module is configured to control the CVP based on the commanded CVP speed ratio. In some embodiments of the computer-implemented system, the vehicle speed and brake pedal position are received from a vehicle CAN bus. In some embodiments of the computer-implemented system, the software module further comprises a rate limit function configured to limit a rate of change of the commanded CVP speed ratio based at least in part on the vehicle speed.

Provided herein is a computer-implemented system for controlling an auto-deceleration of a vehicle having an engine coupled to an infinitely variable transmission having a ball-planetary variator (CVP), the computer-implemented system comprising: a digital processing device comprising an operating system configured to perform executable instructions and a memory device; a computer program including the instructions executable by the digital processing device, the computer program comprising a software module configured to control the auto-deceleration of the vehicle; a plurality of sensors comprising: a vehicle direction sensor adapted to sense a vehicle direction and provide the vehicle direction to the software module, a vehicle speed sensor adapted to sense a vehicle speed and provide the vehicle speed to the software module, a brake pedal position sensor adapted to sense a brake pedal position and provide the brake pedal position to the software module, an accelerator pedal position sensor adapted to sense an accelerator pedal position and provide the accelerator pedal position to the software module, an engine speed sensor adapted to sense an engine speed and provide the engine speed to the software module, and a CVP shift position sensor adapted to sense a current CVP shift position and provide the current CVP shift position to the software module, wherein the software module determines a commanded CVP shift position during the auto-deceleration of the vehicle, wherein the commanded CVP shift position is based on the vehicle direction, the vehicle speed, the brake pedal position, the accelerator pedal position, the engine speed, and the current CVP shift position; and wherein the software module is configured to control the CVP based on the commanded CVP shift position. In some embodiments of the computer-implemented control system, the commanded CVP shift position is adjusted to achieve an IVT zero condition of the vehicle. In some embodiments of the computer-implemented control system, wherein the CVP shift position is adjusted by an incremental value based on a desired deceleration rate of the vehicle. In some embodiments of the computer-implemented control system, wherein the desired deceleration rate of the vehicle is a user adjustable input to the software module. In some embodiments of the computer-implemented control system, the software module executes a command for a closed loop control of a CVP shift position. In some embodiments of the computer-implemented control system, an operator initiates the auto-deceleration of the vehicle while the vehicle is moving. In some embodiments of the computer-implemented control system, the software module executes commands for the controlled auto-deceleration of the vehicle when the data received from the sensors consists of: there is vehicle movement in a forward direction or a reverse direction, an accelerator pedal position (APP) equal to zero, and a brake pedal position (BPP) equal to zero. In some embodiments of the computer-implemented control system, the executed commands for auto-deceleration comprises: the vehicle movement in a forward direction, or the vehicle movement in a reverse direction, or the vehicle movement is either forward or reverse and the direction is set to neutral.

Provided herein is a computer-implemented method for auto-deceleration of a vehicle having an engine coupled to an infinitely variable transmission (IVT) having a ball-planetary variator (CVP), the vehicle comprising a plurality of sensors and a computer-implemented system comprising: a digital processing device comprising an operating system configured to perform executable instructions and a memory device, and a computer program including the instructions executable by the digital processing device, wherein the computer program comprises a software module configured to control deceleration of the vehicle; the method comprising controlling deceleration by: the software module receiving a plurality of signals from one or more sensors reflecting vehicle parameters sensed by the one or more sensors, the vehicle parameters comprising a vehicle direction, a vehicle speed, a brake pedal position, an accelerator pedal position, an engine speed, a CVP input speed, a CVP output speed, and a current CVP shift position; and the software module executing instructions based at least in part on the one or more vehicle parameters comprising: transmitting an engine speed limit command to the engine based at least in part on the vehicle direction, the vehicle speed, the accelerator pedal position, and the brake pedal position; monitoring the current CVP shift position, a current CVP speed ratio based upon the CVP input speed and the CVP output speed, and an engine speed limit read from the memory device; and changing the current CVP shift position based at least in part on the brake pedal position. In some embodiments of the computer-implemented method, the current CVP shift position achieves an IVT zero condition of the vehicle. In some embodiments of the computer-implemented method, changing the current CVP shift position comprising adjusting the current CVP shift position by an incremental value based on a desired deceleration rate. In some embodiments of the computer-implemented method, the desired deceleration rate is a user adjustable input value to the software module. In some embodiments of the computer-implemented method, the brake pedal position is zero. In some embodiments of the computer-implemented method, changing the current CVP shift position is based on a calibratable value stored in the memory device. In some embodiments of the computer-implemented method, the software module includes commanding a closed loop control of the current CVP speed ratio, and the software module commanding an engine controller to reduce an input torque supplied to the infinitely variable transmission. In some embodiments of the computer-implemented method, receiving an auto-deceleration initiation signal from an operator while the vehicle is moving. In some embodiments of the computer-implemented method, the software module automatically executing the method when: there is vehicle movement in a forward direction or a reverse direction, the accelerator pedal position (APP) is equal to zero, and the brake pedal position (BPP) is equal to zero. In some embodiments of the computer-implemented method, the software module executing the method when an operator initiates auto-deceleration and movement of the vehicle is in a forward direction, or movement of the vehicle is in a reverse direction, or movement of the vehicle is either in a forward direction or in a reverse direction and a direction setting is neutral.

Provided herein is a computer-implemented system for changing direction of a vehicle having an engine coupled to an infinitely variable transmission having a ball-planetary variator (CVP), the computer-implemented system comprising: a digital processing device comprising an operating system configured to perform executable instructions and a memory device; a computer program including the instructions executable by the digital processing device, the computer program comprising a software module configured to control a power reversal of the vehicle; a plurality of sensors comprising: a vehicle direction sensor adapted to sense a vehicle direction and provide the vehicle direction to the software module, a vehicle speed sensor adapted to sense a vehicle speed and provide the vehicle speed to the software module, a brake pedal position sensor adapted to sense a brake pedal position and provide the brake pedal position to the software module, an accelerator pedal position sensor adapted to sense an accelerator pedal position and provide the accelerator pedal position to the software module, an engine speed sensor adapted to sense an engine speed and provide the engine speed to the software module, and a CVP shift position sensor adapted to sense a current CVP shift position and provide the current CVP shift position to the software module, wherein the software module controls the CVP and the engine during a reversal of the vehicle direction; wherein the software module transmits a first command for an engine speed limit based at least in part on the current vehicle direction, the vehicle speed, the accelerator pedal position, and the brake pedal position; and wherein the software module transmits a second command for a change in the CVP shift position based at least in part on the engine speed. In some embodiments of the computer-implemented system, the command for a change in the CVP shift position is adjusted to achieve an engine speed below an overspeed condition of the engine, wherein the overspeed condition of the engine is a calibratable value stored in the memory device. In some embodiments of the computer-implemented system, the command for a change in the CVP shift position is adjusted by an incremental value based on a desired deceleration rate. In some embodiments of the computer-implemented system, the desired deceleration rate is a user adjustable input value to the software module. In some embodiments of the computer-implemented system, the command for a change in the CVP shift position is further based at least in part on the accelerator pedal position. In some embodiments of the computer-implemented system, the command for a change in the CVP shift position is a calibratable value stored in the memory device. In some embodiments of the computer-implemented system, the software module commands an engine speed corresponding to an engine idle speed, and the digital processing device reduces engine torque transmitted to the transmission. In some embodiments of the computer-implemented system, an operator initiates the change of direction of the vehicle while it is moving. In some embodiments of the computer-implemented system, the software module executes the controlled power reversal of the vehicle when: an operator-commanded change in direction, the accelerator pedal position being greater than zero, and the brake pedal position being equal to zero. In some embodiments of the computer-implemented system, the operator-commanded change in direction comprises: movement of the vehicle in a forward direction and the direction switch is set to reverse by the operator, or movement of the vehicle in a reverse direction and the direction switch is set to forward by the operator, or movement of the vehicle is either in the forward direction or the reverse direction and the direction switch is set to neutral by the operator.

Provided herein is a computer-implemented method for changing direction of a vehicle comprising an engine coupled to an infinitely variable transmission (IVT) having a ball-planetary variator (CVP), a direction switch, a plurality of sensors, and a computer-implemented system comprising: a digital processing device comprising an operating system configured to perform executable instructions and a memory device, and a computer program including the instructions executable by the digital processing device, wherein the computer program comprises a software module configured to change direction of the vehicle, the method comprising changing direction of the vehicle by: receiving first data from the direction switch indicating a desired vehicle direction; receiving second data from one or more of the sensors configured to sense a current vehicle direction, a vehicle speed, a brake pedal position, an accelerator pedal position, an engine speed, and a CVP shift position; executing the instructions to manage a controlled power reversal based on the desired vehicle direction, the vehicle speed, the brake pedal position, the accelerator pedal position, the engine speed and the CVP shift position; transmitting a first command for an engine speed limit based at least in part on the current vehicle direction, the vehicle speed, the accelerator pedal position, and the brake pedal position; monitoring an overspeed condition of the engine; and transmitting a second command for a change in the CVP shift position based at least in part on the engine speed. In some embodiments of the computer-implemented method, transmitting the second command comprises adjusting the engine speed below the overspeed condition. In some embodiments of the computer-implemented method, the change in the CVP shift position is an incremental value or amount based on a desired deceleration rate. In some embodiments of the computer-implemented method, the desired deceleration rate is a user adjustable input value to the software module. In some embodiments of the computer-implemented method, the change in the CVP shift position is based at least in part on the accelerator pedal position. In some embodiments of the computer-implemented method, the change in the CVP shift position is a calibratable value stored in the memory device. In some embodiments of the computer-implemented method, the software module commands the engine speed corresponding to an engine idle speed and wherein the method further comprises reducing engine torque transmitted to the infinitely variable transmission. In some embodiments of the computer-implemented method, changing direction of the vehicle is initiated by an operator of the vehicle while the vehicle is moving. In some embodiments of the computer-implemented method, the software module executes the changing direction of the vehicle when the first data received from the direction switch and the second data received the sensors comprises: an operator-commanded change in direction, the accelerator pedal position being greater than zero, and the brake pedal position being equal to zero. In some embodiments of the computer-implemented method, the operator-commanded change in direction comprises: movement of the vehicle in a forward direction and the direction switch is set to reverse by the operator, or movement of the vehicle in a reverse direction and the direction switch is set to forward by the operator, or movement of the vehicle is either in the forward direction or the reverse direction and the direction switch is set to neutral by the operator.

Provided herein is a computer-implemented system for controlling an inching maneuver in a vehicle having an engine coupled to an infinitely variable transmission having a ball-planetary variator (CVP), the computer-implemented system comprising: a digital processing device comprising an operating system configured to perform executable instructions and a memory device; a computer program including the instructions executable by the digital processing device, the computer program comprising a software module configured to control an inching maneuver in the vehicle; a plurality of sensors comprising: a vehicle direction sensor adapted to sense a vehicle direction and provide the vehicle direction to the software module, a vehicle speed sensor adapted to sense a vehicle speed and provide the vehicle speed to the software module, a brake pedal position sensor adapted to sense a brake pedal position and provide the brake pedal position to the software module, an accelerator pedal position sensor adapted to sense an accelerator pedal position and provide the accelerator pedal position to the software module, a CVP input speed sensor adapted to sense a CVP input speed and provide the CVP input speed to the software module; a CVP output speed sensor adapted to sense a CVP output speed and provide the CVP output speed to the software module, an IVT output speed sensor adapted to sense an IVT output speed and provide the IVT output speed to the software module, an engine speed sensor adapted to sense an engine speed and provide the engine speed to the software module, and a CVP shift position sensor adapted to sense a current CVP shift position and provide the current CVP shift position to the software module, wherein the software module controls the CVP and the engine during an inching maneuver; wherein the software module is configured to monitor a speed ratio signal of the CVP based on the CVP input speed and the CVP output speed; wherein the software module issues a first command for an engine speed based at least in part on the vehicle direction, the vehicle speed, and the accelerator pedal position; and wherein the software module issues a second command for a CVP shift position based at least in part on the brake pedal position. In some embodiments of the computer-implemented system, the software module is activated when the sensors detect a minimum position setting for both the brake pedal position and the accelerator pedal position. In some embodiments of the computer-implemented system, the software module commands an engine speed override limit to reduce the engine torque if the vehicle speed is in excess of speed limits set for the inching mode when transitioning into the inching maneuver. In some embodiments of the computer-implemented system, the command for a CVP shift position is adjusted towards IVT speed ratio zero condition as the value of the brake pedal position increases. In some embodiments of the computer-implemented system, the commanded CVP shift position signal is adjusted to an IVT speed ratio zero condition when the brake pedal position signal reaches or exceeds a maximum inching position threshold value regardless of the accelerator pedal position. In some embodiments of the computer-implemented system, the software module calculates an effective inching range between a minimum brake pedal inching position threshold value and maximum brake pedal inching position threshold value. In some embodiments of the computer-implemented system, the software module controls the inching of the vehicle when the brake pedal position exceeds the maximum brake pedal inching position threshold value. In some embodiments of the computer-implemented system, the software module commands a reference shift position based on the quantized BPP value, each BPP quanta adding or subtracting a position delta between the position range of 0 and Position_{inchMax}. In some embodiments of the computer-implemented system, a resolution of the quantization is set when a code for the software module is compiled. In some embodiments of the computer-implemented system, a hysteresis scheme is implemented to prevent excessive switching in the CVP shift position due to small oscillations in the brake pedal position. In some embodiments of the computer-implemented system, the maximum brake pedal inching position threshold value is a condition wherein a set of wheel brakes are engaged hard enough to prevent a vehicle from moving from a stand-still position. In some embodiments of the computer-implemented system, a brake position value between the maximum brake pedal inching position threshold value and a fully depressed brake pedal position will generate reference shift position that is saturated to zero. In some embodiments of the computer-implemented system, the software module controls the inching maneuver in a forward or reverse vehicle direction. In some embodiments of the computer-implemented system, the command for a CVP shift position takes on negative values when the inching maneuver mode is performed in a reverse vehicle direction. In some embodiments of the computer-implemented system, a change in the commanded CVP shift position is a calibratable value stored in the memory device. In some embodiments of the computer-implemented system, an operator initiates the inching maneuver of the vehicle while it is not moving. In some embodiments of the computer-implemented system, an operator initiates the inching maneuver of the vehicle while it is moving. In some embodiments of the computer-implemented system, the software module controls the inching maneuver when the data received from the sensors consists of: a detection of vehicle speed and direction, a detection of engine speed, a detection of CVP shift position, a detection of a minimum accelerator pedal position (APP) setting greater than zero, and a detection of a minimum brake pedal position (BPP) setting greater than zero; wherein the vehicle speed is within a preset limit less than full operation speed; and wherein the engine speed is within a preset limit that will safely produce torque deliverable to the CVP that will allow a safe change in the command for a CVP shift position. In some embodiments of the computer-implemented system, the minimum detectable threshold value for the accelerator pedal position (APP) setting is greater than 5%; and the minimum detectable threshold value for the brake pedal position (BPP) setting is greater than 6%. In some embodiments of the computer-implemented system, the executed inching maneuver comprises: the vehicle movement in a forward direction, or the vehicle movement in a reverse direction, or the vehicle movement in either forward direction or reverse direction and simultaneously elevating or lowering the payload lift apparatus, or elevating or lowering the payload lift apparatus alone without vehicle movement in either forward direction or reverse direction.

Provided herein is a computer-implemented method for inching a vehicle in a controlled manner, wherein the vehicle comprises an engine coupled to an infinitely variable transmission (IVT) having a ball-planetary variator (CVP), a plurality of sensors, and a computer-implemented system comprising: a digital processing device comprising an operating system configured to perform executable instructions and a memory device; and a computer program including the instructions executable by the digital processing device, wherein the computer program comprises a software module; the method comprising: controlling an inching maneuver of the vehicle by: one or more of the plurality of sensors sensing vehicle parameters comprising: a vehicle direction, a vehicle speed, a brake pedal position, an accelerator pedal position, a CVP input speed, a CVP output speed, an IVT output speed, an engine speed, and a CVP shift position; the software module monitoring the CVP shift position, a speed ratio of the CVP based on the CVP input speed and the CVP output speed, and an overspeed condition of the engine based one or more of the vehicle parameters sensed by the sensors; commanding a first change in the engine speed and controlling an engine torque based at least in part on the vehicle direction, the vehicle speed, and the accelerator pedal position sensed by the sensors; and commanding a second change in the CVP shift position based at least in part on the brake pedal position sensed by one or more of the sensors. In some embodiments of the computer-implemented method, activating the software module when the sensors detect a minimum position setting for both the brake pedal position and the accelerator pedal position. In some embodiments of the computer-implemented method, the software module commanding an engine speed override limit to reduce the engine torque if the vehicle speed is in excess of a speed limit set for the inching maneuver mode when transitioning into the inching maneuver mode. In some embodiments of the computer-implemented method, adjusting the second change towards an IVT speed ratio zero condition as a value of the brake pedal position increases. In some embodiments of the computer-implemented method, adjusting the second change to the IVT speed ratio zero condition when the brake pedal position reaches or exceeds a maximum inching position threshold value regardless of the accelerator pedal position. In some embodiments of the computer-implemented method, generating an effective inching maneuver range between a minimum threshold value of the brake pedal position and maximum threshold value of the brake pedal position. In some embodiments of the computer-implemented method, controlling the inching maneuver occurs when the brake pedal position exceeds the maximum threshold value brake pedal position. In some embodiments of the computer-implemented method, a hysteresis scheme is implemented to prevent excessive switching in the CVP shift position due to small oscillations in the brake pedal position. In some embodiments of the computer-implemented method, the maximum threshold value of the brake pedal position exists when a set of wheel brakes are engaged hard enough to prevent the vehicle from moving from a stand-still position. In some embodiments of the computer-implemented method, the brake pedal position between the maximum threshold value and a fully depressed brake pedal position will generate a reference shift position that is saturated to zero. In some embodiments of the computer-implemented method, controlling the inching maneuver occurs in a forward or reverse vehicle direction. In some embodiments of the computer-implemented method, the CVP shift position takes on a negative value when the method is performed in a reverse vehicle direction. In some embodiments of the computer-implemented method, the second change is a calibratable value stored in the memory device. In some embodiments of the computer-implemented method, controlling the inching maneuver occurs when initiated by an operator while the vehicle is not moving. In some embodiments of the computer-implemented method, controlling the inching maneuver occurs when initiated by an operator while the vehicle is moving. In some embodiments of the computer-implemented method, controlling the inching maneuver occurs when: the vehicle speed is within a first preset limit less than a full operation speed, the engine speed within a second preset limit that will safely produce torque deliverable to the CVP that will allow a safe change in the CVP shift position, the sensors sense the vehicle direction, the sensors sense the CVP shift position, the accelerator pedal position is at a first minimum setting greater than zero, and the brake pedal position is at a second minimum setting greater than zero. In some embodiments of the computer-implemented method, the first minimum setting for the accelerator pedal position (APP) 5%; and the second minimum setting for the brake pedal position (BPP) is greater than 6%. In some embodiments of the computer-implemented method, controlling the inching maneuver comprises: moving the vehicle in a forward direction; or moving the vehicle in a reverse direction; or moving the vehicle in either forward direction or reverse direction and simultaneously elevating or lowering a payload lift apparatus; or elevating or lowering the payload lift apparatus alone without moving the vehicle in either a forward direction or a reverse direction.

Provided herein is a computer-implemented control system for controlling a speed ratio droop of an infinitely variable transmission (IVT) having a ball planetary variator (CVP) operably coupled to gears, said IVT operably coupled to an engine of a vehicle, the computer-implemented control system comprising: a digital processing device comprising an operating system configured to perform executable instructions and a memory device; a computer program including the instructions executable by the digital processing device, the computer program comprising a software module configured to control the engine and the CVP; a plurality of sensors comprising: a CVP input speed sensor configured to sense a CVP input speed and provide the CVP input speed to the software module, and a CVP output speed sensor configured to sense a CVP output speed and provide the CVP output speed to the software module, wherein the software module determines a current CVP speed ratio based on the CVP input speed and the CVP output speed, and a CVP shift position sensor adapted to sense a current CVP shift position and provide the current CVP shift position to the software module, wherein the software module calculates a speed ratio droop based on the CVP input speed, the CVP output speed, and the CVP shift position; wherein the software module is configured to compare the speed ratio droop to a first warning fault threshold, wherein the first warning fault threshold is a calibratable parameter stored in the memory device; wherein the software module is configured to detect a gross slip of the ball planetary variator by comparing the speed ratio droop to a second (critical) warning fault threshold, wherein the second (critical) warning fault threshold is a calibratable parameter stored in the memory device; wherein the software module transmits a first command for a change in the CVP shift position based on the comparison of the speed ratio droop to the first warning fault threshold and the second (critical) warning fault threshold; wherein the software module transmits a second command for a change in CVP input speed based on the comparison of the speed ratio droop signal to the first warning fault threshold; and wherein the software module transmits a third command to shut down the vehicle and disengage the IVT from the downstream drivetrain based on the comparison of the speed ratio droop signal to the second warning fault threshold. In some embodiments of the computer-implemented control system, the speed ratio droop module regulates the input power to the IVT by issuing an engine torque-speed limit override command (TSC1 CAN) to a vehicle electronic control unit provided on the vehicle, wherein the vehicle electronic control unit commands an adjustment to a plurality control parameters to thereby limit the power produced by the engine per the TSC1 request to regulate the speed ratio droop. In some embodiments of the computer-implemented control system, an engine torque-speed limit is set to a current measured engine speed at which the first warning fault threshold was detected. In some embodiments of the computer-implemented control system, the first warning fault threshold is a warning, which occurs if: |δ_{droop} ∛>ε_{w}, continuously over a period of Δt_{w} seconds, wherein ε_{w} is a warning speed ratio droop threshold parameter. In some embodiments of the computer-implemented control system, the default value for ε_{w} is a nominal value within a range of about 0.04 and 0.15 and the default value for the time threshold Δt_{w} is a nominal value within a range of about 0.15 sec and 0.5 sec. In some embodiments of the computer-implemented control system, the speed ratio droop is monitored to determine if the speed ratio droop continues to exceed the warning speed ratio droop threshold ∈_{W} and wherein if the speed ratio droop continues to exceed ∈_{W}, then an engine torque-speed limit value is decremented at a rate within a range of about 200-600 rpm/sec depending on the current engine speed. In some embodiments of the computer-implemented control system, the speed ratio droop is monitored to determine if the speed ratio droop falls below ∈_{W}, and wherein if the speed ratio droop falls below ∈_{W}, then the engine torque-speed limit value is incremented at a rate within a range of about 40 to 100 rpm/sec. depending on the current engine speed. In some embodiments of the computer-implemented control system, the engine torque-speed limit value is monitored to determine when it reaches a max threshold, wherein the engine torque-speed override command is removed. In some embodiments of the computer-implemented control system, when the engine torque-speed override command is removed, the speed ratio droop regulation process is complete. In some embodiments of the computer-implemented control system, the second (critical) warning fault threshold is a warning which occurs if: |δ_{droop}|>ε_{c}, continuously over a period of Δt_{c} seconds, wherein ε_{c} is the second (critical) speed ratio droop threshold parameter. In some embodiments of the computer-implemented control system, the default value for ε_{c} is a nominal value within a range of about 0.04 and 0.20 and the default value for the time threshold Δt_{c} is a nominal value within a range of about 0.15 sec and 0.5 sec. In some embodiments of the computer-implemented control system, when the second (critical) warning fault threshold is detected, the vehicle is shut down and the IVT is disengaged from a downstream drivetrain.

Provided herein is a computer-implemented method for regulating an engine torque-speed limit of a vehicle and a speed ratio droop an infinitely variable transmission (IVT) having a ball planetary variator (CVP) operably coupled to gears, said IVT operably coupled to an engine of the vehicle, the vehicle comprising a plurality of sensors and a computer-implemented system comprising: a digital processing device comprising an operating system configured to perform executable instructions and a memory device, and a computer program including the instructions executable by the digital processing device, wherein the computer program comprises a software module configured to control the engine and the CVP, the method comprising controlling the engine and the CVP by: the software module receiving a plurality of signals from one or more sensors reflecting vehicle parameters sensed by the one or more sensors, the vehicle parameters comprising a CVP input speed, a CVP output speed, and a current CVP shift position; calculating a speed ratio droop of the ball planetary variator based on the CVP input speed, the CVP output speed, and the current CVP shift position; comparing the speed ratio droop to a first warning fault threshold, wherein the first warning fault threshold is a calibratable parameter stored in the memory device; comparing the speed ratio droop to a second (critical) warning fault threshold, wherein the second (critical) warning fault threshold is a calibratable parameter stored in the memory device; and transmitting a first command for a change in the CVP shift position based on the comparison of the speed ratio droop to the first warning fault threshold and the second (critical) warning fault threshold; and transmitting a second command for a change in the CVP input speed based on the comparison of the speed ratio droop signal to the first warning fault threshold. In some embodiments, the computer-implemented method includes measuring the speed ratio droop of the ball planetary variator (CVP) and comparing the speed ratio droop to a first warning fault threshold; regulating the speed ratio droop of the ball planetary variator (CVP) based on the first comparison; detecting gross slip based on a second comparison of the speed ratio droop to a second (critical) warning fault threshold; and further regulating the speed ratio droop of the ball planetary variator (CVP) based on the second comparison. In some embodiments, the computer-implemented method includes regulating the input power to the IVT by issuing an engine torque-speed limit override command to the electronic control unit, which commands a plurality of control signals to the engine and limits the power from the engine per the TSC1 request to regulate the speed ratio droop. In some embodiments of the computer-implemented implemented method, an engine torque-speed limit is set to a current measured engine speed at which a first warning fault threshold was detected. In some embodiments of the computer-implemented method, the first warning fault threshold is a warning which occurs if: |δ_{droop} |>ε_{w}, continuously over a period of Δt_{w} seconds, wherein ε_{w} is a warning speed ratio droop threshold parameter. In some embodiments of the computer-implemented method, a first default value for ε_{w} is a first nominal value within a first range of about 0.04 and 0.15 and a second default value for a time threshold Δt_{w} is a second nominal value within a second range of about 0.15 sec and 0.5 sec. In some embodiments of the computer-implemented method includes monitoring the speed ratio droop to determine if the speed ratio droop continues to exceed the first default value ∈_{W} and wherein if the speed ratio droop continues to exceed ∈_{w}, then the engine torque-speed limit value is decremented at a rate within a range of about 200-600 rpm/sec depending on a current speed of the engine. In some embodiments of the computer-implemented method, the speed ratio droop is monitored to determine if the speed ratio droop falls below the first default value ∈_{W}, and wherein if the speed ratio droop falls below ∈_{W}, then the engine torque-speed limit value is incremented at a rate within a range of about 40 to 100 rpm/sec. depending on a current speed of the engine. In some embodiments of the computer-implemented method, the second (critical) warning fault threshold occurs if: |δ_{droop}|>ε_{c}, continuously over a period of Δt_{c} seconds, wherein ε_{c} is a second (critical) speed ratio droop threshold parameter. In some embodiments of the computer-implemented method, a first default value for ε_{c} is a first nominal value within a range of about 0.04 and 0.20 and a second default value for the time threshold Δt_{c} is a second nominal value within a range of about 0.15 sec and 0.5 sec. In some embodiments of the computer-implemented method, when the second (critical) warning fault threshold is detected, the vehicle is shut down and the Infinite Variable Transmission (IVT) is disengaged from a downstream drivetrain.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator;

FIG. 2 is a magnified, side sectional view of a ball of a variator of FIG. 1 having a symmetric arrangement of a first ring assembly and a second ring assembly;

FIG. 3 is a schematic of a typical continuously variable transmission (CVT) used in an Off-Highway (OH) vehicle;

FIG. 4 is a block diagram of a control system that can be implemented in the vehicle of FIG. 3.

FIG. 5 is a block diagram of a driving control module that can be implemented in the control system of FIG. 4.

FIG. 6 is a block diagram of a normal operation control sub-module that can be implemented in the control system of FIG. 4.

FIG. 7 is a block diagram of a power reversal control sub-module that can be implemented in the control system of FIG. 4.

FIG. 8 is a block diagram of a transition control sub-module that can be implemented in the control system of FIG. 4.

FIG. 9 is a block diagram of an inching control sub-module that can be implemented in the control system of FIG. 4.

FIG. 10 is a block diagram of an automatic deceleration control sub-module that can be implemented in the control system of FIG. 4.

FIG. 11 is a block diagram of a braking control sub-module that can be implemented in the control system of FIG. 4.

FIG. 12 is a block diagram of a speed ratio conversion algorithm that can be implemented in the control system of FIG. 4.

FIG. 13 is a side sectional view of a ball-type variator.

FIG. 14 is a plan view of a carrier member that can be used in the variator of FIG. 13.

FIG. 15 is an illustrative view of different tilt positions of the ball-type variator of FIG. 13.

FIG. 16 is a block diagram of a normal operation control sub-module that can also be implemented in the control system of FIG. 4.

FIG. 17 is a block diagram of a power reversal control sub-module that can also be implemented in the control system of FIG. 4.

FIG. 18 is a block diagram of a transition control sub-module that can also be implemented in the control system of FIG. 4.

FIG. 19 is a block diagram of an inching control sub-module that can also be implemented in the control system of FIG. 4.

FIG. 20A is an Auto-Deceleration High-Level Algorithm Flow Chart.

FIG. 20B is another Auto-Deceleration High-Level Algorithm Flow Chart.

FIG. 21 is a flow chart of an Auto-Deceleration State within the Driving Manager Software Module.

FIG. 22A is a Power Reversal High-Level Algorithm Flow Chart.

FIG. 22B is another Power Reversal High-Level Algorithm Flow Chart.

FIG. 23 is a flow chart of a Power Reversal State within the Driving Manager Software Module.

FIG. 24 is an Inching maneuver High-Level Algorithm Flow Chart.

FIG. 25A is an illustration of a Position-based Inching Map (forward driving)—with hysteresis scheme.

FIG. 25B is an illustration of a Speed Ratio-based Inching Map (forward driving)—with hysteresis scheme.

FIG. 26 is an illustration of the functional inching range of the brake pedal position.

FIG. 27 is a graph illustrating the nominal CVP relative speed ratio as a function of CVP carrier shift position.

FIG. 28 is a graph illustrating CVP Ratio Droop Fault Tolerances.

FIG. 29 is a high-level flow chart of a ratio droop regulation control algorithm.

### DETAILED DESCRIPTION OF THE INVENTION

A control system for a vehicle having an infinitely variable transmission (IVT) comprising a ball planetary variator (CVP), providing a smooth and controlled operation is described. In some embodiments, the vehicle is a fork lift truck. An operator commands a brake pedal, an accelerator pedal, a parking brake, and a direction switch (or “gear selector”), which are evaluated by the control system to determine a current operating state of the vehicle. Some operating states include, forward drive, reverse drive, vehicle braking, automatic deceleration, inching, power reversal, vehicle hold, and park, among others.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. Typically, friction drives generally relate to transferring power between two elements by frictional forces between the elements. For the purposes of this disclosure, it should be understood that the CVTs described here may operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer is referred to as “creep in the rolling direction.” Sometimes the driving and driven elements experience creep in a direction orthogonal to the power transfer direction, in such a case this component of creep is referred to as “transverse creep.”

For description purposes, the terms “prime mover”, “engine,” and like terms, are used herein to indicate a power source. Said power source may be fueled by energy sources comprising hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission comprising this technology.

For description purposes, the terms “electronic control unit”, “ECU”, “Driving Control Manager System” or “DCMS” are used interchangeably herein to indicate a vehicle's electronic system that controls subsystems monitoring or commanding a series of actuators on an internal combustion engine to ensure optimal engine performance. It does this by reading values from a multitude of sensors within the engine bay, interpreting the data using multidimensional performance maps (called lookup tables), and adjusting the engine actuators accordingly. Before ECUs, air-fuel mixture, ignition timing, and idle speed were mechanically set and dynamically controlled by mechanical and pneumatic means.

Those of skill will recognize that brake position and throttle position sensors can be electronic, and in some cases, well-known potentiometer type sensors. These sensors can provide a voltage or current signal that is indicative of a relative rotation and/or compression/depression of driver control pedals, for example, brake pedal and/or throttle pedal. Often, the voltage signals transmitted from the sensors are scaled. A convenient scale used in the present application as an illustrative example of one implementation of the control system uses a percentage scale 0-100%, where 0% is indicative of the lowest signal value, for example a pedal that is not compressed, and 100% is indicative of the highest signal value, for example a pedal that is fully compressed. There may be implementations of the control system where the brake pedal is effectively fully engaged with a sensor reading of 20%-100%. Likewise, a fully engaged throttle pedal may correspond to a throttle position sensor reading of 20%-100%. The sensors, and associated hardware for transmitting and calibrating the signals, can be selected in such a way as to provide a relationship between the pedal position and signal to suit a variety of implementations. Numerical values given herein are included as examples of one implementation and not intended to imply limitation to only those values. For example, a minimum detectable threshold for a brake pedal position may be 6% for a particular pedal hardware, sensor hardware, and electronic processor. Whereas an effective brake pedal engagement threshold may be 14%, and a maximum brake pedal engagement threshold may begin at or about 20% compression. As a further example, a minimum detectable threshold for an accelerator pedal position may be 5% for a particular pedal hardware, sensor hardware, and electronic processor. Similar or completely different pedal compression threshold values for effective pedal engagement and maximum pedal engagement may also apply for the accelerator pedal.

As used herein, and unless otherwise specified, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 30%, 25%, 20%, 15%, 10%, 9%, 8%, 7%, 6%, 5%, 4%, 3%, 2%, 1%, 0.5%, 0.1%, or 0.05% of a given value or range. In certain embodiments, the term “about” or “approximately” means within 40.0 mm, 30.0 mm, 20.0 mm, 10.0mm 5.0 mm 1.0 mm, 0.9 mm, 0.8 mm, 0.7 mm, 0.6 mm, 0.5 mm, 0.4 mm, 0.3 mm, 0.2 mm or 0.1 mm of a given value or range. In certain embodiments, the term “about” or “approximately” means within 20. degrees, 15.0 degrees, 10.0 degrees, 9.0 degrees, 8.0 degrees, 7.0 degrees, 6.0 degrees, 5.0 degrees, 4.0 degrees, 3.0 degrees, 2.0 degrees. 1.0 degrees, 0.9 degrees, 0.8 degrees, 0.7 degrees, 0.6 degrees_{;} 0.5 degrees, 0.4 degrees, 0.3 degrees, 0.2 degrees, 0.1 degrees, 0.05 degrees of a given value or range.

In certain embodiments, the term “about” or “approximately” means within 5.0 mA, 1.0 mA, 0.9 mA, 0.8 mA, 0.7 mA, 0.6 mA, 0.5 mA, 0.4 mA, 0.3 mA, 0.2 mA, 0.1 mA, 0.09 mA, 0.08 mA, 0.07 mA, 0.06 mA, 0.05 mA, 0.04 mA, 0.03 mA, 0.02 mA or 0.01 mA of a given value or range.

As used herein, “about” when used in reference to a velocity of the moving object or movable substrate means variation of 1%-5%, of 5%-10%, of 10%-20%, and/or of 10%-50% (as a percent of the percentage of the velocity, or as a variation of the percentage of the velocity). For example, if the percentage of the velocity is “about 20%”, the percentage may vary 5%-10% as a percent of the percentage i.e. from 19% to 21% or from 18% to 22%; alternatively the percentage may vary 5%-10% as an absolute variation of the percentage i.e. from 15% to 25% or from 10% to 30%.

In certain embodiments, the term “about” or “approximately” means within 0.01 sec., 0.02 sec, 0.03 sec., 0.04 sec., 0.05 sec., 0.06 sec., 0.07 sec., 0,08 sec. 0.09 sec. or 0.10 sec of a given value or range. in certain embodiments, the term “about” or “approximately” means within 0.5 rpm/sec, 1.0 rpm/sec, 5.0 rpm/sec, 10,0 rpm/sec, 15.0 rpm/sec, 20.0 rpm/sec, 30 rpm/sec, 40 rpm/sec, or 50 rpm/sec of a given value or range.

Those of skill will recognize that the various illustrative logical blocks, modules, circuits, and algorithm steps described in connection with the embodiments disclosed herein, including with reference to the transmission control system described herein, for example, may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Software associated with such modules may reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor can read information from, and write information to, the storage medium. In the alternative, the storage medium may be integral to the processor. The processor and the storage medium may reside in an ASIC. For example, in some embodiments, a controller for use of control of the IVT comprises a processor (not shown).

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Digital Processing Device

In some embodiments, the Control System for a Vehicle equipped with an infinitely variable transmission described herein includes a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® OS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii ®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-transitory Computer Readable Storage Medium

In some embodiments the Control System for a Vehicle equipped with an infinitely variable transmission disclosed herein includes one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the Control System for a Vehicle equipped with an infinitely variable transmission disclosed herein includes at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

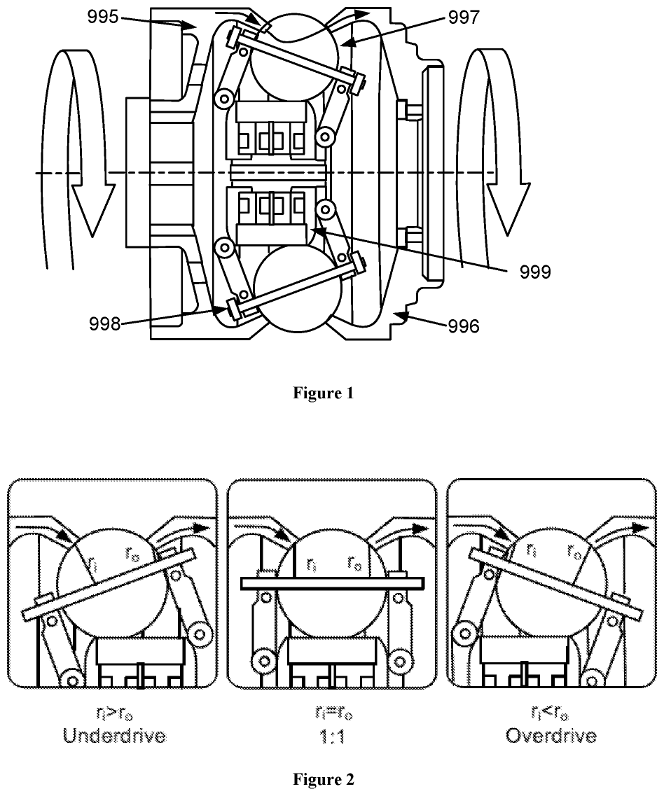

The type of IVT described herein comprises a ball planetary variator (CVP) comprising a plurality of variator balls, depending on the application, two discs or annular rings 995, 996 each having an engagement portion that engages the variator balls 997, at least. The engagement portions are optionally in a conical or toroidal convex or concave surface contact with the variator balls, as input (995) and output (996). The variator optionally includes an idler 999 contacting the balls as well as shown on FIG. 1. The variator balls are mounted on axles 998, themselves held in a cage or carrier allowing changing the ratio by tilting the variator balls' axes. Other types of ball IVTs and or CVTs also exist like the one produced by Milner, but are slightly different. These alternative ball IVTs and CVTs are additionally contemplated herein. The working principle generally speaking, of a ball-type variator (i.e. CVP) of a CVT is shown in FIG. 2.

The variator itself works with a traction fluid. The lubricant between the ball and the conical rings acts as a solid at high pressure, transferring the power from the first ring assembly (input of the variator), through the variator balls, to the second ring assembly (output of the variator). By tilting the variator balls' axes, the ratio is changed between input and output. When the axis of each of the variator balls is horizontal the ratio is one, when the axis is tilted the distance between the axis and the contact point change, modifying the overall ratio. All the variator balls' axles are tilted at the same time with a mechanism included in the cage.

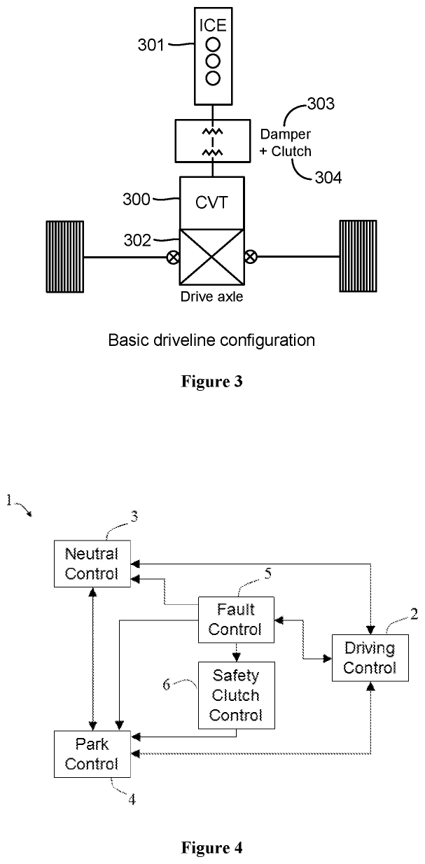

In a vehicle, the IVT, CVT or IVT/CVT 300 is used to replace a traditional transmission and is located between the engine (ICE or internal combustion engine, or other power source) 301 and the differential 302 as shown on FIG. 3. A torsional dampener (alternatively called a damper) 303 is optionally introduced between the engine and the CVT to avoid transferring torque peaks and vibrations that could damage the CVT. In some configurations this dampener is coupled with a clutch 304 for the starting function or for allowing the engine to be decoupled from the transmission. In some embodiments, the clutch is located at a different place in the driveline for allowing an interruption in the transmission of power in the driveline. In yet other embodiments, the engine 301 is coupled to the CVT 300 through a torque converter, or other power coupling means.

Referring now to FIG. 4, in some embodiments a control system 1 is provided with a driving control sub-module 2, a neutral control sub-module 3, and a park control sub-module 4 each in communication with a fault sub-module 5. The fault sub-module 5 is in communication with a safety clutch control sub-module 6. In some embodiments, the fault sub-module 5 is configured to monitor and receive any fault condition of the vehicle and commands the safety clutch control sub-module 6 to activate, for example, the clutch 304. For example, a fault condition may arise from the brake pedal being pressed harder than the actuator can handle, or a loss of hydraulic pressure in the system. The neutral control sub-module 3 is configured to manage the IVT when a neutral condition is selected on the gear selector. The park control sub-module 4 is configured to manage the IVT when a park condition is selected on the gear selector.

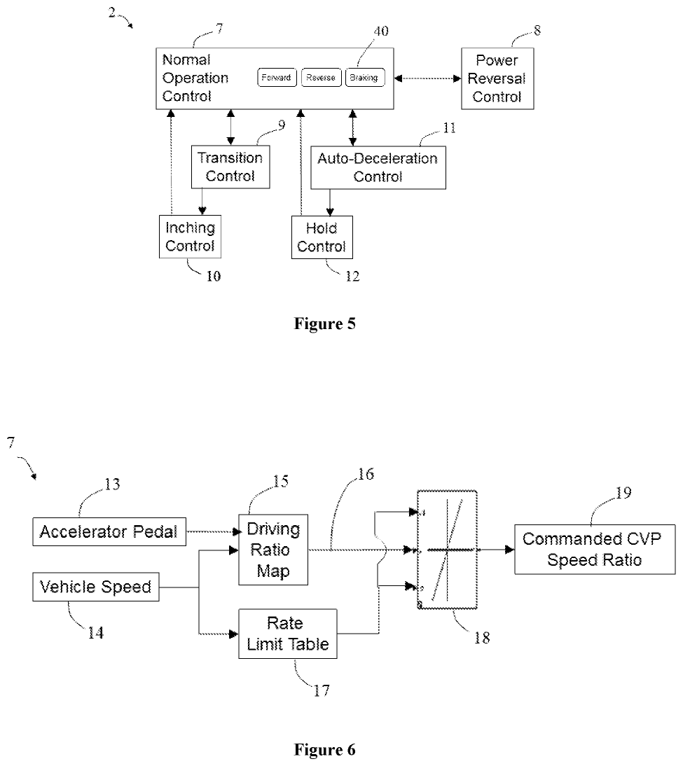

Referring now to FIG. 5, in some embodiments the driving control sub-module 2 is provided with a normal operation control sub-module 7. The normal operation control sub-module 7 is configured to manage the IVT during normal forward, reverse, and braking operation of the vehicle. In some embodiments, the driving control sub-module 2 is provided with a power reversal control sub-module 8. The power reversal control sub-module 8 is configured to manage the IVT during a power reversal maneuver. To execute the Power Reversal maneuver, the operator will command a change in direction using a Vehicle Direction Switch, or gear selector, while the vehicle is moving. For example, the operator will move the gear selector from forward to reverse while the vehicle is moving in a forward direction, or the operator will move the gear selector from reverse to forward while the vehicle is moving in a reverse direction

Provided herein is a computer-implemented system for generating an inching maneuver mode in a vehicle having an engine coupled to an infinitely variable transmission having a ball-planetary variator (CVP), the computer-implemented system comprising: a digital processing device comprising an operating system configured to perform executable instructions and a memory device; a computer program including instructions executable by the digital processing device to create an application comprising a software module configured to manage a controlled inching maneuver; a plurality of sensors configured to monitor vehicle parameters comprising: vehicle direction, brake pedal position, engine speed, wherein the software module receives data from the plurality of sensors and executes instructions to manage the controlled inching maneuver indicative of the vehicle direction, the brake pedal position, the accelerator pedal position, and the engine speed; wherein the software module commands CVP speed ratio based at least in part on the vehicle direction, the engine speed, and the brake pedal position.

In some embodiments, the vehicle direction and brake pedal position are received from a vehicle CAN bus.

In some embodiments, the system further comprises a rate limit function configured to limit a rate of change of the CVP speed ratio based at least in part on the vehicle speed.

In some embodiments, the driving control sub-module 2 is provided with a transition control sub-module 9 and an inching control sub-module 10. The transition control sub-module 9 is configured to manage the IVT during a transition from normal operation to an inching maneuver. The inching control sub-module 10 is configured to manage the IVT during the inching maneuver. An inching maneuver is a process where an engine powered lift truck moves slowly while the engine is operated at high speed to allow full speed operation of the lift truck hydraulic system or to allow a vehicle to move in a slow, controlled fashion, at some reduced percentage of full operational speed. Inching is used for example, when precisely maneuvering a forklift or similar lifting vehicle, and simultaneously elevating or lowering the payload lift apparatus. Inching allows slow controlled movement of the lift vehicle and is accomplished by simultaneous operation of the inch/brake pedal and the accelerator pedal.

Provided herein is a computer-implemented system for generating an auto-deceleration of a vehicle having an engine coupled to an infinitely variable transmission having a ball-planetary variator (CVP), the computer-implemented system comprising: a digital processing device comprising an operating system configured to perform executable instructions and a memory device; a computer program including instructions executable by the digital processing device to create an application comprising a software module configured to manage auto-deceleration; a plurality of sensors configured to monitor vehicle parameters comprising: vehicle speed, brake pedal position, accelerator pedal position, engine speed, and CVP speed ratio, wherein the software module receives data from the sensors and executes instructions to manage a controlled auto-deceleration indicative of a current operating state of vehicle, the vehicle speed, the brake pedal position, the accelerator pedal position, the engine speed and the CVP speed ratio; wherein the software module monitors a speed ratio of the CVP; wherein the software module monitors an engine overspeed condition and controls the deceleration rate of the vehicle speed based at least in part on the engine speed; and wherein the software module commands a change in CVP speed ratio based at least in part on the position of the brake pedal.

In some embodiments, the vehicle direction, vehicle speed, brake pedal position, and accelerator pedal position are received from a vehicle CAN bus.

In some embodiments, the system further comprises a rate limit function configured to limit a rate of change of the CVP speed ratio based at least in part on the vehicle speed.

In some embodiments, the driving control sub-module 2 is provided with an automatic deceleration control sub-module 11 (sometimes referred to as “auto-decel” control sub-module 11). The auto-deceleration control sub-module 11 is configured to manage the IVT during an Auto-Deceleration maneuver. To execute the Auto-Deceleration maneuver, the operator will command an auto-deceleration by simply taking their foot off of the accelerator pedal and the brake pedal.

In some embodiments, the driving control sub-module 2 is provided with a hold control sub-module 12. The hold control sub-module 12 manages the IVT when a hold mode is initiated by the control system 1. Hold mode physically holds the vehicle stationary when the driver is not pressing the accelerator or brake pedal. It also serves to hold the vehicle stationary on a hill (Hill Hold). Without this feature, the vehicle will roll when on a grade and no pedal is pressed.

Referring now to FIG. 6, in some embodiments the normal operation control sub-module 7 is configured to receive an accelerator pedal signal 13 and a vehicle speed signal 14. The accelerator pedal signal 13 and the vehicle speed signal 14 are passed to a driving ratio map 15 that determines a target CVP speed ratio 16. The vehicle speed signal 14 is passed to a rate limit look-up table 17 to determine a rate limit for a change in CVP speed ratio based on the vehicle speed signal 14. A rate limit function block 18 applies the vehicle-speed-based rate limit determined in the look-up table 17 to the target CVP speed ratio 16 to provide a commanded CVP speed ratio signal 19.

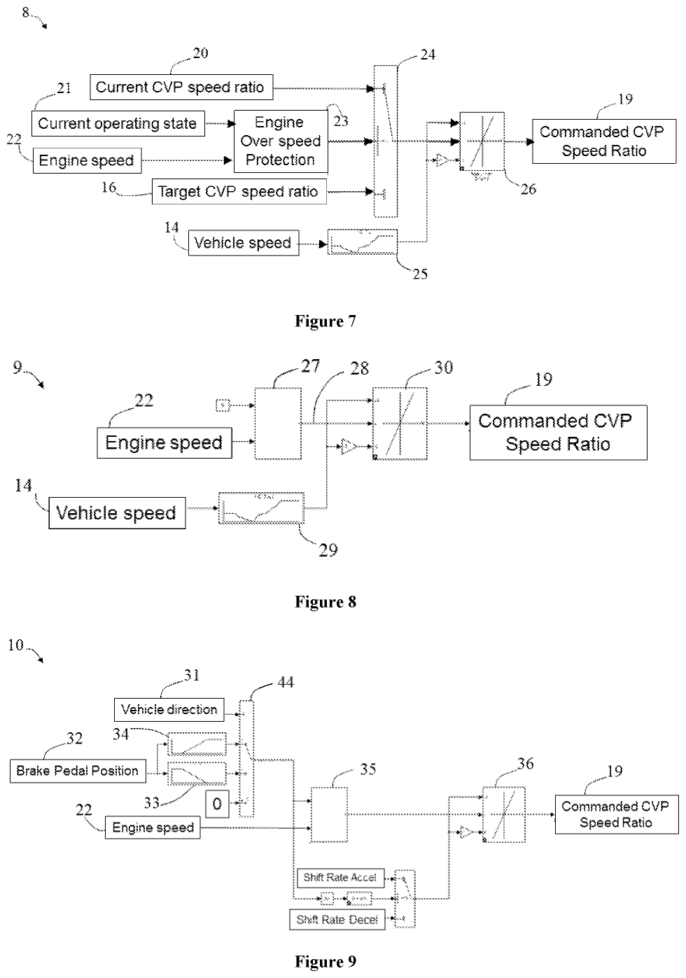

Referring now to FIG. 7, in some embodiments the power reversal control sub-module 8 is configured to receive a current CVP speed ratio signal 20, a current operating state signal 21, and an engine speed signal 22 that are passed to an engine overspeed protection sub-module 23. During a power reversal maneuver, a request is sent to the engine to reduce engine torque to approximately its idle value. If the engine speed is within a calibratable threshold of the maximum engine speed, the engine overspeed protection sub-module 23 will output a TRUE value to a decision block 24, the current CVP speed ratio 20 will be passed until the engine speed falls below the threshold. Once the engine speed has fallen below the threshold, the target CVP speed ratio 16 is passed, and CVP speed ratio changes at the rate determined by a lookup table 25 based on vehicle speed 14. A rate limit function block 26 applies the vehicle-speed-based rate limit determined in the look-up table 25 to provide the commanded CVP speed ratio signal 19.

Provided herein is a computer-implemented system for changing direction of a vehicle having an engine coupled to an infinitely variable transmission having a ball-planetary variator (CVP), the computer-implemented system comprising: a digital processing device comprising an operating system configured to perform executable instructions and a memory device; a computer program including the instructions executable by the digital processing device, the computer program comprising a software module configured to control the change of direction of the vehicle; a plurality of sensors comprising: a vehicle direction sensor adapted to sense a vehicle direction and provide the vehicle direction to the software module, a vehicle speed sensor adapted to sense a vehicle speed and provide the vehicle speed to the software module, an engine speed sensor adapted to sense an engine speed and provide the engine speed to the software module, a CVP input speed sensor configured to sense a CVP input speed and provide the CVP input speed to the software module, and a CVP output speed sensor configured to sense a CVP output speed and provide the CVP output speed to the software module, wherein the software module determines a current CVP speed ratio based on the CVP input speed and the CVP output speed, wherein the software module determines a commanded CVP speed ratio during the change of the direction of the vehicle, wherein the commanded CVP speed ratio is based at least in part on the vehicle direction, the vehicle speed, the engine speed, and the current CVP speed ratio; wherein the software module is configured to command an engine speed limit based at least in part on the vehicle direction and the vehicle speed; and wherein the software module is configured to control the current speed ratio of CVP based on the commanded CVP speed ratio. In some embodiments of the computer-implemented system, the vehicle speed is received from a vehicle CAN bus. In some embodiments of the computer-implemented system, the software module further comprises a rate limit function configured to limit a rate of change of the commanded CVP speed ratio based at least in part on the vehicle speed.

Referring now to FIG. 8, in some embodiments the transition control sub-module 9 is configured to receive the engine speed signal 22 and the vehicle speed signal 14. The engine speed signal 22 is passed to a function block 27 where a target speed ratio 28 is determined based on the engine speed signal 22 and a target vehicle speed. The transition control sub-module 9 is implemented to change the CVP speed ratio toward. IVT zero in order to slow the vehicle down to inching speed (for example, a vehicle speed below about 3.5 mph). The transition control sub-module 9 effectively reduces engine torque to prevent overspeeding the engine during change in CVP speed ratio. The transition control sub-module 9 is entered when the vehicle is traveling greater than the maximum inching speed and the driver presses both the brake and accelerator pedal at the same time. This state is exited when vehicle reaches inching speed. In other embodiments, the transition control sub-module 9 can be integral to the inching control sub-module 10. The transition control sub-module 9 can be configured with a rate limit look-up table 29 to determine a rate limit for a change in CVP speed ratio based on the vehicle speed signal 14. A rate limit function block 30 applies the vehicle-speed-based rate limit determined in the look-up table 29 to the target CVP speed ratio to provide a commanded CVP speed ratio signal 19.

Turning now to FIG. 9, in some embodiments the inching control sub-module 10 is configured to receive a vehicle direction signal 31, a brake pedal position signal 32, and the engine speed signal 22. The brake pedal position signal 32 is passed to a forward direction look-up table 33 and a reverse direction look-up table 34 where a requested vehicle speed is determined based on the brake pedal position signal 32. A decision block 34 passes the requested vehicle speed based on the vehicle direction signal 31. For example, when the vehicle direction is forward, the value determined from the forward direction look-up table 33 is passed. Likewise, when the vehicle direction is reverse, the value determined from the reverse direction look-up table 34 is passed. The target vehicle speed is passed from the decision block 44 to a function block 35 where a target CVP speed ratio is determined based on the target vehicle speed and the engine speed signal 22. In some embodiments, the target CVP speed ratio is passed through a rate limit function block 36 that can be configured to apply a rate limit for forward direction or for reverse direction.

Provided herein is a computer-implemented system for generating an inching maneuver mode in a vehicle having an engine coupled to an infinitely variable transmission having a ball-planetary variator (CVP), the computer-implemented system comprising: a digital processing device comprising an operating system configured to perform executable instructions and a memory device; a computer program including the instructions executable by the digital processing device, the computer program comprising a software module configured to control the vehicle during the inching maneuver; a plurality of sensors comprising: a vehicle direction sensor adapted to sense a vehicle direction and provide the vehicle direction to the software module, a brake pedal position sensor adapted to sense a brake pedal position and provide the brake pedal position to the software module, an engine speed sensor adapted to sense an engine speed and provide the engine speed to the software module, wherein the software module determines a commanded CVP speed ratio during the inching maneuver, wherein the commanded CVP speed ratio is based at least in part on the vehicle direction, the brake pedal position, the accelerator pedal position, and the engine speed; and wherein the software module is configured to control the CVP based on the commanded CVP speed ratio. In some embodiments of the computer-implemented system, the vehicle direction and brake pedal position are received from a vehicle CAN bus. In some embodiments of the computer-implemented system, the software module further comprises a rate limit function configured to limit a rate of change of the commanded CVP speed ratio based at least in part on the vehicle speed.

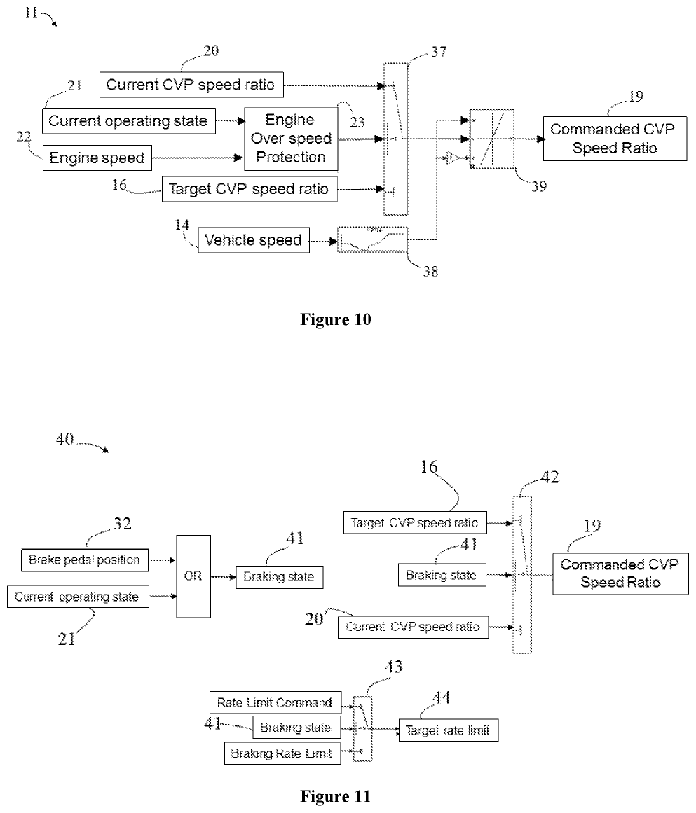

Referring now to FIG. 10, in some embodiments the auto-deceleration control sub-module 11 is configured to receive the current CVP speed ratio signal 20, the current operating state signal 21, the vehicle speed signal 14, and the engine speed signal 22. The current operating state signal 21 and the engine speed signal 22 are passed to the engine overspeed protection sub-module 23. The engine overspeed protection sub-module 23 determines if the engine speed is within an operating threshold based on the current operating state signal and the engine speed signal 22. The resulting comparison is passed to a decision block 37. Automatic Deceleration is entered when the vehicle is moving and the driver releases both the brake and accelerator pedal. During an auto-deceleration maneuver, the auto-deceleration control sub-module 11 waits for the engine speed to drop below the maximum safe engine speed, for example within the engine overspeed protection sub-module 23. During this wait time, the vehicle holds a constant CVP speed ratio equivalent to the current speed ratio signal 20. Once the engine speed has dropped, the CVP speed ratio is commanded toward IVT zero at a rate determined by a rate limit look-up table 38 to determine a rate limit for a change in CVP speed ratio based on the vehicle speed signal 14. A rate limit function block 39 applies the vehicle-speed-based rate limit determined in the look-up table 38 to the target CVP speed ratio to provide a commanded CVP speed ratio signal 19.

Provided herein is a computer-implemented system for controlling an auto-deceleration of a vehicle having an engine coupled to an infinitely variable transmission having a ball-planetary variator (CVP), the computer-implemented system comprising: a digital processing device comprising an operating system configured to perform executable instructions and a memory device; a computer program including the instructions executable by the digital processing device, the computer program comprising a software module configured to control the auto-deceleration of the vehicle; a plurality of sensors comprising: a vehicle speed sensor adapted to sense a vehicle speed and provide the vehicle speed to the software module, a brake pedal position sensor adapted to sense a brake pedal position and provide the brake pedal position to the software module, an accelerator pedal position sensor adapted to sense an accelerator pedal position and provide an accelerator pedal position to the software module, an engine speed sensor adapted to sense an engine speed and provide an engine speed to the software module, a CVP input speed sensor configured to sense a CVP input speed and provide the CVP input speed to the software module, and a CVP output speed sensor configured to sense a CVP output speed and provide the CVP output speed to the software module, wherein the software module determines a current CVP speed ratio based on the CVP input speed and the CVP output speed, and wherein the software module determines a commanded CVP speed ratio during the auto-deceleration of the vehicle, wherein the commanded CVP speed ratio signal is based on a current operating state of vehicle, the vehicle speed, the brake pedal position, the accelerator pedal position, the engine speed, and the current CVP speed ratio; and wherein the software module is configured to control the current speed ratio of CVP based on the commanded CVP speed ratio. In some embodiments of the computer-implemented system, the vehicle direction, vehicle speed, brake pedal position, and accelerator pedal position are received from a vehicle CAN bus. In some embodiments of the computer-implemented system, the software module further comprises a rate limit function configured to limit a rate of change of the commanded CVP speed ratio based at least in part on the vehicle speed.

Provided herein is a computer-implemented control system for regulating a deceleration of a vehicle having an engine coupled to an infinitely variable transmission (IVT) having a ball-planetary variator (CVP), the computer-implemented control system comprising: a digital processing device comprising an operating system configured to perform executable instructions and a memory device; a computer program including the instructions executable by the digital processing device, the computer program comprising a software module configured to control vehicle deceleration; a plurality of sensors comprising: a vehicle speed sensor adapted to sense a vehicle speed and provide the vehicle speed to the software module, a brake pedal position sensor adapted to sense a brake pedal position and provide the brake pedal position to the software module, a CVP input speed sensor configured to sense a CVP input speed and provide the CVP input speed to the software module, and a CVP output speed sensor configured to sense a CVP output speed and provide the CVP output speed to the software module, wherein the software module determines a current CVP speed ratio based on the CVP input speed and the CVP output speed; wherein the software module determines a commanded CVP speed ratio during the deceleration of the vehicle, wherein the commanded CVP speed ratio is based at least in part on the vehicle speed and the brake pedal position; and wherein the software module is configured to control the CVP based on the commanded CVP speed ratio. In some embodiments of the computer-implemented system, the vehicle speed and brake pedal position are received from a vehicle CAN bus. In some embodiments of the computer-implemented system, the software module further comprises a rate limit function configured to limit a rate of change of the commanded CVP speed ratio based at least in part on the vehicle speed.

Referring now to FIG. 11, and still referring to FIG. 5, in some embodiments, the normal operation control sub-module 2 can be provided with a braking control sub-module 40. The braking state is entered when the vehicle is not inching and the brake pedal is pressed. The braking control sub-module 40 delivers the more aggressive of two commands 1) the target speed ratio 16, or 2) a CVP speed ratio value to match the current CVP speed ratio 20. In some embodiments, the braking control sub-module 40 receives the brake pedal position signal 32 and the current operating state signal 21 to determine a braking state signal 41. The braking state signal 41 is passed to a decision block 42 to determine the commanded CVP speed ratio signal 19. The braking control sub-module 40 may also use the braking state signal 41 to determine a target rate limit signal 44 in the decision block 43. When the vehicle deceleration rate due to the driver pressing the brake pedal is greater than the commanded deceleration rate (usually from the auto-deceleration table), the braking control sub-module 40 will allow the vehicle inertia to push the transmission shift actuator toward IVT zero condition. The vehicle inertia causes the CVP speed ratio to droop away from its nominal value. During this time, the shift actuator is commanded to a position which corresponds to the current actual CVP speed ratio (which includes the droop), thereby relieving force or pressure on the actuator, but not actually driving the unit.

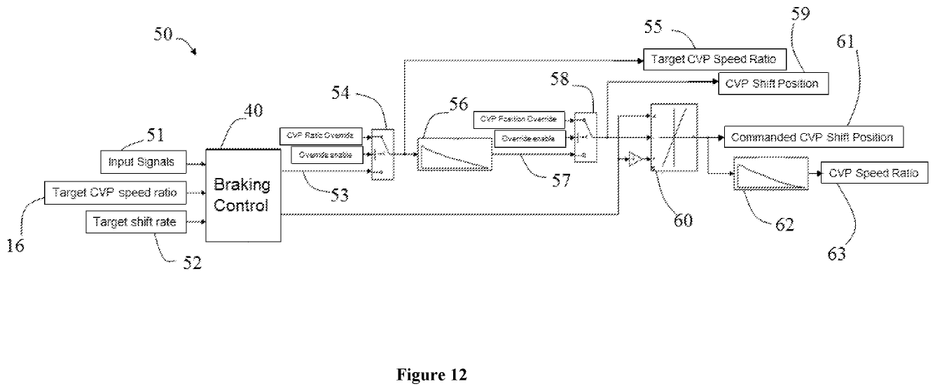

Referring now to FIG. 12, in some embodiments a processing sub-module 50 can be implemented in the control system 1 to convert the commanded CVP speed ratio 19 into a physical change in CVP shift position via an actuator. The processing sub-module 50 receives a number of vehicle parameters 51 as input signals, the target CVP speed ratio 16, and a target shift rate 52, which are passed through the braking control sub-module 40. The target CVP speed ratio 53 is passed to a decision block 54 where commanded system overrides are applied. The target CVP speed ratio 55 is passed to a calibration table 56 to determine a CVP shift position 57 based on the target CVP speed ratio 55. The CVP shift position 57 is passed to a decision block 58 where commanded system overrides are applied. The CVP shift position 59 is passed to a rate limit function block 60 to determine the commanded CVP shift position 61. In some embodiments, the commanded CVP shift position 61 is converted in a look-up table 62 to an equivalent CVP speed ratio 63 for use in other parts of the control system 1.

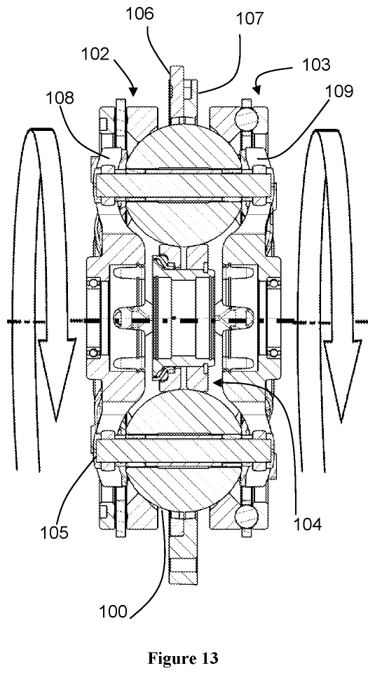

Provided herein are configurations of CVTs based on ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, comprises a number of balls (planets, spheres) 100, depending on the application, two ring (disc) assemblies with a conical surface contact with the balls, as input 102 and output 103, and an idler (sun) assembly 4 as shown on FIG. 13. The balls are mounted on tiltable axles 105, themselves held in a carrier (stator, cage) assembly having a first carrier member 106 operably coupled to a second carrier member 107. The first carrier member 106 can rotate with respect to the second carrier member 107, and vice versa. In some embodiments, the first carrier member 106 can be substantially fixed from rotation while the second carrier member 107 is configured to rotate with respect to the first carrier member, and vice versa. In some embodiments, the first carrier member 106 can be provided with a number of radial guide slots 108. The second carrier member 109 can be provided with a number of radially offset guide slots 109. The radial guide slots 108 and the radially offset guide slots 109 are adapted to guide the tiltable axles 105. The axles 105 can be adjusted to achieve a desired ratio of input speed to output speed during operation of the CVT. In some embodiments, adjustment of the axles 105 involves control of the position of the first carrier member and the second carrier member to impart a tilting of the axles 105 and thereby adjusts the speed ratio of the variator. Other types of ball CVTs also exist, like the one produced by Milner, but are slightly different.

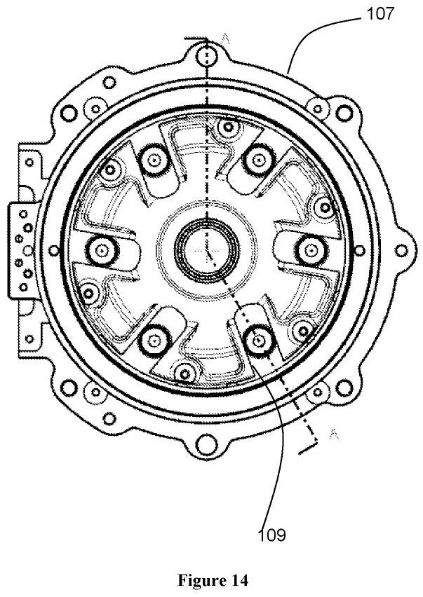

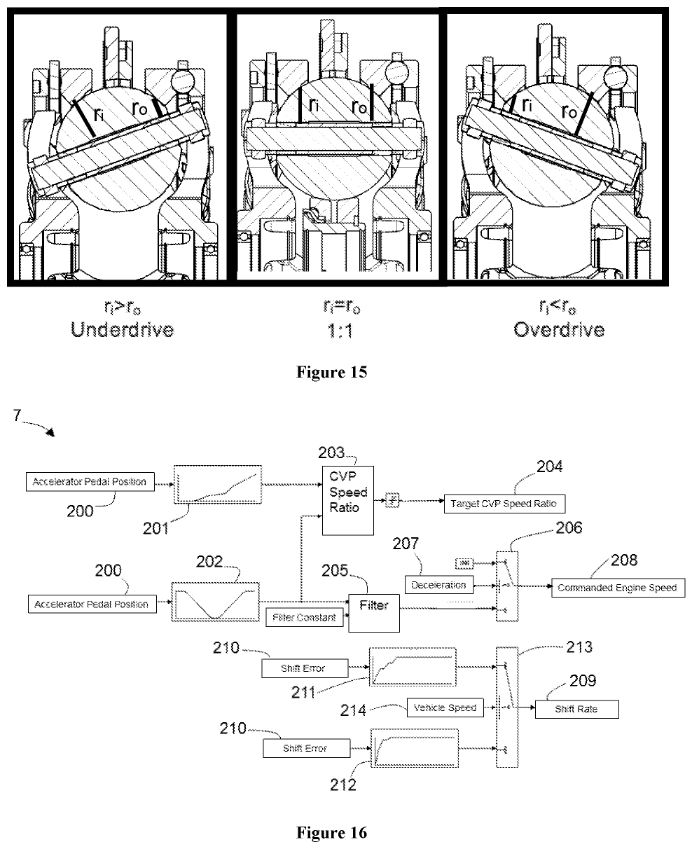

The working principle of such a CVP of FIG. 1 is shown on FIG. 14. The CVP itself works with a traction fluid. The lubricant between the ball and the conical rings acts as a solid at high pressure, transferring the power from the input ring, through the balls, to the output ring. By tilting the balls' axes, the ratio can be changed between input and output. When the axis is horizontal the ratio is one, illustrated in FIG. 15, when the axis is tilted the distance between the axis and the contact point change, modifying the overall ratio. All the balls' axes are tilted at the same time with a mechanism included in the carrier and/or idler. Embodiments of the invention disclosed here are related to the control of a variator and/or a CVT using generally spherical planets each having a tiltable axis of rotation that can be adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In some embodiments, a control system coordinates the use of a skew angle to generate forces between certain contacting components in the variator that will tilt the planet axis of rotation. The tilting of the planet axis of rotation adjusts the speed ratio of the variator.

Referring now to FIG. 16, in some embodiments the normal operation control sub-module 7 is configured to receive an accelerator pedal position signal 200 that is passed to a vehicle speed calibration map 201. The vehicle speed calibration map 201 is read from memory or provided by another sub-module in the driving control sub-module 2. The vehicle speed calibration map 201 stores values for a target vehicle speed signal based at least in part on the accelerator pedal position signal 200. The accelerator pedal position signal 200 is passed to an engine speed calibration map 202. The engine speed calibration map 202 is read from memory or provided by another sub-module in the driving control sub-module 2. The engine speed calibration map 202 stores values for a target engine speed signal based at least in part on the accelerator pedal position signal 200. The target vehicle speed signal and the target engine speed signal are passed to a CVP speed ratio sub-module 203. The CVP speed ratio sub-module 203 determines a target CVP speed ratio signal 204 based at least in part on the target vehicle speed signal and the target engine speed signal. In some embodiments, the CVP speed ratio sub-module 203 is a CVP speed ratio calibration map. In other embodiments, the CVP speed ratio sub-module 203 executes computations based on the target speed signal and the target engine speed signal to determine the target CVP speed ratio. For example, the CVP speed ratio sub-module 203 may use the target engine speed signal and target output shaft speed signal to calculate a target CVP speed ratio using the planetary gear set equation. In some embodiments, the target engine speed can be passed to a first order filter 205. The first order filter 205 passes a filtered signal to a switch block 206. The switch block 206 evaluates the value of a deceleration signal 207 and selects a commanded engine speed signal 208 based on the deceleration signal 207. For example, when the deceleration signal 207 has a false or zero value, the filtered signal provided by the first order filter 205 is passed out of the switch block 206 as the commanded engine speed signal 208.

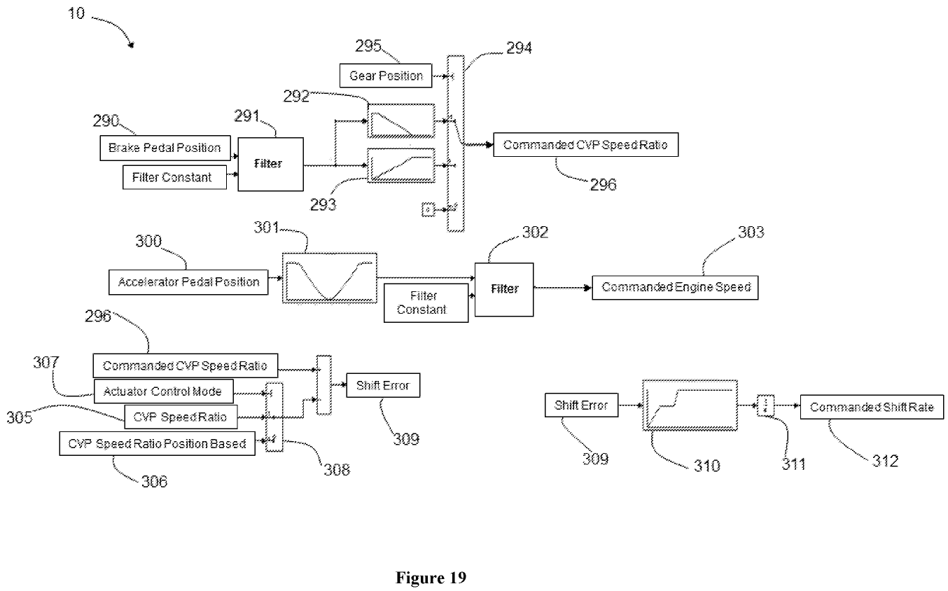

In some embodiments, the normal operation control sub-module 7 can determine a shift rate signal 209 based at least in part on a shift error signal 210. In some embodiments, the shift error signal 210 may be determined in another sub-module of the driving control module 2. (See for example, FIG. 19). In some embodiments, the shift error signal 210 is the difference between a measured CVP speed ratio and a commanded CVP speed ratio. The shift error signal 210 is passed to a forward shift rate calibration table 211. The forward shift rate calibration table 211 stores values of shift rate for forward driving conditions based at least in part on the shift error signal 210. The shift error signal 210 is passed to a reverse shift rate calibration table 212. The reverse shift rate calibration table 212 stores values of shift rate for reverse driving conditions based at least in part on the shift error signal 210. In some embodiments, a switch block 213 is implemented that uses a vehicle speed signal 214 to determine the shift rate signal 209. For example, if the vehicle speed signal 214 indicates a forward driving direction, the switch block 213 passes the shift rate signal determined by the forward shift rate calibration table 211. If the vehicle signal 214 indicates a reverse driving direction, the switch block 213 passes the shift rate signal determined by the reverse shift rate calibration table 212.

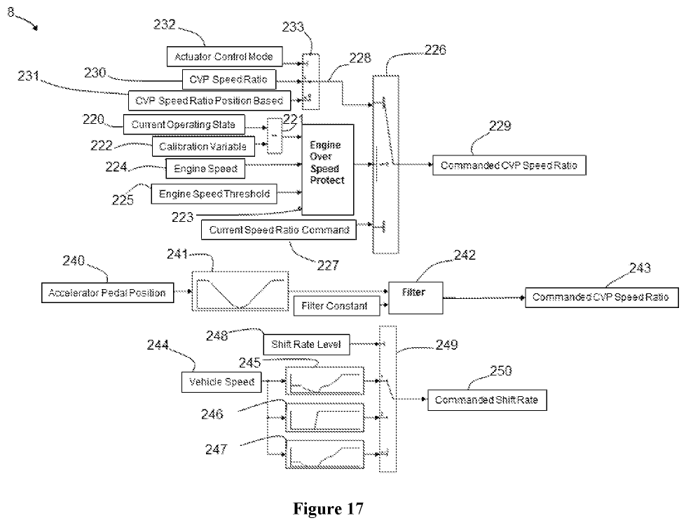

Turning now to FIG. 17, in some embodiments the power reversal control sub-module 8 is configured to receive a current operating state signal 220 that is compared at a comparison block 221 to a calibration variable 222. If the current operating state signal 220 is equal to the calibration variable 222, for example if the current operating state signal 220 is equal to a power reversal operating state, then the comparison block 221 passes a true value, or a 1, to an engine over speed protection module 223. The engine over speed protection module 223 is configured to receive an engine speed signal 224 and an engine speed threshold calibration variable 225. The engine over speed protection sub-module 223 determines a hold CVP ratio command signal that is passed to a switch block 226. In some embodiments, the switch block 226 selects between a current commanded CVP speed ratio signal 227 and an override CVP speed ratio signal 228 based at least in part on the hold CVP ratio command signal determined in the engine over speed protection sub-module 223. The switch block 226 passes a commanded CVP speed ratio signal 229. In some embodiments, the power reversal control sub-module 8 is configured to receive a CVP speed ratio signal 230 and a position-based CVP speed ratio signal 231. The position-based CVP speed ratio signal 231 is indicative of the kinematic speed ratio associated with the position of the first carrier member 106 and/or the second carrier member 107, for example. The power reversal control sub-module 8 is configured to receive an actuator control mode signal 232 that is passed to a switch block 233. The switch block 233 selects between the CVP speed ratio signal 230 and the position-based CVP speed ratio signal 231 based at least in part on the actuator control mode signal 232. For example, when the actuator control mode signal 232 is indicative of a position based control mode, the switch block 231 will pass the position-based CVP speed ratio signal 231 to the switch block 226. When the actuator control mode signal 232 is indicative of a speed ratio control mode, the switch block 231 will pass the CVP speed ratio signal 230.

In some embodiments, the power reversal control sub-module 8 is configured to receive an accelerator pedal position signal 240 that is passed to an engine speed calibration table 241. The engine speed calibration table 241 is configured to store target engine speed values based at least in part on the accelerator pedal position signal 240. The target engine speed value determined in the engine speed calibration table 241 is passed to a filter 242 and generates a commanded engine speed signal 243.

In some embodiments, the power reversal control sub-module 8 is configured to receive a vehicle speed signal 244. The vehicle speed signal 244 is passed to a first shift rate calibration table 245. The first shift rate calibration table 245 is configured to store values of shift rate based at least in part on vehicle speed. The vehicle speed signal 244 is passed to a second shift rate calibration table 246. The second shift rate calibration table 246 is configured to store values of shift rate based at least in part on vehicle speed. The vehicle speed signal 244 is passed to a third shift rate calibration table 247. The third shift rate calibration table 246 is configured to store values of shift rate based at least in part on vehicle speed. The power reversal control sub-module 8 is configured to receive a calibration variable 248 that is indicative of the shift rate level. For example, the calibration variable 248 is received in a switch block 249 and used to select among the signals received from the first shift rate calibration table 245, the second shift rate calibration table 246, and the third shift rate calibration table 247. The switch block 249 passes out a commanded shift rate signal 250. In some embodiments, the first shift rate calibration table 245, the second shift rate calibration table 246, and the third shift rate calibration table 247 contains a different set of calibration values for the shift rate based on a desired deceleration feel. It should be appreciated that any number of calibration tables can be provided in the power reversal control sub-module 8 to tune the vehicle's operating characteristics. In yet other embodiments, the calibration variable 248 may be received from a user's command signal (not shown) that originates from a button, knob, or other device accessible by the driver during operation of the vehicle.

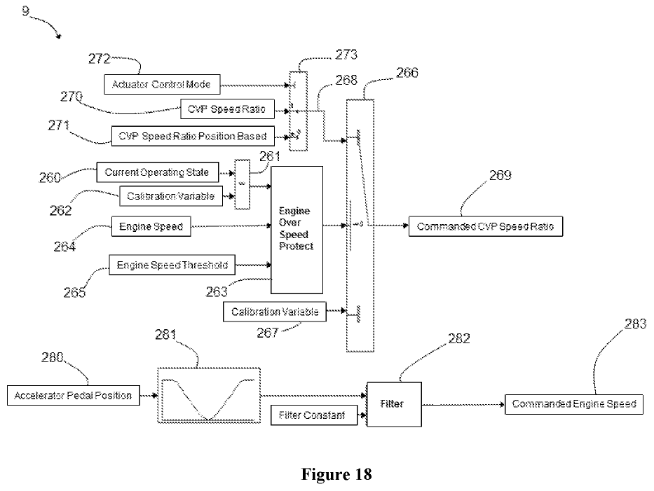

Referring now to FIG. 18, in some embodiments the transition control sub-module 9 is configured to receive a current operating state signal 260 that is compared at a comparison block 261 to a calibration variable 262. If the current operating state signal 260 is equal to the calibration variable 262, for example if the current operating state signal 260 is equal to a transition to inching operating state, then the comparison block 261 passes a true value, or a 1,

to an engine over speed protection module 263. The engine over speed protection module 263 is configured to receive an engine speed signal 264 and an engine speed threshold calibration variable 265. The engine over speed protection sub-module 263 determines a hold CVP ratio command signal that is passed to a switch block 266. In some embodiments, the switch block 266 selects between a calibration variable 267 and an override CVP speed ratio signal 268 based at least in part on the hold CVP ratio command signal determined in the engine over speed protection sub-module 263. In some embodiments, the calibration variable 267 can be a constant value that is indicative of a CVP speed ratio equal to 1.485,for example. It should be appreciated that this speed ratio is dependent upon the CVP hardware and drivetrain configuration and the value can be appropriately set to reflect the hardware. The switch block 266 passes a commanded CVP speed ratio signal 269. In some embodiments, the power reversal control sub-module 8 is configured to receive a CVP speed ratio signal 270 and a position-based CVP speed ratio signal 271. The position-based CVP speed ratio signal 271 is indicative of the kinematic speed ratio associated with the position of the first carrier member 106 and/or the second carrier member 107, for example. The transition control sub-module 9 is configured to receive an actuator control mode signal 272 that is passed to a switch block 273. The switch block 273 selects between the CVP speed ratio signal 270 and the position-based CVP speed ratio signal 271 based at least in part on the actuator control mode signal 272. For example, when the actuator control mode signal 272 is indicative of a position based control mode, the switch block 273 will pass the position-based CVP speed ratio signal 271 to the switch block 266. When the actuator control mode signal 272 is indicative of a speed ratio control mode, the switch block 271 will pass the CVP speed ratio signal 270.In some embodiments, the transition control sub-module 9 is configured to receive an accelerator pedal position signal 280 that is passed to an engine speed calibration table 281. The engine speed calibration table 281 is configured to store target engine speed values based at least in part on the accelerator pedal position signal 280. The target engine speed value determined in the engine speed calibration table 281 is passed to a filter 282 and generates a commanded engine speed signal 283.

Turning now to FIG. 19, in some embodiments the inching control sub-module 10 is configured to receive a brake pedal position signal 290 that is passed through a filter 291. The filtered brake pedal position signal 290 is used as an input signal to a forward inching calibration map 292. The forward inching calibration map 292 is configured to store values of CVP speed ratio based at least in part on the brake pedal position signal 290. The brake pedal position signal 290 is passed to a reverse inching calibration map 293. The reverse inching calibration map 293 is configured to store values of CVP speed ratio based at least in part on the brake pedal position signal 290. The inching control sub-module 10 includes a switch block 294. The switch block 294 is configured to receive a gear position signal 295. The gear position signal 295 is indicative of a position of a gear lever equipped in the vehicle. For example, the gear position signal 295 indicates forward driving and/or reverse driving commands. The switch block 294 uses the gear position signal 295 to determine a commanded CVP speed ratio signal 296. For example, under forward driving conditions, the gear position signal 295 will have a value indicative of a forward driving request, and the switch block 294 will pass the result of the forward inching calibration map 292. For a reverse driving condition, the gear position signal 295 will have a value indicative of a reverse driving request, and the switch block 294 will pass the result of the reverse inching calibration map 293.

In some embodiments, the inching control sub-module 10 is configured to receive an accelerator pedal position signal 300 that is passed to an engine speed calibration table 301. The engine speed calibration table 301 is configured to store target engine speed values based at least in part on the accelerator pedal position signal 300. The target engine speed value determined in the engine speed calibration table 301 is passed to a filter 302 and generates a commanded engine speed signal 303.

In some embodiments, the inching control sub-module 10 can be configured to receive is configured to receive a CVP speed ratio signal 305 and a position-based CVP speed ratio signal 306. The position-based CVP speed ratio signal 306 is indicative of the kinematic speed ratio associated with the position of the first carrier member 106 and/or the second carrier member 107, for example. The inching control sub-module 10 is configured to receive an actuator control mode signal 307 that is passed to a switch block 308. The switch block 308 selects between the CVP speed ratio signal 305 and the position-based CVP speed ratio signal 306 based at least in part on the actuator control mode signal 307. For example, when the actuator control mode signal 307 is indicative of a position based control mode, the switch block 308 will pass the position-based CVP speed ratio signal 306. When the actuator control mode signal 307 is indicative of a speed ratio control mode, the switch block 308 will pass the CVP speed ratio signal 305. The switch block 308 passes a signal to determine a difference between the command CVP speed ratio 296 and the speed ratio signal determined in the switch block 308. The result forms a shift error signal 309. It should be noted that the shift error signal 210 used in the normal operation control sub-module 7 may be determined by a similar method as described for the shift error signal 309. Stated differently, a shift error signal 309 is indicative of the difference between a commanded CVP speed ratio and a measured CVP speed ratio signal.

In some embodiments, the shift error signal 309 is passed to an inching shift rate calibration map 310. The inching shift rate calibration map 310 is configured to store values of a shift rate based at least in part on the shift error signal 309. In some embodiments, a delay 311 is applied to the result of passed from the inching shift rate calibration map 310 to determine a commanded shift rate signal 312.

Provided herein is a computer-implemented control system for a vehicle having an engine coupled to an infinitely variable transmission having a ball-planetary variator (CVP), the computer-implemented control system comprising: a digital processing device comprising an operating system configured to perform executable instructions and a memory device; a computer program including the instructions executable by the digital processing device, the computer program comprising a software module configured to control a plurality of operating conditions of the CVP; a plurality of sensors comprising: a vehicle direction sensor configured to sense a direction of the vehicle and provide the vehicle direction to the software module, a vehicle speed sensor configured to sense a vehicle speed and provide the vehicle speed to the software module, a brake pedal position sensor configured to sense a brake pedal position and provide the brake pedal position to the software module, an accelerator pedal position sensor configured to sense an accelerator pedal position and provide the accelerator pedal position to the software module, an engine speed sensor configured to sense an engine speed and provide the engine speed to the software module, a CVP input speed sensor configured to sense a CVP input speed and provide the CVP input speed to the software module, and a CVP output speed sensor configured to sense a CVP output speed and provide the CVP output speed to the software module, wherein the software module determines a current CVP speed ratio based on the CVP input speed and the CVP output speed, wherein the software module is configured to determine a target CVP speed ratio signal based on the accelerator pedal position, wherein the software module is configured to transmit a commanded CVP speed ratio signal based on the target CVP speed ratio signal to thereby adjust the operating condition of the CVP, wherein the software module comprises: a normal operation control sub-module configured to calculate the target CVP speed ratio based on the vehicle speed and the accelerator pedal position; an inching control sub-module configured to calculate the target CVP speed ratio based on the vehicle direction, the brake pedal position, and the engine speed; a power reversal control sub-module configured to calculate the target CVP speed ratio based on the current CVP speed ratio and the engine speed; and an automatic deceleration control sub-module configured to calculate the target CVP speed ratio based on the current CVP speed ratio, the vehicle speed, and the engine speed. In some embodiments of the computer-implemented control system, the software module further comprises a transition control sub-module configured to calculate the target CVP speed ratio based on the engine speed and the current CVP speed ratio. In some embodiments of the computer-implemented control system, the software module further comprises a hold control sub-module configured to calculate a target CVP speed ratio based on the accelerator pedal position, the brake pedal position, and the vehicle speed. In some embodiments of the computer-implemented control system, the software module further comprises a vehicle braking control sub-module configured to calculate a target CVP speed ratio based on the brake pedal position, the vehicle direction, and the current CVP speed ratio. In some embodiments of the computer-implemented control system, the normal operation control sub-module comprises a driving ratio map configured to determine a target CVP speed ratio based at least in part on the accelerator pedal position and the vehicle speed. In some embodiments of the computer-implemented control system, the normal operation control sub-module comprises a rate limit function configured to limit a rate of change of the target CVP speed ratio based at least in part on the vehicle speed. In some embodiments of the computer-implemented control system, the power reversal control sub-module further comprises an engine overspeed protection sub-module configured to command a hold of the commanded CVP speed ratio based at least in part on the engine speed and the vehicle direction. In some embodiments of the computer-implemented control system, the inching control sub-module comprises at least one calibration table defining a relationship between the brake pedal position and the vehicle speed. In some embodiments of the computer-implemented control system, the inching control sub-module comprises a function configured to determine the target CVP speed ratio based at least in part on a target vehicle speed and the engine speed. In some embodiments of the computer-implemented control system, the inching control sub-module comprises a rate limit function configured to limit a rate of change of the target CVP speed ratio based at least in part on the vehicle speed. In some embodiments of the computer-implemented control system, the automatic deceleration control sub-module comprises an engine overspeed protection sub-module configured to command a hold of the commanded CVP speed ratio based at least in part on the engine speed and the vehicle direction. In some embodiments of the computer-implemented control system, the automatic deceleration control sub-module comprises a rate limit function configured to limit a rate of change of the target CVP speed ratio based at least in part on the vehicle speed. In some embodiments of the computer-implemented control system, the vehicle direction, vehicle speed, brake pedal position, and accelerator pedal position are received from a vehicle CAN bus. In some embodiments of the computer-implemented control system, the normal operation control sub-module comprises a vehicle speed calibration map, the vehicle speed calibration map configured to store values of a target vehicle speed based at least in part on the accelerator pedal position. In some embodiments of the computer-implemented control system, the normal operation control sub-module comprises an engine speed calibration map, the engine speed calibration map configured to store values of a target engine speed based at least in part on the accelerator pedal position. In some embodiments of the computer-implemented control system, the inching control sub-module comprises an engine speed calibration map, the engine speed calibration map configured to store values for a target engine speed based at least in part on the accelerator pedal position. In some embodiments of the computer-implemented control system, the power reversal control sub-module comprises an engine speed calibration map, the engine speed calibration map configured to store values of a target engine speed based at least in part on the accelerator pedal position. In some embodiments of the computer-implemented control system, the transition control sub-module comprises an engine speed calibration map, the engine speed calibration map configured to store values for a target engine speed based at least in part on the accelerator pedal position. In some embodiments of the computer-implemented control system, the inching control sub-module further comprises an inching shift rate calibration map, the inching shift rate calibration map configured to store values of a commanded shift rate based at least in part on a shift error, wherein the shift error is calculated by the software module based at least in part on the current CVP speed ratio. In some embodiments of the computer-implemented control system, the normal operation control sub-module further comprises an inching shift rate calibration map, the inching shift rate calibration map configured to store values of a commanded shift rate based at least in part on a shift error, wherein the shift error is calculated by the software module based at least in part on the current CVP speed ratio. In some embodiments of the computer-implemented control system, the power reversal control sub-module further comprises a plurality of shift rate calibration maps, each shift rate calibration map configured to store values of a commanded shift rate based at least in part on a vehicle speed and a shift rate level, wherein the shift rate level is a calibratable value stored in the memory device.

### Discussion of Auto-Deceleration Control Systems

Auto-Deceleration is a mode of operation used to automatically decelerate a vehicle without the operator needing to utilize the brake pedal. As used herein, the system is commonly applicable to forklifts, certain off-highway vehicles such as front-end loaders, recreational vehicles, utility vehicles and commercial vehicles to name a few.

To execute the Auto-Deceleration maneuver, the operator will simply remove their foot from the accelerator, while the vehicle is moving. This will initiate an Auto-Deceleration algorithm, which will decelerate the vehicle to a stop. The algorithm for executing the Auto-Deceleration maneuver is parameterized, which allows the operator to specify an effective deceleration rate during the Auto-Deceleration maneuver.

Modes of vehicle operation are detected by a logic based Driving Manager, sub-system, or software module. The software module monitors the various vehicle signal inputs and then calls the appropriate control sub-system to execute the corresponding maneuver. The software module will execute the Auto-Deceleration algorithm when the following is detected: 1.) A change in the pressure on the accelerator pedal such as: a) The vehicle is moving either forward or reverse; AND, 2.) The accelerator pedal position (APP) is zero; AND, 3.) The brake pedal position (BPP) is zero.

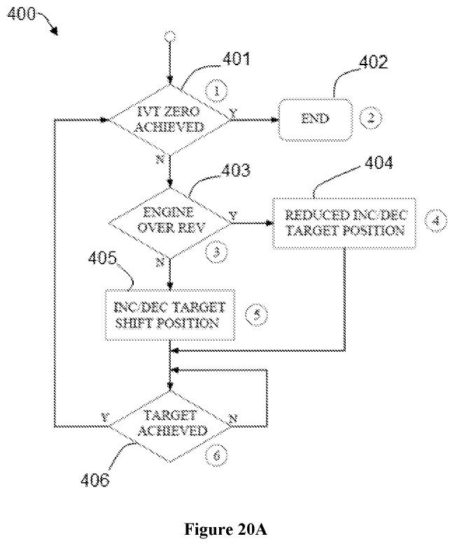

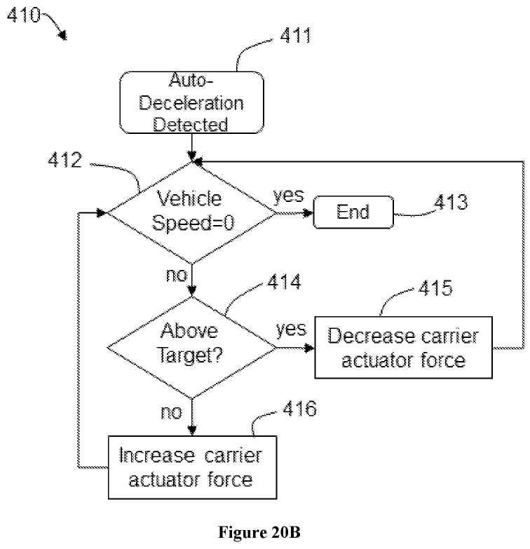

Once the Driving Manager detects the above conditions, the Auto-Deceleration algorithm is executed. FIG. 20A shows a high-level flow chart of the Auto-Deceleration algorithm 400. The Auto-Deceleration algorithm 400 starts by issuing an engine speed limit override command to the vehicle's engineering control unit (ECU, or computer) via the J1939 TSC1 CAN message.

As is commonly known to those skilled in the art, J1939 is an SAE (Society of Automotive Engineers) high-level protocol based on Controller Area Network (CAN), providing serial data communications between ECUs. A Torque/Speed Control 1 code (TSC1) is a code commonly known to those skilled in the art, for retarding or limiting the torque delivered by an engine.

The following is a description of each sub-system corresponding to the numbered labels in FIG. 20A: 1.) The Auto-Deceleration algorithm 400 starts by monitoring the current shift position to determine if the IVT is close to zero and has been achieved at evaluation block 401. In other embodiments, the Auto-Deceleration algorithm is optionally configured to monitor other operating parameters to determine if the IVT is close to zero. Close to zero is TRUE, if the shift position is less than or equal to 0.2 mm away from IVT zero condition. A shift position of zero corresponds to IVT zero, (or by way of non-limiting, illustrative example, a CVP Speed Ratio (SR) of approximately 1.458). 2.) If the shift position is close to IVT zero condition, the control system will control to IVT zero using closed-loop CVP SR control. A CVP SR of ˜1.458, for example, corresponds to IVT zero condition, as described herein, but may be different under different conditions. Once IVT zero is achieved, the Driving Manager will exit the Auto Deceleration algorithm at end state 402. 3.) If IVT zero has not been achieved, then the engine speed is monitored for over-revving at evaluation state 403. Over-revving of the engine is TRUE if the engine speed is greater than the maximum engine speed set in the controller or, in some cases adjustable by the user. For non-limiting, illustrative purposes, the maximum engine speed is, for example, an engine speed of 2700 rpm. 4.) If the engine speed is being over-revved the amount of change in position being asked is reduced using an algorithm. This algorithm uses the current engine speed, and current position. Commands to reduce the position change step size in proportion to how much the engine speed is over the revving limit are determined in a block 404. In some embodiments, this limit, as an example, could be 2700 rpm and over revving allowance could be 300 rpm. So the algorithm would kick in if the engine revs above 2700 rpm. The position delta is changed in proportion to (current engine speed—2700) normalized to 300. Over revving by 300 or more will ask for no change in position until the engine speed has reduced. 5.) If the engine speed is below 2700 rpm, the control system will increment/decrement the reference shift position towards IVT zero at a block 405. In some embodiments, the increment/decrement quantity is determined by a parameter value dependent on the vehicle direction of travel, for example, a forward direction results in a decrement command, and a reverse direction of travel results in an increment. The value of this parameter determines the deceleration rate of the vehicle. 6.) The control system waits until the measured shift position reaches the reference shift position set in the block 405. An evaluation block 406 determines if the reference shift position is achieved, the control system the goes back to item 1 above.

Referring to FIG. 20B, in some embodiments, an auto-deceleration process 410 is optionally configured to accommodate a hydraulic shift actuator for the CVP. For example, a hydraulic shift actuator is optionally coupled to the carrier assembly of the CVP. A change in hydraulic pressure corresponds to a change in force applied to the carrier and thereby adjusts the operating condition of the CVP. Those skilled in the art appreciate that the output torque of the CVP is reacted by the carrier of the CVP. Therefore, a force applied to the carrier of the CVP from the hydraulic shift actuator corresponds to a reaction torque on the carrier. The auto-deceleration process 410 begins at a state 411 where an auto-deceleration condition is detected, as discussed previously. The auto-deceleration process 410 proceeds to an evaluation block 412 where the vehicle speed is monitored. When the vehicle speed has reached a stop, or zero speed, condition, the auto-deceleration process 410 ends at an end state 402. When the vehicle speed is not at a zero speed condition, the auto-deceleration process 410 proceeds to an evaluation block 414 where a target is evaluated. In some embodiments, a target deceleration rate of the vehicle is evaluated. In some embodiments, a target engine speed is evaluated. In other embodiments, a target output torque is evaluated. When the measured feedback is above the target value for the deceleration rate, the engine speed, the output torque, or any other parameter associated with the desired deceleration condition of the vehicle, the auto-deceleration process 410 proceeds to a block 415 where commands are determined to reduce the force applied to the carrier assembly. When the measured feedback is below the target value, the auto-deceleration process 410 proceeds to a block 416 where commands are determined to increase the force applied to the carrier assembly.

For clarification, it is understood by one of skill in the art that a CVT also functions like a planetary gear set. Using a set of spheres to transfer power, the CVP ratio (or speed ratio) is changed by tilting the axes of the spheres with respect to internal input and output traction rings.

In some embodiments, an appropriate range of deceleration rate for the vehicle is −0.01 to −0.25 Gs. It is noted that vehicle designers may take a number of factors into account when determining the appropriate deceleration rate for the vehicle, for example, the durability of the hardware, the stability of the vehicle, and the desired performance of the vehicle. In some embodiments, the control system is configured to provide a closed loop control of a target vehicle deceleration. In other embodiments, the control system is configured to provide an open loop control of a target rate of change for the shift position of the shift actuator in order to achieve an appropriate vehicle deceleration. For example, the shift actuator may be a linear actuator operably coupled to a carrier of the CVP. The linear actuator may have a travel of, for example, 12 mm, where full forward corresponds to the 12 mm position, full reverse corresponds to 0 mm position, and IVT zero is at 3 mm position. Alternatively, the full forward can correspond to 9mm position, IVT zero can correspond to 0mm, and full reverse can correspond to −3 mm. The control system can be configured to specify a rate of change of the actuator, for example, 12 mm/s, as the parameter value to achieve a desirable vehicle deceleration. In yet other embodiments, the control system can be configured to provide open loop control of a target rate of change of the CVP speed ratio to achieve an appropriate vehicle deceleration.

Those of skill in the art will recognize that an “IVT Zero” condition is one in which the input speed to the transmission is non-zero while the output speed of the transmission is substantially zero.

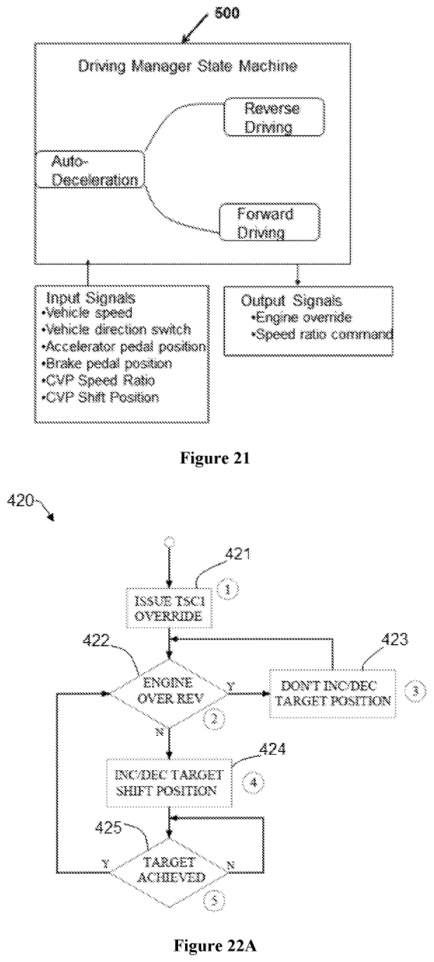

FIG. 21 is a flow chart of an Auto-Deceleration State within the Driving Manager Software Module. A Driving Manager Software Module, 500, shows only “auto-deceleration” as one state or algorithm within the Software Module, but as one skilled in the art would recognize, there is no limit to how many algorithms can be defined within the driving manager. The other maneuvers described in the other cases can be described as states of the Driving Manager Software Module.

Provided herein is a computer-implemented system for generating an auto-deceleration of a vehicle having an engine coupled to an infinitely variable transmission having a ball-planetary variator (CVP), the computer-implemented system comprising: a digital processing device comprising an operating system configured to perform executable instructions and a memory device; a computer program including instructions executable by the digital processing device to create an application comprising a software module configured to manage Auto-Deceleration; a plurality of sensors configured to monitor vehicle parameters comprising: vehicle direction, vehicle speed, brake pedal position, accelerator pedal position, engine speed, and CVP shift position, wherein the software module receives data from the sensors and executes instructions to manage a controlled auto-deceleration indicative of the vehicle direction, the vehicle speed, the brake pedal position, the accelerator pedal position, the engine speed and the CVP shift position; wherein the software module monitors a shift position and a speed ratio of the CVP; wherein the software module monitors an engine overspeed condition and controls the deceleration rate of the vehicle speed based at least in part on the engine speed; and wherein the software module commands a change in shift position of the CVP based at least in part on the position of the brake pedal.

In some embodiments of the computer-implemented system, the CVP shift position is adjusted to achieve an IVT zero condition of the vehicle. In some embodiments, the CVP shift position is adjusted by an incremental value based on a desired deceleration rate. In some embodiments, the desired deceleration rate is a user adjustable input value to the software module.

In some embodiments of the computer-implemented system, the brake pedal position is zero.

In some embodiments of the computer-implemented system, the shift position adjustment is a calibratable value stored in the memory device.

In some embodiments of the computer-implemented system, the software module commands a closed loop speed ratio (i.e.: SR of˜1.458) and commands the engine controller to reduce the torque supplied to the transmission.

In some embodiments of the computer-implemented system, an operator initiates the auto-deceleration of the vehicle while it is moving.

In some embodiments of the computer-implemented system, the software module will execute the controlled auto-deceleration when the data received from the sensors consists of: confirmation of vehicle movement in a forward or reverse direction, an accelerator pedal position (APP) equal to zero, and a brake pedal position (BPP) equal to zero.

In some embodiments, the executed auto-deceleration comprises: the vehicle movement in a forward direction, or the vehicle movement in a reverse direction, or the vehicle movement is either forward or reverse and the direction is set to neutral.

Provided herein is a computer-implemented method for an auto-deceleration of a vehicle having an engine coupled to an infinitely variable transmission having a ball-planetary variator (CVP) comprising: a) providing, by a computer, an operating system configured to perform executable instructions and a memory device; b) providing, by the computer, a program including instructions executable by the computer, to create an application comprising a software module configured to manage auto deceleration; c) providing, by the computer, a software module configured to receive data from a plurality of sensors and execute instructions to manage a controlled auto-deceleration indicative of a vehicle direction, a vehicle speed, a brake pedal position, an accelerator pedal position, an engine speed and a CVP shift position; d) providing, by the computer, the software module configured to command an engine speed limit based at least in part on the vehicle direction, the vehicle speed, the accelerator pedal position, and the brake pedal position, (or said differently, the software module monitors the engine speed so as not to over speed the engine. That is the control system will slow down the deceleration rate in the event the engine begins to over speed); e) providing, by computer, the software module configured to monitor a shift position and a speed ratio of the CVP; f) providing by computer, the software module configured to monitor an overspeed condition of the engine; and g) providing by computer, the software module configured to command a change in shift position of the CVP based at least in part on position of the brake pedal.

In some embodiments of the method, the CVP shift position is adjusted to achieve an IVT zero condition of the vehicle. In some embodiments, the CVP shift position is adjusted by an incremental value based on a desired deceleration rate. In some embodiments, the desired deceleration rate is a user adjustable input value to the software module.

In some embodiments of the method, the brake pedal position is zero.

In some embodiments of the method, the shift position adjustment is a calibratable value stored in the memory device.

In some embodiments of the method, the software module commands a closed loop speed ratio (i.e.: SR of˜1.458) and commands the engine controller to reduce the torque supplied to the transmission.

In some embodiments of the method, an operator initiates the auto-deceleration of the vehicle while it is moving.

In some embodiments of the method, the software module will execute the controlled auto-deceleration when the data received from the sensors consists of: confirmation of vehicle movement in a forward or reverse direction, an accelerator pedal position (APP) equal to zero, and a brake pedal position (BPP) equal to zero. In some embodiments, the operator-initiated auto-deceleration comprises: the vehicle movement in a forward direction, or the vehicle movement in a reverse direction, or the vehicle movement is either forward or reverse and the direction is set to neutral.

Provided herein is a non-transitory computer readable storage media encoded with a computer program including instructions executable by a digital processing device and a memory device to auto-decelerate a vehicle having an engine coupled to an infinitely variable transmission having a ball-planetary variator (CVP), comprising a software module configured to manage a controlled auto-deceleration wherein the software module receives data from a plurality of sensors and executes instructions to manage the controlled auto-deceleration indicative of a vehicle direction, a vehicle speed, a brake pedal position, an accelerator pedal position, an engine speed and a CVP shift position, wherein the software module monitors a shift position and a speed ratio of the CVP; wherein the software module monitors an engine overspeed condition and controls the deceleration rate of the vehicle speed based at least in part on the engine speed, and wherein the software module commands a change in the shift position of the CVP based at least in part on the position of the brake pedal.

In some embodiments of the non-transitory computer readable storage media, the CVP shift position is adjusted to achieve an IVT zero condition of the vehicle.

In some embodiments, the CVP shift position is adjusted by an incremental value based on a desired deceleration rate. In some embodiments, the desired deceleration rate is a user adjustable input value to the software module.

In some embodiments of the non-transitory computer readable storage media, the brake pedal position is zero.

In some embodiments of the non-transitory computer readable storage media, the shift position adjustment is a calibratable value stored in the memory device.

In some embodiments of the non-transitory computer readable storage media, the software module commands a closed loop speed ratio (i.e.: SR of ˜1.458) and commands the engine controller to reduce the torque supplied to the transmission.

Provided herein is a computer-implemented system for controlling an auto-deceleration of a vehicle having an engine coupled to an infinitely variable transmission having a ball-planetary variator (CVP), the computer-implemented system comprising: a digital processing device comprising an operating system configured to perform executable instructions and a memory device; a computer program including the instructions executable by the digital processing device, the computer program comprising a software module configured to control the auto-deceleration of the vehicle; a plurality of sensors comprising: a vehicle direction sensor adapted to sense a vehicle direction and provide the vehicle direction to the software module, a vehicle speed sensor adapted to sense a vehicle speed and provide the vehicle speed to the software module, a brake pedal position sensor adapted to sense a brake pedal position and provide the brake pedal position to the software module, an accelerator pedal position sensor adapted to sense an accelerator pedal position and provide the accelerator pedal position to the software module, an engine speed sensor adapted to sense an engine speed and provide the engine speed to the software module, and a CVP shift position sensor adapted to sense a current CVP shift position and provide the current CVP shift position to the software module, wherein the software module determines a commanded CVP shift position during the auto-deceleration of the vehicle, wherein the commanded CVP shift position is based on the vehicle direction, the vehicle speed, the brake pedal position, the accelerator pedal position, the engine speed, and the current CVP shift position; and wherein the software module is configured to control the CVP based on the commanded CVP shift position. In some embodiments of the computer-implemented control system, the commanded CVP shift position is adjusted to achieve an IVT zero condition of the vehicle. In some embodiments of the computer-implemented control system, wherein the CVP shift position is adjusted by an incremental value based on a desired deceleration rate of the vehicle. In some embodiments of the computer-implemented control system, wherein the desired deceleration rate of the vehicle is a user adjustable input to the software module. In some embodiments of the computer-implemented control system, the software module executes a command for a closed loop control of a CVP shift position. In some embodiments of the computer-implemented control system, an operator initiates the auto-deceleration of the vehicle while the vehicle is moving. In some embodiments of the computer-implemented control system, the software module executes commands for the controlled auto-deceleration of the vehicle when the data received from the sensors consists of: there is vehicle movement in a forward direction or a reverse direction, an accelerator pedal position (APP) equal to zero, and a brake pedal position (BPP) equal to zero. In some embodiments of the computer-implemented control system, the executed commands for auto-deceleration comprises: the vehicle movement in a forward direction, or the vehicle movement in a reverse direction, or the vehicle movement is either forward or reverse and the direction is set to neutral.

Provided herein is a computer-implemented method for auto-deceleration of a vehicle having an engine coupled to an infinitely variable transmission (IVT) having a ball-planetary variator (CVP), the vehicle comprising a plurality of sensors and a computer-implemented system comprising: a digital processing device comprising an operating system configured to perform executable instructions and a memory device, and a computer program including the instructions executable by the digital processing device, wherein the computer program comprises a software module configured to control deceleration of the vehicle; the method comprising controlling deceleration by: the software module receiving a plurality of signals from one or more sensors reflecting vehicle parameters sensed by the one or more sensors, the vehicle parameters comprising a vehicle direction, a vehicle speed, a brake pedal position, an accelerator pedal position, an engine speed, a CVP input speed, a CVP output speed, and a current CVP shift position; and the software module executing instructions based at least in part on the one or more vehicle parameters comprising: transmitting an engine speed limit command to the engine based at least in part on the vehicle direction, the vehicle speed, the accelerator pedal position, and the brake pedal position; monitoring the current CVP shift position, a current CVP speed ratio based upon the CVP input speed and the CVP output speed, and an engine speed limit read from the memory device; and changing the current CVP shift position based at least in part on the brake pedal position. In some embodiments of the computer-implemented method, the current CVP shift position achieves an IVT zero condition of the vehicle. In some embodiments of the computer-implemented method, changing the current CVP shift position comprising adjusting the current CVP shift position by an incremental value based on a desired deceleration rate. In some embodiments of the computer-implemented method, the desired deceleration rate is a user adjustable input value to the software module. In some embodiments of the computer-implemented method, the brake pedal position is zero. In some embodiments of the computer-implemented method, changing the current CVP shift position is based on a calibratable value stored in the memory device. In some embodiments of the computer-implemented method, the software module includes commanding a closed loop control of the current CVP speed ratio, and the software module commanding an engine controller to reduce an input torque supplied to the infinitely variable transmission. In some embodiments of the computer-implemented method, receiving an auto-deceleration initiation signal from an operator while the vehicle is moving. In some embodiments of the computer-implemented method, the software module automatically executing the method when: there is vehicle movement in a forward direction or a reverse direction, the accelerator pedal position (APP) is equal to zero, and the brake pedal position (BPP) is equal to zero. In some embodiments of the computer-implemented method, the software module executing the method when an operator initiates auto-deceleration and movement of the vehicle is in a forward direction, or movement of the vehicle is in a reverse direction, or movement of the vehicle is either in a forward direction or in a reverse direction and a direction setting is neutral.

### Discussion of Power Reversal Control Systems

Power Reversal is a mode of operation used to change the direction of a vehicle without the operator needing to take their foot off the accelerator pedal. As used herein, the system is commonly applicable to forklifts, certain off-highway vehicles such as front-end loaders, recreational vehicles, utility vehicles and many commercial vehicles to name a few.

To execute the Power Reversal maneuver, the operator will command a change in direction via a Vehicle Direction switch, while the vehicle is moving. This will initiate a Power Reversal algorithm 420, which will decelerate the vehicle to a stop, and then launch the vehicle in the opposite direction. The algorithm for executing the Power Reversal maneuver is parameterized, which would allow the operator to specify an effective deceleration rate during the deceleration portion of the Power Reversal maneuver.

Modes of vehicle operation are detected by a logic based Driving Manager, sub-system, or software module. The software module monitors the various vehicle signal inputs and then calls the appropriate control sub-system to execute the corresponding maneuver. The software module will execute the Power Reversal algorithm 420 when the following is detected: 1.) A change in commanded Direction such as: a) The vehicle is moving forward and the Direction is set to reverse OR, b) The vehicle is moving in reverse and Direction is set to forward OR, c) The vehicle is moving forward or reverse and Direction is set to neutral; AND, 2.) The accelerator pedal position (APP) is greater than zero; AND, 3.) The brake pedal position (BPP) is zero.

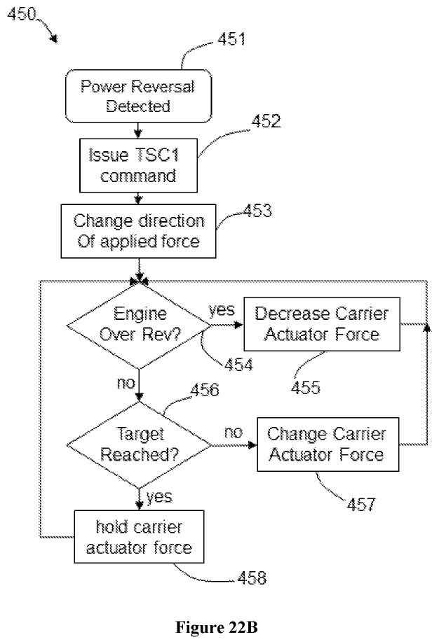

Once the Driving Manager 500 detects the above conditions, the Power Reversal algorithm 420 is executed. FIG. 22A shows a high-level flow chart of the Power Reversal algorithm 420. The following is a description of each sub-system corresponding to the numbered labels in FIG. 22A: 1.) The Power Reversal algorithm starts by issuing an engine speed limit override command at a block 421 to the vehicle's engineering control unit (ECU, or computer) via the J1939 TSC1 CAN message.

As is commonly known to those skilled in the art, J1939 is an SAE (Society of Automotive Engineers) high-level protocol based on Controller Area Network (CAN), providing serial data communications between ECUs. A Torque/Speed Control 1 code (TSC1) is a code commonly known to those skilled in the art, for retarding or limiting the torque delivered by an engine.

For the purposes of a non-limiting illustrative example herein, the engine speed limit is set to 800 rpm. This effectively causes the ECU to reduce the engine torque even though the accelerator pedal is still being pressed. 2.) The engine speed is then monitored for over-revving at an evaluation block 422. Over-revving of the engine is TRUE if the engine speed is greater than the maximum engine speed, for illustrative example, a maximum engine speed of 2700 rpm, is used in this discussion. 3.) If the engine speed is being over-revved due to back driving the engine, the controller will not down shift the IVT at a command block 423. 4.) If the engine speed is below 2700 rpm, for example, the power reversal algorithm 420 proceeds to a block 424 where a command is determined to a change in the reference shift position towards IVT zero at a shift rate between approximately ±0.25 and ±5.5 mm/sec, depending on if the vehicle is moving forward (decrement) or reverse (increment). The value of this parameter determines the deceleration rate of the vehicle. In some embodiments, an appropriate range of deceleration rate for the vehicle is −0.01 to −0.25 Gs. It is noted that vehicle designers may take a number of factors into account when determining the appropriate deceleration rate for the vehicle, for example, the durability of the hardware, the stability of the vehicle, and the desired performance of the vehicle. In some embodiments, the control system is configured to provide a closed loop control of a target vehicle deceleration. In other embodiments, the control system is configured to provide an open loop control of a target rate of change for the shift position of the shift actuator in order to achieve an appropriate vehicle deceleration. For example, the shift actuator may be a linear actuator operably coupled to a carrier of the CVP. The linear actuator may have a travel of, for example, 12 mm, where full forward corresponds to the 12 mm position, full reverse corresponds to 0 mm position, and IVT zero is at 3 mm position. Alternatively, the full forward can correspond to 9 mm position, IVT zero can correspond to 0 mm, and full reverse can correspond to −3 mm. The control system can be configured to specify a rate of change of the actuator, for example, 12 mm/s, as the parameter value to achieve a desirable vehicle deceleration. In yet other embodiments, the control system can be configured to provide open loop control of a target rate of change of the CVP speed ratio to achieve an appropriate vehicle deceleration. 5.) The Power Reversal algorithm 420 proceeds to an evaluation block 425 and waits until the measured shift position reaches the reference shift position set in item 4 above. The Power Reversal algorithm 420 from 2-5 is repeated until one of the following is true: a.) If the vehicle speed is less than zero and the Direction is set to reverse, then the software module (Driver Manager) will issue a command to exit the Power Reversal algorithm 420 and call up the Reverse driving algorithm. At this point the engine speed limit override command will be removed and the engine will launch in reverse since the accelerator pedal is still being pressed. b.) If the vehicle speed is greater than zero and the Direction is set to forward, then the software module (Driver Manager) will issue a command to exit the Power Reversal algorithm 420 and call the forward driving algorithm. At this point the engine speed limit override command will be removed and the engine will launch forward since the accelerator pedal is still being pressed. c.) If the vehicle speed is substantially zero (herein defined as approximately ±0.1 rpm) and the Direction is set to neutral, then the software module (Driver Manager) will issue a command to exit the Power Reversal algorithm 420 and call the Neutral algorithm. At this point the engine speed limit override command will be removed and the engine speed will rev-up since the accelerator pedal is still being pressed.

As is known to those skilled in the art, elucidate, during the deceleration portion of the power reversal maneuver, the engine speed is dictated by the current vehicle speed and IVT/CVP speed ratio, and the power flow has reversed, in which case the vehicle's kinetic energy is not driving the engine through the vehicle drive train. This is referred to as back driving of the engine or more commonly engine braking. That is, the engine is causing a retarding load tending to slow down the coasting vehicle.

Referring now to FIG. 22B, the Driving Manager software module is optionally configured to execute a power reversal control process 450 for use with shift actuators adapted to control an applied force to the CVP As mentioned previously, hydraulic shift actuators are optionally configured to couple to the carrier assembly of the CVP and provide control of the CVP ratio with the application of hydraulic pressure and/or force. The power reversal control process 450 begins at a state 451 where a power reversal condition is detected. The power reversal control process 450 proceeds to a block 452 where a command to override the TSC1 signal is issued. The power reversal control process 450 proceeds to a block 453 where a change in the direction of applied force on the shift actuator is commanded. The power reversal control process 450 proceeds to a first evaluation block 454 where the engine speed is compared to an engine speed limit or upper threshold value. If the first evaluation block 454 returns a true result, the power reversal control process 450 proceeds to a block 455 where a command is issued to decrease the current carrier actuator force. If the first evaluation block 454 returns a false result, the power reversal control process 450 proceeds to a second evaluation block 456 where a target is evaluated. In some embodiments, a target deceleration rate of the vehicle is evaluated. In some embodiments, a target engine speed is evaluated. In other embodiments, a target output torque is evaluated. When the measured feedback is below the target value for the deceleration rate, the engine speed, the output torque, or any other parameter associated with the desired deceleration condition of the vehicle, the power reversal control process 450 proceeds to a block 457 where commands are determined to change the force applied to the carrier assembly. When the measured feedback is above the target value, the power reversal control process 450 proceeds to a block 458 where commands are determined to hold the force applied to the carrier assembly.

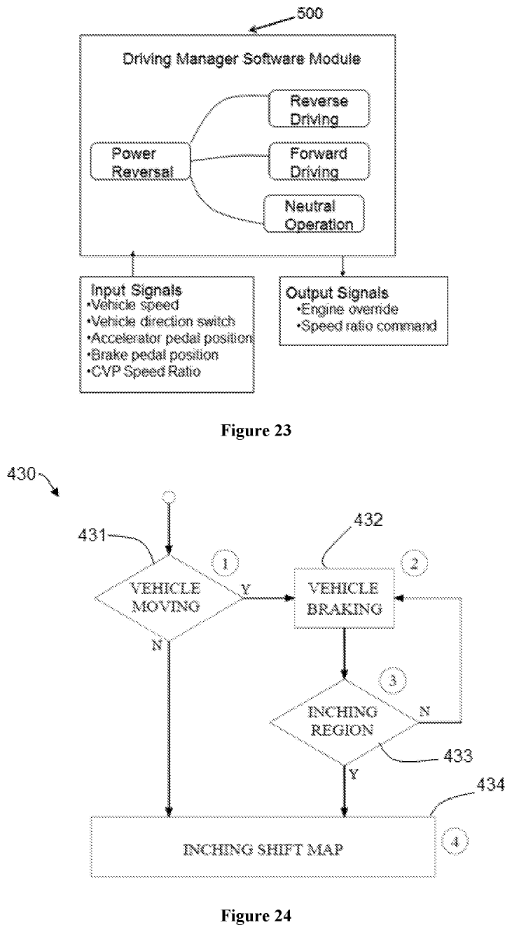

FIG. 23 is a flow chart of a Power Reversal State within the Driving Manager Software Module. The Driving Manager Software Module, 500, shows only “power reversal” as one state or algorithm within the Software Module, but as one skilled in the art would recognize, there is no limit to how many algorithms can be defined within the driving manager. The other maneuvers described in the other cases can be described as states of the Driving Manager Software Module.

Provided herein is a computer-implemented system for changing direction of a vehicle having an engine coupled to an infinitely variable transmission having a ball-planetary variator (CVP), the computer-implemented system comprising: a digital processing device comprising an operating system configured to perform executable instructions and a memory device; a computer program including instructions executable by the digital processing device to create an application comprising a software module configured to manage power reversal; a direction switch configured to signal a desired change of direction, a plurality of sensors configured to monitor vehicle parameters comprising: vehicle direction, vehicle speed, brake pedal position, accelerator pedal position, engine speed, and CVP shift position, wherein the software module receives data from the direction switch and sensors and executes instructions to manage a controlled power reversal indicative of the desired vehicle direction, the vehicle speed, the brake pedal position, the accelerator pedal position, the engine speed and the CVP shift position; wherein the software module commands an engine speed limit based at least in part on the vehicle direction, the vehicle speed, the accelerator pedal position, and the brake pedal position; wherein the software module monitors an overspeed condition of the engine; and wherein the software module commands a change in shift position of the CVP based at least in part on the engine speed.

In some embodiments of the system, the CVP shift position is adjusted to achieve an engine speed below an overspeed condition of the engine. In some embodiments, the CVP shift position is adjusted by an incremental value based on a desired deceleration rate. As noted previously, by way of non-limiting illustrative example, an appropriate range of deceleration rate for the vehicle is −0.01 to −0.25 Gs. In some embodiments, the desired deceleration rate is a user adjustable input value to the software module.

In some embodiments of the system, the commanded change in shift position is further based at least in part on the accelerator pedal position. In some embodiments, the commanded change in shift position is a calibratable value stored in the memory device.

In some embodiments of the system, the software module commands an engine speed corresponding to an engine idle speed (i.e.: 800 rpm, for example) and the digital processing device reduces engine torque transmitted to the transmission.

In some embodiments of the system, an operator initiates the change of direction of the vehicle while it is moving.

In some embodiments of the system, the software module will execute the controlled power reversal when the data received from the sensors consists of: an operator-commanded change in direction, an accelerator pedal position greater than zero, and a brake pedal position equal to zero.

In some embodiments, the operator-commanded change in direction comprises: the vehicle movement in a forward direction and the operator-commanded direction is set to reverse, or the vehicle movement in a reverse direction and the operator-commanded direction is set to forward, or the vehicle movement is either forward or reverse and the operator-commanded direction is set to neutral.

Provided herein is a computer-implemented method for changing direction of a vehicle having an engine coupled to an infinitely variable transmission having a ball-planetary variator (CVP) comprising: a) providing, by a computer, an operating system configured to perform executable instructions and a memory device; b) providing, by the computer, a program including instructions executable by the computer, to create an application comprising a software module configured to manage power reversal; c) providing, by the computer, a software module configured to receive data from a direction switch and a plurality of sensors and execute instructions to manage a controlled power reversal indicative of a desired vehicle direction, a vehicle speed, a brake pedal position, an accelerator pedal position, an engine speed and a CVP shift position; d) providing, by the computer, the software module configured to command an engine speed limit based at least in part on the vehicle direction, the vehicle speed, the accelerator pedal position, and the brake pedal position; e) providing by computer, the software module configured to monitor an overspeed condition of the engine; and f) providing by computer, the software module configured to command a change in shift position of the CVP based at least in part on the engine speed.

In some embodiments of the method, the CVP shift position is adjusted to achieve an engine speed below an overspeed condition of the engine. In some embodiments, the CVP shift position is adjusted by an incremental value based on a desired deceleration rate. In some embodiments, the desired deceleration rate is a user adjustable input value to the software module.

In some embodiments of the method, the commanded change in shift position is further based at least in part on the accelerator pedal position. In some embodiments, the commanded change in shift position is a calibratable value stored in the memory device.

In some embodiments of the method, the software module commands an engine speed corresponding to an engine idle speed (i.e.: 800 rpm, for example) and the computer reduces engine torque transmitted to the transmission.

In some embodiments of the method, an operator initiates the change of direction of the vehicle while it is moving.

In some embodiments of the method, the software module will execute the controlled power reversal when the data received from the direction switch and the sensors consists of: an operator-commanded change in direction, an accelerator pedal position greater than zero, and a brake pedal position equal to zero.

In some embodiments, the operator-commanded change in direction comprises: the vehicle movement in a forward direction and the operator-commanded direction is set to reverse, or the vehicle movement in a reverse direction and the operator-commanded direction is set to forward, or the vehicle movement is either forward or reverse and the operator-commanded direction is set to neutral.

Provided herein is a non-transitory computer readable storage media encoded with a computer program including instructions executable by a digital processing device having a memory device, to change direction of a vehicle having an engine coupled to an infinitely variable transmission having a ball-planetary variator (CVP), comprising a software module configured to manage a controlled power reversal wherein the software module receives data from a direction switch and a plurality of sensors and executes instructions to manage the controlled power reversal indicative of a desired vehicle direction, a vehicle speed, a brake pedal position, an accelerator pedal position, an engine speed and a CVP shift position, wherein the software module commands an engine speed limit based at least in part on the vehicle direction, the vehicle speed, the accelerator pedal position, and the brake pedal position, wherein the software module monitors an overspeed condition of the engine, and wherein the software module commands a change in the shift position of the CVP based at least in part on the engine speed.

Provided herein is a computer-implemented system for changing direction of a vehicle having an engine coupled to an infinitely variable transmission having a ball-planetary variator (CVP), the computer-implemented system comprising: a digital processing device comprising an operating system configured to perform executable instructions and a memory device; a computer program including the instructions executable by the digital processing device, the computer program comprising a software module configured to control a power reversal of the vehicle; a plurality of sensors comprising: a vehicle direction sensor adapted to sense a vehicle direction and provide the vehicle direction to the software module, a vehicle speed sensor adapted to sense a vehicle speed and provide the vehicle speed to the software module, a brake pedal position sensor adapted to sense a brake pedal position and provide the brake pedal position to the software module, an accelerator pedal position sensor adapted to sense an accelerator pedal position and provide the accelerator pedal position to the software module, an engine speed sensor adapted to sense an engine speed and provide the engine speed to the software module, and a CVP shift position sensor adapted to sense a current CVP shift position and provide the current CVP shift position to the software module, wherein the software module controls the CVP and the engine during a reversal of the vehicle direction; wherein the software module transmits a first command for an engine speed limit based at least in part on the current vehicle direction, the vehicle speed, the accelerator pedal position, and the brake pedal position; and wherein the software module transmits a second command for a change in the CVP shift position based at least in part on the engine speed. In some embodiments of the computer-implemented system, the command for a change in the CVP shift position is adjusted to achieve an engine speed below an overspeed condition of the engine, wherein the overspeed condition of the engine is a calibratable value stored in the memory device. In some embodiments of the computer-implemented system, the command for a change in the CVP shift position is adjusted by an incremental value based on a desired deceleration rate. In some embodiments of the computer-implemented system, the desired deceleration rate is a user adjustable input value to the software module. In some embodiments of the computer-implemented system, the command for a change in the CVP shift position is further based at least in part on the accelerator pedal position. In some embodiments of the computer-implemented system, the command for a change in the CVP shift position is a calibratable value stored in the memory device. In some embodiments of the computer-implemented system, the software module commands an engine speed corresponding to an engine idle speed, and the digital processing device reduces engine torque transmitted to the transmission. In some embodiments of the computer-implemented system, an operator initiates the change of direction of the vehicle while it is moving. In some embodiments of the computer-implemented system, the software module executes the controlled power reversal of the vehicle when: an operator-commanded change in direction, the accelerator pedal position being greater than zero, and the brake pedal position being equal to zero. In some embodiments of the computer-implemented system, the operator-commanded change in direction comprises: movement of the vehicle in a forward direction and the direction switch is set to reverse by the operator, or movement of the vehicle in a reverse direction and the direction switch is set to forward by the operator, or movement of the vehicle is either in the forward direction or the reverse direction and the direction switch is set to neutral by the operator.

Provided herein is a computer-implemented method for changing direction of a vehicle comprising an engine coupled to an infinitely variable transmission (IVT) having a ball-planetary variator (CVP), a direction switch, a plurality of sensors, and a computer-implemented system comprising: a digital processing device comprising an operating system configured to perform executable instructions and a memory device, and a computer program including the instructions executable by the digital processing device, wherein the computer program comprises a software module configured to change direction of the vehicle, the method comprising changing direction of the vehicle by: receiving first data from the direction switch indicating a desired vehicle direction; receiving second data from one or more of the sensors configured to sense a current vehicle direction, a vehicle speed, a brake pedal position, an accelerator pedal position, an engine speed, and a CVP shift position; executing the instructions to manage a controlled power reversal based on the desired vehicle direction, the vehicle speed, the brake pedal position, the accelerator pedal position, the engine speed and the CVP shift position; transmitting a first command for an engine speed limit based at least in part on the current vehicle direction, the vehicle speed, the accelerator pedal position, and the brake pedal position; monitoring an overspeed condition of the engine; and transmitting a second command for a change in the CVP shift position based at least in part on the engine speed. In some embodiments of the computer-implemented method, transmitting the second command comprises adjusting the engine speed below the overspeed condition. In some embodiments of the computer-implemented method, the change in the CVP shift position is an incremental value or amount based on a desired deceleration rate. In some embodiments of the computer-implemented method, the desired deceleration rate is a user adjustable input value to the software module. In some embodiments of the computer-implemented method, the change in the CVP shift position is based at least in part on the accelerator pedal position. In some embodiments of the computer-implemented method, the change in the CVP shift position is a calibratable value stored in the memory device. In some embodiments of the computer-implemented method, the software module commands the engine speed corresponding to an engine idle speed and wherein the method further comprises reducing engine torque transmitted to the infinitely variable transmission. In some embodiments of the computer-implemented method, changing direction of the vehicle is initiated by an operator of the vehicle while the vehicle is moving. In some embodiments of the computer-implemented method, the software module executes the changing direction of the vehicle when the first data received from the direction switch and the second data received the sensors comprises: an operator-commanded change in direction, the accelerator pedal position being greater than zero, and the brake pedal position being equal to zero. In some embodiments of the computer-implemented method, the operator-commanded change in direction comprises: movement of the vehicle in a forward direction and the direction switch is set to reverse by the operator, or movement of the vehicle in a reverse direction and the direction switch is set to forward by the operator, or movement of the vehicle is either in the forward direction or the reverse direction and the direction switch is set to neutral by the operator.

### Discussion of Inching Maneuver Control Systems

An Inching maneuver is a mode of operation used to precisely maneuver a forklift or similar lifting vehicle, and/or simultaneously elevating or lowering the payload lift apparatus. Inching occurs when the power shift transmission is partially disengaged at the same time the vehicle truck brakes are being slightly applied and is similar in some regards to “slipping the clutch” in a manual transmission. Inching can allow slow controlled movement of the lift vehicle and is accomplished by simultaneous operation of the brake pedal and the accelerator. In prior applications, an Inching maneuver is typically engaged from a vehicle stand-still (zero) speed. As used herein, the system is commonly applicable to forklifts, certain off-highway vehicles such as front-end loaders, utility vehicles, recreational vehicles and commercial vehicles to name a few.

To execute the Inching maneuver, the operator will simple depress both the accelerator pedal and the brake pedal, simultaneously, beyond a minimum detectable threshold value for each, when the vehicle is in either, a “stand-still” position or moving. This will cause the control system to override the accelerator, taking command of the engine speed, reducing torque and initiating a controlled deceleration or “coast down” of the vehicle, even though the accelerator pedal is still depressed. In the event the vehicle is moving, the control system will issue an engine speed limit override command to the vehicle ECU. Once this command is sent, the control logic is similar to the manual braking control algorithm (described elsewhere) to transition the vehicle from a moving condition to within the operator condition of inching.

Once the vehicle speed is low enough to be in the inching mode range, the override command is withdrawn, the CVP shift position is adjusted based on the brake pedal position and the engine speed is commanded based on the accelerator pedal and can be allowed to deliver full power. The algorithm for executing the Inching maneuver is parameterized, utilizing a stored set of conditions (lookup tables) to specify an effective deceleration rate during the transition to Inching mode, and appropriate engine speeds, CVP shift positions and engine torque delivery while engaged in the Inching mode. Once fully engaged, an Inching maneuver mode will allow slow, controlled movements of the vehicle and/or lifting mechanism.

Modes of vehicle operation are detected by a logic based Driving Control Manager system, or electronic control unit software module. The software module monitors the various vehicle signal inputs and then calls the appropriate control sub-system to execute the corresponding maneuver. The software module will execute the Inching maneuver algorithm when the following are both detected: 1.) Engagement of the accelerator pedal position (APP) sensor is registering a minimum threshold value greater than zero (“0”); AND, 2.) Engagement of the brake pedal position (BPP) sensor is registering a minimum threshold value greater than zero (“0”).

More specifically, the system described herein will execute the Inching maneuver algorithm when: 1.) Engagement of the accelerator pedal position (APP) sensor is greater than a minimum detectable threshold; AND, 2.) Engagement of the brake pedal position (BPP) sensor is greater than minimum detectable threshold. As an example, the APP threshold as described herein has been set to 5% and BPP threshold as described herein has been set to 6%.

Once the Driving Manager detects the above conditions, the Inching maneuver algorithm is executed. FIG. 24 shows a high-level flow chart of the Inching maneuver algorithm 430. The following is a description of each sub-system corresponding to the numbered labels in FIG. 24: 1.) The Inching maneuver algorithm 430 starts at a state 431 where monitoring of the current vehicle speed is performed to determine if the vehicle is moving, as depicted in process step 1. If the vehicle is moving, a Manual Braking control strategy 432 is used to reduce the speed of the vehicle. In some embodiments, an engine speed limit override command is sent to the vehicle's ECU via the J1939 TSC1 CAN message. As is commonly known to those skilled in the art, J1939 is an SAE (Society of Automotive Engineers) high-level protocol based on Controller Area Network (CAN), providing serial data communications between ECUs. A Torque/Speed Control 1 code (TSC1) is a code commonly known to those skilled in the art, for retarding or limiting the torque delivered by an engine.

Additionally, with the TSC1 command you can explicitly limit the engine speed and torque. In fact, these are two separate values. For example, if one were to limit the engine to 2000 rpm and 100 Nm. The ECU will begin to reduce torque if either of these two conditions are exceeded.

In a non-limiting illustrative example of the system described herein, when an engine speed limit override command is sent to the vehicle's ECU via the J1939 TSC1 CAN message, the engine speed limit is set to 800 rpm, (representing a nominal idle speed of the engine). This effectively causes the ECU to reduce the engine torque even though the accelerator pedal is still being pressed. As illustrated in FIG. 24, if the vehicle is still moving, vehicle braking (process step 2, manual braking control 432) continues until the shift position (or IVT speed ratio) has reached the effective operating range for executing the inching maneuver based on the current brake pedal position value. The vehicle speed is evaluated at an evaluation block 433 to determine if the vehicle speed is within inching range and the shift position (or IVT speed ratio) has reached the effective operating range for inching, the control algorithm removes the engine speed override command and proceeds to the inching shift map (process step 4). Stated differently, during the actual inching maneuver, the shift position (or IVT speed ratio) is a function of BPP (i.e. inching map). During the transition from driving to inching, the system considers the vehicle has reached the inching operating range when the shift position (or IVT speed ratio) reaches the value that corresponds to the shift map and current BPP value.

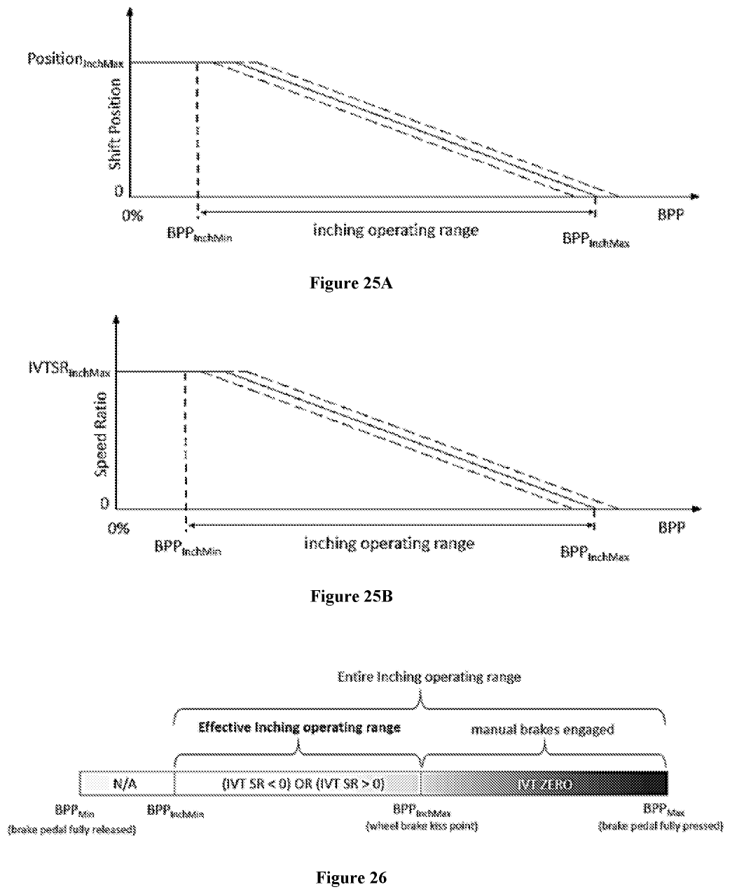

During this process, the control algorithm commands a reference shift position based on the BPP signal. FIG. 25A illustrates the mapping from BPP to a reference shift position for the case of forward driving. For this case, the shift position is bounded between 0 and Position_{InchMax}. For low values of BPP (default minimum value of BPP_{InchMax}, is 6%), the shift position is saturated to Position_{InchMax} and corresponds to the highest overdrive condition allowed for inching. By way of example, a default value of Position_{InchMax} may be 1.65 mm of travel on a position sensor. As the value of BPP increases, the reference shift position decreases (i.e. the IVT speed ratio decreases towards IVT zero). Once the BPP reaches a value of BPP_{InchMax}, (default maximum value of BPP_{InchMax}, is 14%) the reference shift position is saturated to zero. The default value of BPP_{InchMax}, corresponds to the condition where the brakes begin to engage. In clutch systems this is sometimes referred to as the “kiss” point. The BPP is quantized to negate the effects of fluctuations in the BPP signal that are not necessarily noise. The software module commands a reference shift position based on the quantized BPP value, each BPP quanta adding or subtracting a position delta between the position range of 0 and Position_{inchMax}. The resolution of the quantization is set at code compilation. By way of example, the default delta for reference shift position over BPP is 0.15 mm/%. A hysteresis scheme is also implemented to prevent excessive switching in reference shift position due to small oscillating changes in BPP. A similar logic is used for reverse driving, except the reference shift positions take on negative values.

Those of skill in the art will recognize that an “IVT Zero” condition is one in which the input speed to the transmission is non-zero while the output speed of the transmission is substantially zero.

### Shift Position

Those of skill in the art will recognize that in some embodiments, a shift position can be associated with the relative position of an actuator coupled to the CVP. For example, an electronic linear or rotary actuator can be coupled to the carrier of the CVP to provide a rotation of the carrier and thereby modify the operating condition of the CVP. In other embodiments, a hydraulic actuator may be used to adjust the carrier of the CVP.

As used herein, reference to a shift position can be that of an actuator position or a carrier position; (for example, the position of a linear actuator with respect to a reference position or a relative rotational position of a carrier). It should be understood that any variable configured to provide feedback indicative of a physical positioning of the CVP that corresponds to an operating condition could be used in the control systems and algorithms described herein.

Position vs. Speed Ratio Control

Further, those skilled in the art will recognize that in some embodiments, a control system can be configured to use a variable indicative of shift position as a feedback variable. In other embodiments, a control system can be configured to use a variable indicative of CVP speed ratio as a feedback variable. Under certain operating conditions, for example low speed or zero speed conditions, when the transmission speed ratio is not available as a variable, the shift position can be used as a feedback variable. Under some operating conditions, for example a high torque condition, when there is creep or slip occurring in the CVP, it may be desirable to use speed ratio and shift position as feedback variables. In other operating conditions, the control system can utilize transmission speed ratio as a feedback variable.

Alternatively, FIG. 25B illustrates the mapping from BPP to an IVT speed ratio for the case of forward driving. For this case, the speed ratio is bounded between 0 and IVTSR_{InchMax}. For low values of BPP (default minimum value of BPP_{InchMin}, is 6%), the IVT speed ratio is saturated to IVTSR_{InchMax} and corresponds to the highest overdrive condition allowed for inching. By way of non-limiting illustrative example, a default value of IVTSR_{InchMax} may be 0.2. As the value of BPP increases, the reference IVT speed ratio decreases towards IVT zero. Once the BPP reaches a value of BPP_{InchMax}, the reference IVT speed ratio is saturated to zero. (The default value of BPP_{InchMax}, corresponds to the condition where the brakes begin to engage.) The BPP is quantized to negate the effects of fluctuations in the BPP signal that are not necessarily noise. The software module commands a reference IVT ratio based on the quantized BPP value, each BPP quanta adding or subtracting a ratio delta between the IVT ratio range of 0 and IVTSRinchMax. The resolution of the quantization is set at code compilation. By way of non-limiting illustrative example, the default delta of IVT SR over BPP is 0.02%⁻¹. A hysteresis scheme is also implemented to prevent excessive switching in reference IVT speed ratio due to small oscillating changes in BPP. A similar logic is used for reverse driving, except the reference IVT speed ratios take on negative values.

FIG. 26 is a representative scale chart of an Inching maneuver range within the functional range of the brake pedal position. As shown herein, the effective Inching Range detectable by the brake position sensors is between 6% (minimum brake pedal threshold detection for inching) and 14% (maximum brake pedal threshold for inching): The condition of wheel lockup will begin to occur somewhere in the region described here: BPP_{inchMax}≤BPP≤BPPₘₐₓ, but not necessarily over this entire range. When BPP=f, BPP_{inchMin}, (sometimes called the “kiss point”) and is the condition where the wheel brakes begin to engage. By way of example, the brake pedal maximum engagement range may be a range set on the sensors between 14% and 20%. The Driving Manager Software Module, 500 is optionally configured to include an “inching maneuver” as one state or algorithm within the Software Module, but as one skilled in the art would recognize, there is no limit to how many algorithms or sub-systems can be defined within the driving manager 500. The other maneuvers described in the other cases can be described as states of the Driving Control Manager Software Module.

As suggested above, an alternative driving scenario provides for the situation where the inching maneuver may also be engaged when the vehicle is traveling at a non-zero speed or speed in excess of the Inching maneuver speed range. For example, an operator can be traveling at an elevated speed and depress the brake pedal, while simultaneously depressing the accelerator pedal. In this scenario, the vehicle slows down because the brakes are engaged, and the control system detects an activation of the brake pedal sensor, simultaneously with the accelerator pedal being in a depressed state, and issues an override command to the engine to bring the engine power down, while the driver maintains depressed pedal positions on brake and accelerator. As the vehicle slows down, the driver may reposition the brake pedal to correspond to a sensor position within the inching threshold (i.e.: between 6% and 14%). In that event, the current shift position or IVT speed ratio can be compared to the shift position or IVT speed ratio expected for that particular brake pedal position. If the shift position or IVT speed ratio corresponds to the inching range (as noted in FIG. 5A), then the override command for the accelerator pedal position is withdrawn thereby allowing the engine speed and power to satisfy the request from the driver, and the driving manager transitions the control state into an inching state from the manual braking/coast-down state. Likewise, the driving manager can be configured to transition out of the inching maneuver when the driver has removed any commanded brake pedal position while depressing the accelerator pedal position.

Provided herein is a computer-implemented system for generating an inching maneuver mode in a vehicle having an engine coupled to an infinitely variable transmission having a ball-planetary variator (CVP), the computer-implemented system comprising: a digital processing device comprising an operating system configured to perform executable instructions and a memory device; a computer program including instructions executable by the digital processing device to create an application comprising a software module configured to manage a controlled inching maneuver; a plurality of sensors configured to monitor vehicle parameters comprising: vehicle direction, vehicle speed, brake pedal position, accelerator pedal position, engine speed, and CVP shift position, wherein the software module receives data from the plurality of sensors and executes instructions to manage the controlled inching maneuver indicative of the vehicle direction, the vehicle speed, the brake pedal position, the accelerator pedal position, the engine speed and the CVP shift position; wherein the software module monitors the CVP shift position and a speed ratio of the CVP; wherein the software module commands an engine speed to control an engine torque based at least in part on the vehicle direction, the vehicle speed, and the accelerator pedal position; and wherein the software module commands a change in CVP shift position based at least in part on the position of the brake pedal.

In some embodiments, the software module is activated when the sensors detect a minimum position setting for both the brake pedal position and the accelerator pedal position.

In some embodiments, the software module commands an engine speed override limit to reduce the engine torque if the vehicle speed is in excess of speed limits set for the inching mode when transitioning into the inching mode.

In some embodiments, the CVP shift position is adjusted by a delta whose value is based on the brake pedal position.

In some embodiments, the CVP shift position is adjusted towards IVT speed ratio zero condition as the value of the brake pedal position increases.

In some embodiments, the CVP shift position is adjusted to an IVT speed ratio zero condition when the brake pedal position sensor detects a maximum inching position threshold value regardless of the accelerator pedal position setting. In other words, when the brake pedal position (BPP) is equal to or exceeds PBP_{inchMax}, then the system will be at IVT zero, regardless of the accelerator pedal position.

In some embodiments, the software module generates an effective inching maneuver range between a minimum brake pedal inching position threshold value and maximum brake pedal inching position threshold value. In this situation the inching maneuver is executed when the brake pedal position is between BPP_{inchMin} and BPP_{inchMax} and APP is greater than some minimum threshold (to be considered pressed). However, even when BPP>BPP_{inchMax} the Inching algorithm can be executed . . . just that IVT zero will be commanded when BPP_{inchMax}≤BPP≤BPPₘₐₓ. In other words, the inching maneuver would be executed when APP is greater than some minimum threshold (to be considered pressed) and BPP>PBP_{inchMin}.

In some embodiments, the software module generates the inching maneuver mode when the brake pedal position exceeds the maximum brake pedal inching position threshold value. The inching algorithm can still be executed when BPP>BPP_{inchMax}. That is, the system will be at IVT zero for conditions where BPP_{inchMax}≤BPP≤BPP_{inchMax}. This represents the region where the brakes begin to engage (BPP_{inchMax}) up to where the brake pedal is fully pressed (BPPₘₐₓ). All of these conditions will correspond to IVT zero, but nonetheless this is still part of inching. Only under the condition: BPP<BPP_{inchMin} will the inching algorithm not be executed, (regardless of the APP position).

In some embodiments, the BPP is quantized to negate the effects of fluctuations in the BPP signal that are not necessarily noise. The software module commands a reference shift position based on the quantized BPP value, each BPP quanta adding or subtracting a position delta between the position range of 0 and Position_{inchMax}.

In some embodiments, a resolution of the quantization is set when a code for the software module is compiled.

In some embodiments, a hysteresis scheme is implemented to prevent excessive switching in the CVP shift position due to small oscillations in the brake pedal position.

In some embodiments, the maximum brake pedal inching position threshold value is a condition wherein a set of wheel brakes are engaged hard enough to prevent a vehicle from moving from a stand-still position. To further expand, a value of BPP_{inchMax} corresponds to the condition where the brakes begin to engage the wheels. In hydraulic systems, this is often referred to as the “kiss” point.

In some embodiments, a brake position value between the maximum brake pedal inching position threshold value and a fully depressed brake pedal position will generate a reference shift position that is saturated to zero. The condition of wheel lockup will begin to occur somewhere in the region described here: BPP_{inchMax}≤BPP≤BPPₘₐₓ, but not necessarily over this entire range. When BPP=f, BPP_{inchMin}, (sometimes called the “kiss point”) and is the condition where the wheel brakes begin to engage.

In some embodiments, the software module generates an inching maneuver mode in a forward or reverse vehicle direction. In some embodiments, the CVP shift positions take on negative values when the inching maneuver mode is performed in a reverse vehicle direction.

In some embodiments, the shift position change is a calibratable value stored in the memory device.

In some embodiments, an operator initiates the inching maneuver of the vehicle while it is not moving. In some embodiments, an operator initiates the inching maneuver of the vehicle while it is moving.

In some embodiments, the software module will execute the controlled inching maneuver when the data received from the sensors consists of detection of vehicle speed and direction, detection of engine speed, detection of CVP shift position, detection of a minimum accelerator pedal position (APP) setting greater than zero and a minimum brake pedal position (BPP) setting greater than zero, wherein the vehicle speed is within a preset limit less than full operation speed and wherein the engine speed is within a preset limit that will safely produce torque deliverable to the CVP that will allow a safe change in shift position.

In some embodiments, the minimum detectable threshold value for the accelerator pedal position (APP) setting is greater than 5% and the minimum detectable threshold value for the brake pedal position (BPP) setting is greater than 6%. However, one of skill in the art would recognize that these are parameterized settings and can change from one application to another.

In some embodiments, the executed inching maneuver comprises: the vehicle movement in a forward direction, or the vehicle movement in a reverse direction; or the vehicle movement in either forward direction or reverse direction and simultaneously elevating or lowering the payload lift apparatus; or elevating or lowering the payload lift apparatus alone without vehicle movement in either forward direction or reverse direction.

Provided herein is a computer-implemented method for generating an inching maneuver mode in a vehicle having an engine coupled to an infinitely variable transmission having a ball-planetary variator (CVP) comprising: a) providing, by a computer, an operating system configured to perform executable instructions and a memory device; b) providing, by the computer, a program including instructions executable by the computer, to create an application comprising a software module configured to manage a controlled inching maneuver; c) providing, by the computer, the software module configured to receive data from a plurality of sensors and execute instructions to manage the controlled inching maneuver indicative of a vehicle direction, a vehicle speed, a brake pedal position, an accelerator pedal position, an engine speed and a CVP shift position; d) providing, by the computer, the software module configured to monitor the CVP shift position and a speed ratio of the CVP; e) providing, by computer, the software module configured to monitor an overspeed condition of the engine; f) providing, by the computer, the software module configured to command an engine speed to control an engine torque based at least in part on the vehicle direction, the vehicle speed, and the accelerator pedal position; and g) providing, by computer, the software module configured to command a change in shift position of the CVP based at least in part on the position of the brake pedal.

In some embodiments, the software module is activated when the sensors detect a minimum position setting for both the brake pedal position and the accelerator pedal position.

In some embodiments, the software module commands an engine speed override limit to reduce the engine torque if the vehicle speed is in excess of speed limits set for the inching mode when transitioning into the inching mode.

In some embodiments, the CVP shift position is adjusted by a delta whose value is based on the brake pedal position.

In some embodiments, the CVP shift position is adjusted towards IVT speed ratio zero condition as the value of the brake pedal position increases.

In some embodiments, the CVP shift position is adjusted to an IVT speed ratio zero condition when the brake pedal position reaches or exceeds a maximum inching position threshold value regardless of the accelerator pedal position setting.

In some embodiments, the software module generates an effective inching maneuver range between a minimum brake pedal inching position threshold value and maximum brake pedal inching position threshold value.

In some embodiments, the software module commands the vehicle to exit the inching maneuver mode when the brake pedal position exceeds the maximum brake pedal inching position threshold value.

In some embodiments, the BPP is quantized to negate the effects of fluctuations in the BPP signal that are not necessarily noise. The software module commands a reference shift position based on the quantized BPP value, each BPP quanta adding or subtracting a position delta between the position range of 0 and Position_{inchMax}.

In some embodiments, a resolution of the quantization is set when a code for the software module is compiled.

In some embodiments, a hysteresis scheme is implemented to prevent excessive switching in the CVP shift position due to small oscillations in the brake pedal position.

In some embodiments, the maximum brake pedal inching position threshold value is a condition wherein a set of wheel brakes are engaged hard enough to prevent a vehicle from moving from a stand-still position. As a further point of explanation, a value of PBP_{inchMax} corresponds to the condition where the brakes begin to engage the wheels. In hydraulic systems, this is often referred to as the “kiss” point.

In some embodiments, a brake position value between the maximum brake pedal inching position threshold value and a fully depressed brake pedal position will generate a reference shift position that is saturated to zero. The condition of wheel lockup will begin to occur somewhere in the region described here: BPP_{inchMax}≤BPP≤BPPₘₐₓ, but not necessarily over this entire range. When BPP=f, PBP_{inchMin}, (sometimes called the “kiss point”) and is the condition where the wheel brakes begin to engage.

In some embodiments, the software module generates an inching maneuver mode in a forward or reverse vehicle direction. In some embodiments, the CVP shift positions take on negative values when the inching maneuver mode is performed in a reverse vehicle direction.

In some embodiments, the shift position change is a calibratable value stored in the memory device.

In some embodiments, an operator initiates the inching maneuver of the vehicle while it is not moving. In some embodiments, an operator initiates the inching maneuver of the vehicle while it is moving.

In some embodiments, the software module will execute the controlled inching maneuver when the data received from the sensors consists of detection of vehicle speed and direction, detection of engine speed, detection of CVP shift position, detection of a minimum accelerator pedal position (APP) setting greater than zero and detection of a minimum brake pedal position (BPP) setting greater than zero; wherein the vehicle speed is within a preset limit less than full operation speed and wherein the engine speed is within a preset limit that will safely produce torque deliverable to the CVP that will allow a safe change in shift position.

In some embodiments, the minimum detectable threshold value for the accelerator pedal position (APP) setting is greater than 5% and the minimum detectable threshold value for the brake pedal position (BPP) setting is greater than 6%. As noted previously however, one of skill in the art would recognize that these are parameterized settings and can change from one application to another.

In some embodiments, the executed inching maneuver comprises: the vehicle movement in a forward direction; or the vehicle movement in a reverse direction; or the vehicle movement in either forward direction or reverse direction and simultaneously elevating or lowering the payload lift apparatus; or elevating or lowering the payload lift apparatus alone without vehicle movement in either forward direction or reverse direction.

Provided herein is a non-transitory computer readable storage media encoded with a computer program including instructions executable by a digital processing device having a memory device to generate an inching maneuver mode in a vehicle having an engine coupled to an infinitely variable transmission having a ball-planetary variator (CVP), comprising a software module configured to manage a controlled inching maneuver, wherein the software module receives data from a plurality of sensors and executes instructions to manage the controlled inching maneuver indicative of a vehicle direction, a vehicle speed, a brake pedal position, an accelerator pedal position, an engine speed and a CVP shift position, wherein the software module monitors a shift position and a speed ratio of the CVP, wherein the software module commands an engine speed to control an engine torque based at least in part on the vehicle direction, the vehicle speed, and the accelerator pedal position and wherein the software module commands a change in the shift position of the CVP based at least in part on the brake pedal position.

In some embodiments, the software module is activated when the sensors detect a minimum position setting for both the brake pedal position and the accelerator pedal position.

In some embodiments, the software module commands an engine speed override limit to reduce the engine torque if the vehicle speed is in excess of speed limits set for the inching mode when transitioning into the inching mode.

In some embodiments, the CVP shift position is adjusted by a delta whose value is based on the brake pedal position.

In some embodiments, the CVP shift position is adjusted towards IVT speed ratio zero condition as the value of the brake pedal position increases.

In some embodiments, the CVP shift position is adjusted to an IVT speed ratio zero condition when the brake pedal position reaches or exceeds a maximum inching position threshold value regardless of the accelerator pedal position setting.

In some embodiments, the software module generates an effective inching maneuver range between a minimum brake pedal inching position threshold value and maximum brake pedal inching position threshold value.

In some embodiments, the software module commands the vehicle to exit the inching maneuver mode when the brake pedal position exceeds the maximum brake pedal inching position threshold value.

In some embodiments, the BPP is quantized to negate the effects of fluctuations in the BPP signal that are not necessarily noise. The software module commands a reference shift position based on the quantized BPP value, each BPP quanta adding or subtracting a position delta between the position range of 0 and Position_{inchMax}.

In some embodiments, a resolution of the quantization is set when a code for the software module is compiled.

In some embodiments, a hysteresis scheme is implemented to prevent excessive switching in the CVP shift position due to small oscillations in the brake pedal position.

In some embodiments, the maximum brake pedal inching position threshold value is a condition wherein a set of wheel brakes are engaged hard enough to prevent a vehicle from moving from a stand-still position. Expanding on this point, a value of BPP_{inchMax} corresponds to the condition where the brakes begin to engage the wheels. In hydraulic systems, this is often referred to as the “kiss” point.

In some embodiments, a brake position value between the maximum brake pedal inching position threshold value and a fully depressed brake pedal position will generate a reference shift position that is saturated to zero.

In some embodiments, the software module generates an inching maneuver mode in a forward or reverse vehicle direction. In some embodiments, the CVP shift positions take on negative values when the inching maneuver mode is performed in a reverse vehicle direction.

In some embodiments, the shift position change is a calibratable value stored in the memory device.

In some embodiments, an operator initiates the inching maneuver of the vehicle while it is not moving. In some embodiments, an operator initiates the inching maneuver of the vehicle while it is moving.

In some embodiments, the software module will execute the controlled inching maneuver when the data received from the sensors consists of: detection of vehicle speed and direction, detection of engine speed, detection of CVP shift position, detection of a minimum accelerator pedal position (APP) setting greater than zero and detection of a minimum brake pedal position (BPP) setting greater than zero, wherein the vehicle speed is within a preset limit less than full operation speed and wherein the engine speed is within a preset limit that will safely produce torque deliverable to the CVP that will allow a safe change in shift position.

In some embodiments, the minimum detectable threshold value for the accelerator pedal position (APP) setting is greater than 5% and the minimum detectable threshold value for the brake pedal position (BPP) setting is greater than 6%.

In some embodiments, the executed inching maneuver comprises: the vehicle movement in a forward direction; or the vehicle movement in a reverse direction; or the vehicle movement in either forward direction or reverse direction and simultaneously elevating or lowering the payload lift apparatus; or elevating or lowering the payload lift apparatus alone without vehicle movement in either forward direction or reverse direction.

Provided herein is a computer-implemented system for controlling an inching maneuver in a vehicle having an engine coupled to an infinitely variable transmission having a ball-planetary variator (CVP), the computer-implemented system comprising: a digital processing device comprising an operating system configured to perform executable instructions and a memory device; a computer program including the instructions executable by the digital processing device, the computer program comprising a software module configured to control an inching maneuver in the vehicle; a plurality of sensors comprising: a vehicle direction sensor adapted to sense a vehicle direction and provide the vehicle direction to the software module, a vehicle speed sensor adapted to sense a vehicle speed and provide the vehicle speed to the software module, a brake pedal position sensor adapted to sense a brake pedal position and provide the brake pedal position to the software module, an accelerator pedal position sensor adapted to sense an accelerator pedal position and provide the accelerator pedal position to the software module, a CVP input speed sensor adapted to sense a CVP input speed and provide the CVP input speed to the software module; a CVP output speed sensor adapted to sense a CVP output speed and provide the CVP output speed to the software module, an IVT output speed sensor adapted to sense an IVT output speed and provide the IVT output speed to the software module, an engine speed sensor adapted to sense an engine speed and provide the engine speed to the software module, and a CVP shift position sensor adapted to sense a current CVP shift position and provide the current CVP shift position to the software module, wherein the software module controls the CVP and the engine during an inching maneuver; wherein the software module is configured to monitor a speed ratio signal of the CVP based on the CVP input speed and the CVP output speed; wherein the software module issues a first command for an engine speed based at least in part on the vehicle direction, the vehicle speed, and the accelerator pedal position; and wherein the software module issues a second command for a CVP shift position based at least in part on the brake pedal position. In some embodiments of the computer-implemented system, the software module is activated when the sensors detect a minimum position setting for both the brake pedal position and the accelerator pedal position. In some embodiments of the computer-implemented system, the software module commands an engine speed override limit to reduce the engine torque if the vehicle speed is in excess of speed limits set for the inching mode when transitioning into the inching maneuver. In some embodiments of the computer-implemented system, the command for a CVP shift position is adjusted towards IVT speed ratio zero condition as the value of the brake pedal position increases. In some embodiments of the computer-implemented system, the commanded CVP shift position signal is adjusted to an IVT speed ratio zero condition when the brake pedal position signal reaches or exceeds a maximum inching position threshold value regardless of the accelerator pedal position. In some embodiments of the computer-implemented system, the software module calculates an effective inching range between a minimum brake pedal inching position threshold value and maximum brake pedal inching position threshold value. In some embodiments of the computer-implemented system, the software module controls the inching of the vehicle when the brake pedal position exceeds the maximum brake pedal inching position threshold value. In some embodiments of the computer-implemented system, the software module commands a reference shift position based on the quantized BPP value, each BPP quanta adding or subtracting a position delta between the position range of 0 and Position_{inchMax}. In some embodiments of the computer-implemented system, a resolution of the quantization is set when a code for the software module is compiled. In some embodiments of the computer-implemented system, a hysteresis scheme is implemented to prevent excessive switching in the CVP shift position due to small oscillations in the brake pedal position. In some embodiments of the computer-implemented system, the maximum brake pedal inching position threshold value is a condition wherein a set of wheel brakes are engaged hard enough to prevent a vehicle from moving from a stand-still position. In some embodiments of the computer-implemented system, a brake position value between the maximum brake pedal inching position threshold value and a fully depressed brake pedal position will generate reference shift position that is saturated to zero. In some embodiments of the computer-implemented system, the software module controls the inching maneuver in a forward or reverse vehicle direction. In some embodiments of the computer-implemented system, the command for a CVP shift position takes on negative values when the inching maneuver mode is performed in a reverse vehicle direction. In some embodiments of the computer-implemented system, a change in the commanded CVP shift position is a calibratable value stored in the memory device. In some embodiments of the computer-implemented system, an operator initiates the inching maneuver of the vehicle while it is not moving. In some embodiments of the computer-implemented system, an operator initiates the inching maneuver of the vehicle while it is moving. In some embodiments of the computer-implemented system, the software module controls the inching maneuver when the data received from the sensors consists of: a detection of vehicle speed and direction, a detection of engine speed, a detection of CVP shift position, a detection of a minimum accelerator pedal position (APP) setting greater than zero, and a detection of a minimum brake pedal position (BPP) setting greater than zero; wherein the vehicle speed is within a preset limit less than full operation speed; and wherein the engine speed is within a preset limit that will safely produce torque deliverable to the CVP that will allow a safe change in the command for a CVP shift position. In some embodiments of the computer-implemented system, the minimum detectable threshold value for the accelerator pedal position (APP) setting is greater than 5%; and the minimum detectable threshold value for the brake pedal position (BPP) setting is greater than 6%. In some embodiments of the computer-implemented system, the executed inching maneuver comprises: the vehicle movement in a forward direction, or the vehicle movement in a reverse direction, or the vehicle movement in either forward direction or reverse direction and simultaneously elevating or lowering the payload lift apparatus, or elevating or lowering the payload lift apparatus alone without vehicle movement in either forward direction or reverse direction.

Provided herein is a computer-implemented method for inching a vehicle in a controlled manner, wherein the vehicle comprises an engine coupled to an infinitely variable transmission (IVT) having a ball-planetary variator (CVP), a plurality of sensors, and a computer-implemented system comprising: a digital processing device comprising an operating system configured to perform executable instructions and a memory device; and a computer program including the instructions executable by the digital processing device, wherein the computer program comprises a software module; the method comprising: controlling an inching maneuver of the vehicle by: one or more of the plurality of sensors sensing vehicle parameters comprising: a vehicle direction, a vehicle speed, a brake pedal position, an accelerator pedal position, a CVP input speed, a CVP output speed, an IVT output speed, an engine speed, and a CVP shift position; the software module monitoring the CVP shift position, a speed ratio of the CVP based on the CVP input speed and the CVP output speed, and an overspeed condition of the engine based one or more of the vehicle parameters sensed by the sensors; commanding a first change in the engine speed and controlling an engine torque based at least in part on the vehicle direction, the vehicle speed, and the accelerator pedal position sensed by the sensors; and commanding a second change in the CVP shift position based at least in part on the brake pedal position sensed by one or more of the sensors. In some embodiments of the computer-implemented method, activating the software module when the sensors detect a minimum position setting for both the brake pedal position and the accelerator pedal position. In some embodiments of the computer-implemented method, the software module commanding an engine speed override limit to reduce the engine torque if the vehicle speed is in excess of a speed limit set for the inching maneuver mode when transitioning into the inching maneuver mode. In some embodiments of the computer-implemented method, adjusting the second change towards an IVT speed ratio zero condition as a value of the brake pedal position increases. In some embodiments of the computer-implemented method, adjusting the second change to the IVT speed ratio zero condition when the brake pedal position reaches or exceeds a maximum inching position threshold value regardless of the accelerator pedal position. In some embodiments of the computer-implemented method, generating an effective inching maneuver range between a minimum threshold value of the brake pedal position and maximum threshold value of the brake pedal position. In some embodiments of the computer-implemented method, controlling the inching maneuver occurs when the brake pedal position exceeds the maximum threshold value brake pedal position. In some embodiments of the computer-implemented method, a hysteresis scheme is implemented to prevent excessive switching in the CVP shift position due to small oscillations in the brake pedal position. In some embodiments of the computer-implemented method, the maximum threshold value of the brake pedal position exists when a set of wheel brakes are engaged hard enough to prevent the vehicle from moving from a stand-still position. In some embodiments of the computer-implemented method, the brake pedal position between the maximum threshold value and a fully depressed brake pedal position will generate a reference shift position that is saturated to zero. In some embodiments of the computer-implemented method, controlling the inching maneuver occurs in a forward or reverse vehicle direction. In some embodiments of the computer-implemented method, the CVP shift position takes on a negative value when the method is performed in a reverse vehicle direction. In some embodiments of the computer-implemented method, the second change is a calibratable value stored in the memory device. In some embodiments of the computer-implemented method, controlling the inching maneuver occurs when initiated by an operator while the vehicle is not moving. In some embodiments of the computer-implemented method, controlling the inching maneuver occurs when initiated by an operator while the vehicle is moving. In some embodiments of the computer-implemented method, controlling the inching maneuver occurs when: the vehicle speed is within a first preset limit less than a full operation speed, the engine speed within a second preset limit that will safely produce torque deliverable to the CVP that will allow a safe change in the CVP shift position, the sensors sense the vehicle direction, the sensors sense the CVP shift position, the accelerator pedal position is at a first minimum setting greater than zero, and the brake pedal position is at a second minimum setting greater than zero. In some embodiments of the computer-implemented implemented method, the first minimum setting for the accelerator pedal position (APP) 5%; and the second minimum setting for the brake pedal position (BPP) is greater than 6%. In some embodiments of the computer-implemented method, controlling the inching maneuver comprises: moving the vehicle in a forward direction; or moving the vehicle in a reverse direction; or moving the vehicle in either forward direction or reverse direction and simultaneously elevating or lowering a payload lift apparatus; or elevating or lowering the payload lift apparatus alone without moving the vehicle in either a forward direction or a reverse direction.

### Discussion of Ratio Droop

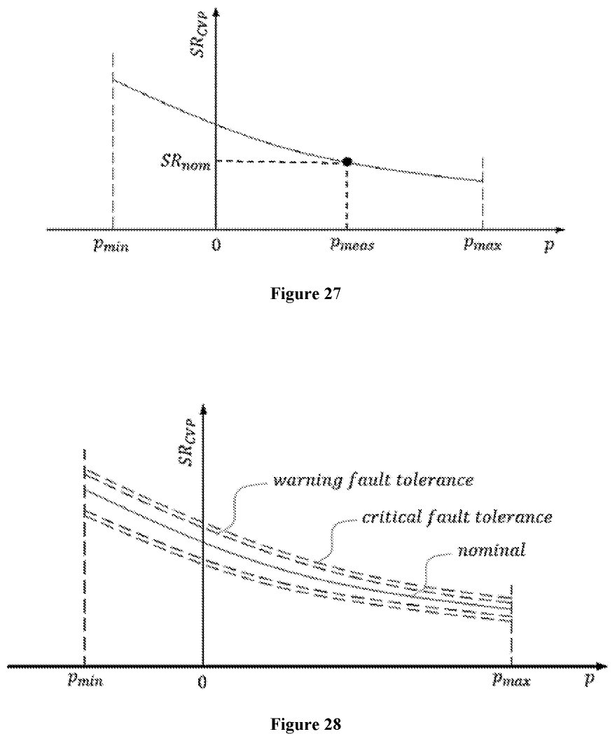

CVP ratio droop, δ_{droop}, is computed as follows:

$${δ}_{droop} = \frac{S {R}_{nom} - S {R}_{meas}}{S {R}_{nom}} ,$$

where SRₘₑₐₛ is the measured CVP speed ratio and SRₙₒₘ is a nominal (or reference) CVP speed ratio value. FIG. 27 illustrates how SRₙₒₘ is computed. A function or mapping is generated under low loading conditions relating CVP speed ratio to the relative carrier shift position over the full shift range from pₘᵢₙ to pₘₐₓ. Thus, given the measured shift position, Pmeas, one would compute SRₙₒₘ via the CVP speed ratio-position map as illustrated in FIG. 27.

### Discussion of Speed Ratio Droop Warning and Error Faults

Referring now to FIG. 28, a set of faults are defined in the event the CVP ratio droop exceeds certain threshold values, in which case a corresponding fault action is executed. The first fault is a warning, which occurs if: |δ_{droop}|>ε_{w}, continuously over a period of Δt_{w} seconds, where ε_{w} is the warning ratio droop threshold parameter. Typical, non-limiting default values for ε_{w} and Δt_{w} are 0.08 and 0.25 sec, respectively for a system described herein. As described herein, the default value for ε_{w} is a nominal value within a range of about 0.04 and 0.15 and the default value for the time threshold Δt_{w} is a nominal value within a range of about 0.15 sec and 0.5 sec. The default values are given as illustrative examples based on the properties of commercial traction fluids currently available. It should be understood that the values may be modified appropriately to reflect performance of fluid and hardware used.

The second fault is regarded as a critical fault, which occurs if: |δ_{droop}|>ε_{c}, continuously over a period of Δt_{c} seconds, where ε_{c} is the critical ratio droop threshold parameter. Typical non-limiting default values for ε_{c} and Δt_{c} are 0.1 and 0.25 sec, respectively. Similarly, as described herein, the default value for ε_{c} is a nominal value within a range of about 0.04 and 0.20 and the default value for the time threshold Δt_{c} is a nominal value within a range of about 0.15 sec and 0.5 sec.

Thus, the parameters ε_{w} and ε_{c} represent tolerances the CVP speed ratio is allowed to exceed, before a corresponding fault action is executed. FIG. 5 illustrates the warning and critical fault tolerance bands relative to the nominal CVP speed ratio mapping described in the previous section.

### Discussion of Fault Actions

In the event a warning fault occurs, the control system will attempt to regulate the CVP ratio droop by limiting the input power to the IVT/CVP. This is achieved by issuing the standard J1939 CAN TSC1 (torque/speed control 1) engine torque-speed limit override command to the vehicle's electronic control unit (ECU). By limiting the engine power, the ratio droop will decrease or be maintained within a stable operating range. It is understood by those skilled in the art that a standard J1939 CAN TSC1 is a universal CAN message used to send override commands to a vehicle's ECU.

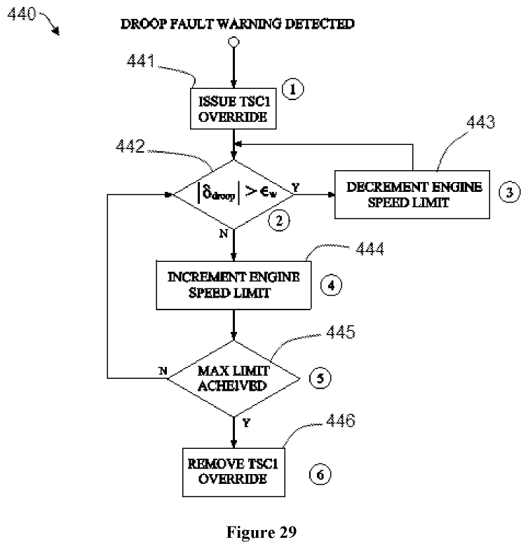

FIG. 29 illustrates a high-level flow chart of the ratio droop regulating control process 440 used when a warning fault is detected. The following is a description of each process corresponding to the numbered labels shown in FIG. 29.

1. Once a droop warning fault is detected, the TSC1 engine torque-speed limit override command is sent to the vehicle's ECU at a block 441. The TSC1 engine speed limit is set to the current measured engine speed at which, the warning fault was detected. This essentially limits or reduces the torque produced by the engine.

2. The ratio droop is monitored at an evaluation block 442 to determine if it continues to exceed the warning threshold ∈_{w}.

3. If the ratio droop exceeds ∈_{w}, then the TSC1 engine speed limit value is decremented at a rate within a range of about 200-600 rpm/sec depending on the current engine speed at a block 443.

4. If the ratio droop falls below ∈_{w}, then the TSC1 engine speed limit value is incremented at a rate within a range of about 40 to 100 rpm/sec. depending on the current engine speed at a block 444.

If the TSC1 engine speed limit value reaches a max threshold (default 2700 rpm), determined in an evaluation block 5, the TSC1 engine torque-speed override command is removed at a block 446. If this condition is reached, the ratio droop regulation process is complete. The default speed (2700 rpm) is given as an illustrative example, which in this case represents the maximum engine speed that the vehicle's ECU will allow. This maximum allowed engine speed will change across applications. As one would increase the TSC1 engine speed limit they would stop the process once they reached the maximum allowed engine speed; or in this illustrative case, 2700 rpm.

In the event a critical droop fault is detected, the vehicle is shut down and the IVT is disengaged from the down-steam drivetrain. This is done in order to reduce the risk of the CVP reaching gross slip, or prevent the CVP from re-engaging under load in the event it has already reached gross slip, which can cause damage to the CVP traction components.

Provided herein is a computer-implemented control system for regulating the speed ratio droop of an infinitely variable transmission (IVT) having a ball planetary variator (CVP) operably coupled to gears, said IVT operably coupled to the engine of a vehicle comprising: an electronic control unit (ECU) having a digital processing device comprising an operating system configured to perform executable instructions and a memory device; a speed ratio droop module configured to monitor the speed ratio droop of the ball planetary variator, wherein the module comprises a plurality of sensors configured to: measure the speed ratio droop in the event its value exceeds a defined first warning fault threshold; regulate the speed ratio droop in the event its value exceeds the defined first warning fault threshold; detect and/or predict ball planetary variator gross slip, in the event the speed ratio droop exceeds a defined second (critical) warning fault threshold; and regulate the speed ratio droop in the event its value exceeds the defined second warning fault threshold; wherein the electronic control unit issues a command to limit an input power to the infinitely variable transmission (IVT) based on feedback from the speed ratio droop module sensors corresponding to the speed ratio droop exceeding the first warning fault threshold or wherein the electronic control unit issues a command to shut down the vehicle and disengage the IVT from the downstream drivetrain corresponding to the speed ratio droop exceeding the second warning fault threshold.

In some embodiments, the ratio droop control system is a sub-system or module of a vehicle control system, driveline control system, transmission control system, or other control system implementation.

In some embodiments, the sensors comprise speed sensors to measure the speed of rotating CVP components.

In some embodiments of the computer-implemented control system, the speed ratio droop module regulates the input power to the IVT by issuing an engine torque-speed limit override command (TSC1 CAN) to the vehicle's electronic control unit, wherein the vehicle electronic control unit, will then adjust its control parameters to the engine, (for example, the engine throttle or fuel command, ignition timing, or fuel injection timing, etc.), to limit the power to the engine per the TSC1 request to regulate the speed ratio droop. The vehicle electronic control unit, or namely, the engine control unit, can adjust a number of parameters to control torque and speed, for example, fuel injection rate and timing, ignition timing, air flow via throttle valve or boost pressure when equipped with turbocharger or supercharger, and in some cases valve timing for engines equipped with variable valve timing.

In some embodiments, an engine torque-speed limit is set to a current measured engine speed at which the first warning fault threshold was detected.

In some embodiments of the computer-implemented control system, the first warning fault threshold is a warning, which occurs if: |δ_{droop}|>ε_{w}, continuously over a period of Δt_{w}, seconds, wherein ε_{w} is a warning speed ratio droop threshold parameter.

In some embodiments, a typical, non-limiting example of the first warning fault threshold default values for ε_{w} and Δt_{w} are 0.08 and 0.25 sec, respectively.

As described herein, the default value for ε_{w} is a nominal value within a range of about 0.04 and 0.15 and the default value for the time threshold Δt_{w} is a nominal value within a range of about 0.15 sec and 0.5 sec. The default values are given as illustrative examples based on the properties of commercial traction fluids currently available. It should be understood that the values may be modified appropriately to reflect performance of fluid and hardware used.

It is understood by those skilled in the art that these values are provided as illustrative example and may be modified by the designers as appropriate depending on hardware and software selection.

In some embodiments of the computer-implemented control system, the speed ratio droop is monitored to determine if the speed ratio droop continues to exceed the warning speed ratio droop threshold ∈_{w} and wherein if the speed ratio droop exceeds ∈_{w}, then an engine torque-speed limit value is decremented at a rate within a range of about 200-600 rpm/sec depending on the current engine speed.

In some embodiments of the computer-implemented control system, the speed ratio droop is monitored to determine if the speed ratio droop falls below ∈_{w}, and wherein if the speed ratio droop falls below ∈_{w}, then the engine torque-speed limit value is incremented at a rate within a range of about 40 to 100 rpm/sec. depending on the current engine speed.

It is understood by those skilled in the art that in some embodiments, the fixed percentage value (decrement /increment) is a calibratable variable that can be used to tune the response of the system to speed ratio droop. Large values may be used to provide large changes in speed ratio droop, while small values may be used to provide smaller changes in speed ratio droop. A designer may implement any value as appropriate to achieve a desired vehicle operation.

In some embodiments of the computer-implemented control system, the engine torque-speed limit value is monitored to determine when it reaches a max threshold, wherein the engine torque-speed override command is removed.

In some embodiments, when the engine torque-speed override command is removed, the speed ratio droop regulation process is complete.

In some embodiments of the computer-implemented control system, the second (critical) warning fault threshold is a warning which occurs if: |δ_{droop}|>ε_{c}, continuously over a period of Δt, seconds, wherein ε_{c} is the second (critical) speed ratio droop threshold parameter.

In some embodiments, typical, non-limiting illustrative default values for ε_{c} and Δt_{c} may be 0.1 and 0.25 sec, respectively. Similarly, as with the warning threshold, the ratio droop error threshold is a nominal value. The default value for ε_{c} is a nominal value within a range of about 0.04 and 0.20 and the default value for the time threshold Δt_{c} is a nominal value within a range of about 0.15 sec and 0.5 sec.

The second (critical) speed ratio droop threshold parameter has a higher value than the first speed ratio droop threshold. The first speed ratio droop threshold is often set to a value known by the designers to provide predictable operation at a high torque levels. The second (critical) speed ratio droop threshold is often set to a value known by the designers to be at the limit to the tractive capacity of the fluid before encountering a gross slip condition.

In some embodiments of the computer-implemented control system, when the second (critical) warning fault threshold is detected, the vehicle is shut down and the IVT is disengaged from a downstream drivetrain.

Provided herein is a computer-implemented method for regulating a speed ratio droop of an infinitely variable transmission (IVT) having a ball planetary variator (CVP) operably coupled to gears, said IVT operably coupled to an engine of a vehicle comprising an electronic control unit having a digital processing device comprising an operating system configured to perform executable instructions and a memory device and a speed ratio droop module configured to monitor the speed ratio droop of the ball planetary variator (CVP) and regulate the engine torque-speed limit of the vehicle, the method comprising: monitoring, by computer, the speed ratio droop of the ball planetary variator; transmitting, by computer, an engine torque-speed limit override command to the vehicle's electronic control unit; and receiving, by computer, updates of the engine torque-speed limit override command to the vehicle's electronic control unit; regulating, by computer, the engine torque-speed limit of the vehicle until the speed ratio droop regulation process is complete.

In some embodiments of the computer-implemented method, the speed ratio droop module comprises a plurality of sensors configured to: measure the speed ratio droop of the ball planetary variator (CVP) in the event its value exceeds a defined first warning fault threshold; regulate the speed ratio droop of the ball planetary variator (CVP) in the event its value exceeds the defined first warning fault threshold; predict and/or detect ball planetary variator gross slip, in the event the speed ratio droop exceeds a defined second (critical) warning fault threshold; and regulate the speed ratio droop of the ball planetary variator (CVP) in the event its value exceeds the defined second warning fault threshold.

In some embodiments of the computer-implemented method, the speed ratio droop module regulates the input power to the IVT by issuing an engine torque-speed limit override command to the vehicle's electronic control unit, wherein the vehicle's electronic control unit, will then adjust its control parameters to the engine, (for example, the engine throttle or fuel command, ignition timing, or fuel injection timing, etc.), to limit the power to the engine per the TSC1 request to regulate the speed ratio droop. The vehicle electronic control unit, or namely, the engine control unit, can adjust a number of parameters to control torque and speed, for example, fuel injection rate and timing, ignition timing, air flow via throttle valve or boost pressure when equipped with turbocharger or supercharger, and in some cases valve timing for engines equipped with variable valve timing.

In some embodiments, an engine torque-speed limit is set to the current measured engine speed at which, the first warning fault threshold was detected.

In some embodiments of the computer-implemented method, the first warning fault threshold is a warning which occurs if: |δ_{droop}|>ε_{w}, continuously over a period of Δt_{w} seconds, wherein ε_{w} is a warning speed ratio droop threshold parameter.

In some embodiments, a typical set of non-limiting illustrative default first warning fault threshold values for ε_{w} and Δt_{w} are 0.08 and 0.25 sec, respectively. As described herein, the default value for ε_{w} is a nominal value within a range of about 0.04 and 0.15 and the default value for the time threshold Δt_{w} is a nominal value within a range of about 0.15 sec and 0.5 sec.

In some embodiments of the computer-implemented method, the speed ratio droop is monitored to determine if the speed ratio droop continues to exceed the warning threshold ∈_{w} and wherein if the speed ratio droop continues to exceed ∈_{w}, then the engine torque-speed limit value is decremented at a rate within a range of about 200-600 rpm/sec depending on the current engine speed.

In some embodiments of the computer-implemented control system, the speed ratio droop is monitored to determine if the speed ratio droop falls below ∈_{w}, and wherein if the speed ratio droop falls below ∈_{w}, then the engine torque-speed limit value is decremented at a rate within a range of about 40-100 rpm/sec depending on the current engine speed.

In some embodiments of the computer-implemented method, the second (critical) warning fault threshold is a warning which occurs if: εδ_{droop}|>ε_{c}, continuously over a period of Δt_{c} seconds, wherein ε_{c} is the second (critical) speed ratio droop threshold parameter.

In some embodiments, a typical set of non-limiting illustrative default second (critical) warning fault threshold values for ε_{c} and Δt_{c} are 0.1 and 0.25 sec, respectively. As described herein, the default value for ε_{c} is a nominal value within a range of about 0.04 and 0.20 and the default value for the time threshold Δt_{c} is a nominal value within a range of about 0.15 sec and 0.5 sec.

In some embodiments, when the second (critical) warning fault threshold is detected, the vehicle is shut down and the Infinite Variable Transmission (IVT) is disengaged from a downstream drivetrain.

Provided herein is non-transitory computer-readable storage media encoded with a computer program including instructions executable by a processor to create an application comprising a software module configured to regulate the speed ratio droop of an infinitely variable transmission (IVT) having a ball planetary variator (CVP) operably coupled to gears, said IVT operably coupled to the engine of a vehicle, comprising: an electronic control unit for controlling the vehicle having a digital processing device comprising an operating system configured to perform executable instructions and a memory device; a speed ratio droop module configured to monitor the speed ratio droop of the ball planetary variator (CVP), wherein the module comprises a plurality of sensors configured to: measure the speed ratio droop in the event its value exceeds a defined first warning fault threshold; regulate the speed ratio droop in the event its value exceeds the defined first warning fault threshold; detect and/or predict ball planetary variator gross slip, in the event the speed ratio droop exceeds a defined second critical fault threshold; and regulate the speed ratio droop in the event its value exceeds the defined second warning fault threshold; wherein the electronic control unit issues a command to limit the input power to the IVT based on the feedback from the speed ratio droop module sensors corresponding to the speed ratio droop exceeding the first warning fault threshold or wherein the electronic control unit issues a command to shut down the vehicle and disengage the IVT from the downstream drivetrain corresponding to the speed ratio droop exceeding the second warning fault threshold.

In some embodiments of the non-transitory computer-readable storage media, the speed ratio droop module regulates the input power to the IVT by issuing an engine torque-speed limit override command (TSC1 CAN) to the vehicle's electronic control unit, wherein the vehicle's electronic control unit, will then adjust its control parameters to the engine, (for example, the engine throttle or fuel command, ignition timing, or fuel injection timing, etc.), to limit the power to the engine per the TSC1 request to regulate the speed ratio droop. As enumerated above, the vehicle electronic control unit can control a number of parameters governing engine speed and torque, for example, the fuel injection rate and timing, the ignition timing, the air flow, and in some cases the exhaust flow, to name a few.

In some embodiments of the non-transitory computer-readable storage media, an engine torque-speed limit is set to a current measured engine speed at which, the first warning fault threshold was detected.

In some embodiments of the non-transitory computer-readable storage media, the first warning fault threshold is a warning which occurs if: |δ_{droop}|>ε_{w}, continuously over a period of Δt_{w} seconds, wherein ε_{w} is a warning speed ratio droop threshold parameter.

In some embodiments of the non-transitory computer-readable storage media, a typical set of non-limiting illustrative default first warning fault threshold values for ε_{w} and Δt_{w} are 0.08 and 0.25 sec, respectively As described herein, the default value for ε_{w} is a nominal value within a range of about 0.04 and 0.15 and the default value for the time threshold Δt_{w} is a nominal value within a range of about 0.15 sec and 0.5 sec.

In some embodiments of the non-transitory computer-readable storage media, the speed ratio droop is monitored to determine if the speed ratio droop continues to exceed the warning threshold ε_{w} and wherein when the speed ratio droop exceeds ε_{w}, then the engine torque-speed limit value is decremented at a rate within a range of about 200-600 rpm/sec depending on the current engine speed.

In some embodiments the engine torque speed limit value is decremented by a fixed value of 0.1%. This is just a nominal value. However, this value is influenced by the control loop time and may change system to system. As a further non-limiting illustrative example, a typical control loop time for the system described herein is 5ms.

In some embodiments, the speed ratio droop is monitored to determine if the speed ratio droop falls below ε_{w}, and wherein if the speed ratio droop falls below ε_{w}, then the engine torque-speed limit value is incremented at a rate within a range of about 40-100 rpm/sec depending on the current engine speed.

In some embodiments of the non-transitory computer-readable storage media, the second (critical) warning fault threshold is a warning which occurs if: |δ_{droop}|>ε_{c}, continuously over a period of Δt_{c} seconds, wherein ε_{c} is the second (critical) speed ratio droop threshold parameter.

In some embodiments, a typical non-limiting illustrative set of default second (critical) warning fault threshold values for ε_{c} and Δt_{c} are 0.1 and 0.25 sec, respectively. As described herein, the default value for ε_{c} is a nominal value within a range of about 0.04 and 0.20 and the default value for the time threshold Δt_{c} is a nominal value within a range of about 0.15 sec and 0.5 sec.

In some embodiments of the non-transitory computer-readable storage media, if the second (critical) warning fault threshold is detected, the vehicle is shut down and the Infinite Variable Transmission (IVT) is disengaged from a downstream drivetrain.

Provided herein is a computer-implemented control system for regulating the speed ratio droop of an infinitely variable transmission (IVT) having a ball planetary variator (CVP) operably coupled to gears, said IVT operably coupled to the engine of a vehicle comprising: an electronic control unit having a digital processing device comprising an operating system configured to perform executable instructions and a memory device; a speed ratio droop module configured to monitor the speed ratio droop of the ball planetary variator, wherein the speed ratio droop module comprises: at least one speed sensor configured to acquire signals indicative of the speed ratio droop and a software module including instructions executable by a digital processing device in communication with the at least one speed sensor and the at least one actuator, the software module configured to detect and/or predict ball planetary variator gross slip, in the event the speed ratio droop exceeds a defined warning fault threshold, the software module configured to provide executable instructions to regulate the speed ratio droop in the event its value exceeds the defined warning fault threshold.

In some embodiments, the CVP further comprises a plurality of balls each having a tiltable axis of rotation, a carrier operably coupled to each ball, the carrier operably coupled to the actuator.

In some embodiments, the instructions to regulate the speed ratio droop include an engine torque-speed limit override command (TSC1 CAN) to the engine control unit.

Provided herein is a computer-implemented control system for controlling a speed ratio droop of an infinitely variable transmission (IVT) having a ball planetary variator (CVP) operably coupled to gears, said IVT operably coupled to an engine of a vehicle, the computer-implemented control system comprising: a digital processing device comprising an operating system configured to perform executable instructions and a memory device; a computer program including the instructions executable by the digital processing device, the computer program comprising a software module configured to control the engine and the CVP; a plurality of sensors comprising: a CVP input speed sensor configured to sense a CVP input speed and provide the CVP input speed to the software module, and a CVP output speed sensor configured to sense a CVP output speed and provide the CVP output speed to the software module, wherein the software module determines a current CVP speed ratio based on the CVP input speed and the CVP output speed, and a CVP shift position sensor adapted to sense a current CVP shift position and provide the current CVP shift position to the software module, wherein the software module calculates a speed ratio droop based on the CVP input speed, the CVP output speed, and the CVP shift position; wherein the software module is configured to compare the speed ratio droop to a first warning fault threshold, wherein the first warning fault threshold is a calibratable parameter stored in the memory device; wherein the software module is configured to detect a gross slip of the ball planetary variator by comparing the speed ratio droop to a second (critical) warning fault threshold, wherein the second (critical) warning fault threshold is a calibratable parameter stored in the memory device; wherein the software module transmits a first command for a change in the CVP shift position based on the comparison of the speed ratio droop to the first warning fault threshold and the second (critical) warning fault threshold; wherein the software module transmits a second command for a change in CVP input speed based on the comparison of the speed ratio droop signal to the first warning fault threshold; and wherein the software module transmits a third command to shut down the vehicle and disengage the IVT from the downstream drivetrain based on the comparison of the speed ratio droop signal to the second warning fault threshold. In some embodiments of the computer-implemented control system, the speed ratio droop module regulates the input power to the IVT by issuing an engine torque-speed limit override command (TSC1 CAN) to a vehicle electronic control unit provided on the vehicle, wherein the vehicle electronic control unit commands an adjustment to a plurality control parameters to thereby limit the power produced by the engine per the TSC1 request to regulate the speed ratio droop. In some embodiments of the computer-implemented control system, an engine torque-speed limit is set to a current measured engine speed at which the first warning fault threshold was detected. In some embodiments of the computer-implemented control system, the first warning fault threshold is a warning, which occurs if: |δ_{droop}|>ε_{w}, continuously over a period of Δt_{w} seconds, wherein ε_{w} is a warning speed ratio droop threshold parameter. In some embodiments of the computer-implemented control system, the default value for ε_{w} is a nominal value within a range of about 0.04 and 0.15 and the default value for the time threshold Δt_{w} is a nominal value within a range of about 0.15 sec and 0.5 sec. In some embodiments of the computer-implemented control system, the speed ratio droop is monitored to determine if the speed ratio droop continues to exceed the warning speed ratio droop threshold ∈_{w} and wherein if the speed ratio droop continues to exceed ∈_{w}, then an engine torque-speed limit value is decremented at a rate within a range of about 200-600 rpm/sec depending on the current engine speed. In some embodiments of the computer-implemented control system, the speed ratio droop is monitored to determine if the speed ratio droop falls below ∈_{w}, and wherein if the speed ratio droop falls below ∈_{w}, then the engine torque-speed limit value is incremented at a rate within a range of about 40 to 100 rpm/sec. depending on the current engine speed. In some embodiments of the computer-implemented control system, the engine torque-speed limit value is monitored to determine when it reaches a max threshold, wherein the engine torque-speed override command is removed. In some embodiments of the computer-implemented control system, when the engine torque-speed override command is removed, the speed ratio droop regulation process is complete. In some embodiments of the computer-implemented control system, the second (critical) warning fault threshold is a warning which occurs if: |δ_{droop}|>ε_{c}, continuously over a period of Δt_{c} seconds, wherein ε_{c} is the second (critical) speed ratio droop threshold parameter. In some embodiments of the computer-implemented control system, the default value for ε_{c} is a nominal value within a range of about 0.04 and 0.20 and the default value for the time threshold Δt_{c} is a nominal value within a range of about 0.15 sec and 0.5 sec. In some embodiments of the computer-implemented control system, when the second (critical) warning fault threshold is detected, the vehicle is shut down and the IVT is disengaged from a downstream drivetrain.

Provided herein is a computer-implemented method for regulating an engine torque-speed limit of a vehicle and a speed ratio droop an infinitely variable transmission (IVT) having a ball planetary variator (CVP) operably coupled to gears, said IVT operably coupled to an engine of the vehicle, the vehicle comprising a plurality of sensors and a computer-implemented system comprising: a digital processing device comprising an operating system configured to perform executable instructions and a memory device, and a computer program including the instructions executable by the digital processing device, wherein the computer program comprises a software module configured to control the engine and the CVP, the method comprising controlling the engine and the CVP by: the software module receiving a plurality of signals from one or more sensors reflecting vehicle parameters sensed by the one or more sensors, the vehicle parameters comprising a CVP input speed, a CVP output speed, and a current CVP shift position; calculating a speed ratio droop of the ball planetary variator based on the CVP input speed, the CVP output speed, and the current CVP shift position; comparing the speed ratio droop to a first warning fault threshold, wherein the first warning fault threshold is a calibratable parameter stored in the memory device; comparing the speed ratio droop to a second (critical) warning fault threshold, wherein the second (critical) warning fault threshold is a calibratable parameter stored in the memory device; and transmitting a first command for a change in the CVP shift position based on the comparison of the speed ratio droop to the first warning fault threshold and the second (critical) warning fault threshold; and transmitting a second command for a change in the CVP input speed based on the comparison of the speed ratio droop signal to the first warning fault threshold. In some embodiments, the computer-implemented method includes measuring the speed ratio droop of the ball planetary variator (CVP) and comparing the speed ratio droop to a first warning fault threshold; regulating the speed ratio droop of the ball planetary variator (CVP) based on the first comparison; detecting gross slip based on a second comparison of the speed ratio droop to a second (critical) warning fault threshold; and further regulating the speed ratio droop of the ball planetary variator (CVP) based on the second comparison. In some embodiments, the computer-implemented method includes regulating the input power to the IVT by issuing an engine torque-speed limit override command to the electronic control unit, which commands a plurality of control signals to the engine and limits the power from the engine per the TSC1 request to regulate the speed ratio droop. In some embodiments of the computer-implemented method, an engine torque-speed limit is set to a current measured engine speed at which a first warning fault threshold was detected. In some embodiments of the computer-implemented method, the first warning fault threshold is a warning which occurs if: |δ_{droop}|>ε_{w}, continuously over a period of Δt_{w} seconds, wherein ε_{w} is a warning speed ratio droop threshold parameter. In some embodiments of the computer-implemented method, a first default value for ε_{w} is a first nominal value within a first range of about 0.04 and 0.15 and a second default value for a time threshold Δt_{w} is a second nominal value within a second range of about 0.15 sec and 0.5 sec. In some embodiments of the computer-implemented method includes monitoring the speed ratio droop to determine if the speed ratio droop continues to exceed the first default value ∈_{w} and wherein if the speed ratio droop continues to exceed ∈_{w}, then the engine torque-speed limit value is decremented at a rate within a range of about 200-600 rpm/sec depending on a current speed of the engine. In some embodiments of the computer-implemented method, the speed ratio droop is monitored to determine if the speed ratio droop falls below the first default value ∈_{w}, and wherein if the speed ratio droop falls below ∈_{w}, then the engine torque-speed limit value is incremented at a rate within a range of about 40 to 100 rpm/sec. depending on a current speed of the engine. In some embodiments of the computer-implemented method, the second (critical) warning fault threshold occurs if: |δ_{droop}|>ε_{c}, continuously over a period of Δt_{c} seconds, wherein ε_{c} is a second (critical) speed ratio droop threshold parameter. In some embodiments of the computer-implemented method, a first default value for ε_{c} is a first nominal value within a range of about 0.04 and 0.20 and a second default value for the time threshold Δt_{c} is a second nominal value within a range of about 0.15 sec and 0.5 sec. In some embodiments of the computer-implemented method, when the second (critical) warning fault threshold is detected, the vehicle is shut down and the Infinite Variable Transmission (IVT) is disengaged from a downstream drivetrain.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

Various embodiments as described herein are provided in the Aspects below:

Aspect 1: A computer-implemented system for controlling an auto-deceleration of a vehicle having an engine coupled to an infinitely variable transmission having a ball-planetary variator (CVP), the computer-implemented system comprising:
a digital processing device comprising an operating system configured to perform executable instructions and a memory device;
a computer program including the instructions executable by the digital processing device, the computer program comprising a software module configured to control the auto-deceleration of the vehicle;
a plurality of sensors comprising:
   a vehicle direction sensor adapted to sense a vehicle direction and provide the vehicle direction to the software module,
   a vehicle speed sensor adapted to sense a vehicle speed and provide the vehicle speed to the software module,
   a brake pedal position sensor adapted to sense a brake pedal position and provide the brake pedal position to the software module,
   an accelerator pedal position sensor adapted to sense an accelerator pedal position and provide the accelerator pedal position to the software module,
   an engine speed sensor adapted to sense an engine speed and provide the engine speed to the software module, and
   a CVP shift position sensor adapted to sense a current CVP shift position and provide the current CVP shift position to the software module,
wherein the software module determines a commanded CVP shift position during the auto-deceleration of the vehicle, wherein the commanded CVP shift position is based on the vehicle direction, the vehicle speed, the brake pedal position, the accelerator pedal position, the engine speed, and the current CVP shift position; and
wherein the software module is configured to control the CVP based on the commanded CVP shift position.

Aspect 2: The computer-implemented system of Aspect 1, wherein the commanded CVP shift position is adjusted to achieve an IVT zero condition of the vehicle.

Aspect 3: The computer-implemented system of Aspect 1 or 2, wherein the CVP shift position is adjusted by an incremental value based on a desired deceleration rate of the vehicle.

Aspect 4: The computer-implemented system of any one of Aspects 1, 2, or 3, wherein the desired deceleration rate of the vehicle is a user adjustable input to the software module.

Aspect 5: The computer-implemented system of any one of Aspects 1-4, wherein the software module executes a command for a closed loop control of a CVP shift position.

Aspect 6: The computer-implemented system of any one of Aspects 1-5, wherein an operator initiates the auto-deceleration of the vehicle while the vehicle is moving.

Aspect 7: The computer-implemented system of any one of Aspects 1-6, wherein the software module executes commands for the controlled auto-deceleration of the vehicle when the data received from the sensors consists of:
there is vehicle movement in a forward direction or a reverse direction,
an accelerator pedal position (APP) equal to zero, and
a brake pedal position (BPP) equal to zero.

Aspect 8: The computer-implemented system of any one of Aspects 1-7, wherein the executed commands for auto-deceleration comprises:
the vehicle movement in a forward direction, or
the vehicle movement in a reverse direction, or
the vehicle movement is either forward or reverse and the direction is set to neutral.

Aspect 9: A computer-implemented method for auto-deceleration of a vehicle having an engine coupled to an infinitely variable transmission (IVT) having a ball-planetary variator (CVP), the vehicle comprising a plurality of sensors and a computer-implemented system comprising
a digital processing device comprising an operating system configured to perform executable instructions and a memory device, and
a computer program including the instructions executable by the digital processing device, wherein the computer program comprises a software module configured to control deceleration of the vehicle, the method comprising controlling deceleration by:
the software module receiving a plurality of signals from one or more sensors reflecting vehicle parameters sensed by the one or more sensors, the vehicle parameters comprising a vehicle direction, a vehicle speed, a brake pedal position, an accelerator pedal position, an engine speed, a CVP input speed, a CVP output speed, and a current CVP shift position; and
the software module executing instructions based at least in part on the one or more vehicle parameters comprising:
   transmitting an engine speed limit command to the engine based at least in part on the vehicle direction, the vehicle speed, the accelerator pedal position, and the brake pedal position;
   monitoring the current CVP shift position, a current CVP speed ratio based upon the CVP input speed and the CVP output speed, and an engine speed limit read from the memory device; and
   changing the current CVP shift position based at least in part on the brake pedal position.

Aspect 10: The method of Aspect 9, wherein changing the current CVP shift position achieves an IVT zero condition of the vehicle.

Aspect 11: The method of Aspects 9 or 10, wherein changing the current CVP shift position comprising adjusting the current CVP shift position by an incremental value based on a desired deceleration rate.

Aspect 12: The method of any one of Aspects 9, 10, or 11, wherein the desired deceleration rate is a user adjustable input value to the software module.

Aspect 13: The method of any one of Aspects 9-12, wherein the brake pedal position is zero.

Aspect 14: The method of any one of Aspects 9-13, wherein changing the current CVP shift position is based on a calibratable value stored in the memory device.

Aspect 15: The method of any one of Aspects 9-14, comprising the software module commanding a closed loop control of the current CVP speed ratio, and the software module commanding an engine controller to reduce an input torque supplied to the infinitely variable transmission.

Aspect 16: The method of any one of Aspects 9-15, comprising receiving an auto-deceleration initiation signal from an operator while the vehicle is moving.

Aspect 17: The method of any one of Aspects 9-16, comprising the software module automatically executing the method when:
there is vehicle movement in a forward direction or a reverse direction,
the accelerator pedal position (APP) is equal to zero, and
the brake pedal position (BPP) is equal to zero.

Aspect 18: The method of any one of Aspects 9-17, comprising the software module executing the method when an operator initiates auto-deceleration and
movement of the vehicle is in a forward direction, or
movement of the vehicle is in a reverse direction, or
movement of the vehicle is either in a forward direction or in a reverse direction and a direction setting is neutral.

Aspect 19: A computer-implemented system for changing direction of a vehicle having an engine coupled to an infinitely variable transmission having a ball-planetary variator (CVP), the computer-implemented system comprising:
a digital processing device comprising an operating system configured to perform executable instructions and a memory device;
a computer program including the instructions executable by the digital processing device, the computer program comprising a software module configured to control a power reversal of the vehicle;
a plurality of sensors comprising:
   a vehicle direction sensor adapted to sense a vehicle direction and provide the vehicle direction to the software module,
   a vehicle speed sensor adapted to sense a vehicle speed and provide the vehicle speed to the software module,
   a brake pedal position sensor adapted to sense a brake pedal position and provide the brake pedal position to the software module,
   an accelerator pedal position sensor adapted to sense an accelerator pedal position and provide the accelerator pedal position to the software module,
   an engine speed sensor adapted to sense an engine speed and provide the engine speed to the software module, and
   a CVP shift position sensor adapted to sense a current CVP shift position and provide the current CVP shift position to the software module,
wherein the software module controls the CVP and the engine during a reversal of the vehicle direction;
wherein the software module transmits a first command for an engine speed limit based at least in part on the current vehicle direction, the vehicle speed, the accelerator pedal position, and the brake pedal position; and
wherein the software module transmits a second command for a change in the CVP shift position based at least in part on the engine speed.

Aspect 20: The computer-implemented system of Aspect 19, wherein the command for a change in the CVP shift position is adjusted to achieve an engine speed below an overspeed condition of the engine, wherein the overspeed condition of the engine is a calibrateable value stored in the memory device.

Aspect 21: The computer-implemented system of Aspects 19 or 20, wherein the command for a change in the CVP shift position is adjusted by an incremental value based on a desired deceleration rate.

Aspect 22: The computer-implemented system of any one of Aspects 19, 20, or 21, wherein the desired deceleration rate is a user adjustable input value to the software module.

Aspect 23: The computer-implemented system of any one of Aspects 19-22, wherein the command for a change in the CVP shift position is further based at least in part on the accelerator pedal position.

Aspect 24: The computer-implemented system of any one of Aspects 19 -23, wherein the command for a change in the CVP shift position is a calibrateable value stored in the memory device.

Aspect 25: The computer-implemented system of any one of Aspects 19-24, wherein the software module commands an engine speed corresponding to an engine idle speed, and the digital processing device reduces engine torque transmitted to the transmission.

Aspect 26: The computer-implemented system of any one of Aspects 19-25, wherein an operator initiates the change of direction of the vehicle while it is moving.

Aspect 27: The computer-implemented system of any one of Aspects 19-27, wherein the software module executes the controlled power reversal of the vehicle when:
an operator-commanded change in direction,
the accelerator pedal position being greater than zero, and
the brake pedal position being equal to zero.

Aspect 28: The computer-implemented system of any one of Aspects 19-27, wherein the operator-commanded change in direction comprises:
movement of the vehicle in a forward direction and the direction switch is set to reverse by the operator, or
movement of the vehicle in a reverse direction and the direction switch is set to forward by the operator, or movement of the vehicle is either in the forward direction or the reverse direction and the direction switch is set to neutral by the operator.

Aspect 29: A computer-implemented method for changing direction of a vehicle comprising an engine coupled to an infinitely variable transmission (IVT) having a ball-planetary variator (CVP), a direction switch, a plurality of sensors, and a computer-implemented system comprising
a digital processing device comprising an operating system configured to perform executable instructions and a memory device, and
a computer program including the instructions executable by the digital processing device, wherein the computer program comprises a software module configured to change direction of the vehicle,

the method comprising changing direction of the vehicle by:
receiving first data from the direction switch indicating a desired vehicle direction;
receiving second data from one or more of the sensors configured to sense a current vehicle direction, a vehicle speed, a brake pedal position, an accelerator pedal position, an engine speed, and a CVP shift position;
executing the instructions to manage a controlled power reversal based on the desired vehicle direction, the vehicle speed, the brake pedal position, the accelerator pedal position, the engine speed and the CVP shift position;
transmitting a first command for an engine speed limit based at least in part on the current vehicle direction, the vehicle speed, the accelerator pedal position, and the brake pedal position;
monitoring an overspeed condition of the engine; and
transmitting a second command for a change in the CVP shift position based at least in part on the engine speed.

Aspect 30: The method of Aspect 29, wherein transmitting the second command comprises adjusting the engine speed below the overspeed condition.

Aspect 31: The method of Aspects 29 or 30, wherein the change in the CVP shift position is an incremental value or amount based on a desired deceleration rate.

Aspect 32: The method of any one of Aspects 29, 30, or 31, wherein the desired deceleration rate is a user adjustable input value to the software module.

Aspect 33: The method of any one of Aspects 29-32, wherein the change in the CVP shift position is based at least in part on the accelerator pedal position.

Aspect 34: The method of any one of Aspects 29-33, wherein the change in the CVP shift position is a calibrateable value stored in the memory device.

Aspect 35: The method of any one of Aspects 29-34, wherein the software module commands the engine speed corresponding to an engine idle speed and wherein the method further comprises reducing engine torque transmitted to the infinitely variable transmission.

Aspect 36: The method of any one of Aspects 29-35, wherein changing direction of the vehicle is initiated by an operator of the vehicle while the vehicle is moving.

Aspect 37: The method of any one of Aspects 29-36, wherein the software module executes the changing direction of the vehicle when the first data received from the direction switch and the second data received the sensors comprises:
an operator-commanded change in direction,
the accelerator pedal position being greater than zero, and
the brake pedal position being equal to zero.

Aspect 38: The method of any one of Aspects 29-37, wherein the operator-commanded change in direction comprises:
movement of the vehicle in a forward direction and the direction switch is set to reverse by the operator, or
movement of the vehicle in a reverse direction and the direction switch is set to forward by the operator, or
movement of the vehicle is either in the forward direction or the reverse direction and the direction switch is set to neutral by the operator.

Aspect 39: A computer-implemented system for controlling an inching maneuver in a vehicle having an engine coupled to an infinitely variable transmission having a ball-planetary variator (CVP), the computer-implemented system comprising:
a digital processing device comprising an operating system configured to perform executable instructions and a memory device;
a computer program including the instructions executable by the digital processing device, the computer program comprising a software module configured to control an inching maneuver in the vehicle;
a plurality of sensors comprising:
   a vehicle direction sensor adapted to sense a vehicle direction and provide the vehicle direction to the software module,
   a vehicle speed sensor adapted to sense a vehicle speed and provide the vehicle speed to the software module,
   a brake pedal position sensor adapted to sense a brake pedal position and provide the brake pedal position to the software module,
   an accelerator pedal position sensor adapted to sense an accelerator pedal position and provide the accelerator pedal position to the software module,
   a CVP input speed sensor adapted to sense a CVP input speed and provide the CVP input speed to the software module;
   a CVP output speed sensor adapted to sense a CVP output speed and provide the CVP output speed to the software module,
   an IVT output speed sensor adapted to sense an IVT output speed and provide the IVT output speed to the software module,
   an engine speed sensor adapted to sense an engine speed and provide the engine speed to the software module, and
   a CVP shift position sensor adapted to sense a current CVP shift position and provide the current CVP shift position to the software module,
wherein the software module controls the CVP and the engine during an inching maneuver;
wherein the software module is configured to monitor a speed ratio signal of the CVP based on the CVP input speed and the CVP output speed;
wherein the software module issues a first command for an engine speed based at least in part on the vehicle direction, the vehicle speed, and the accelerator pedal position; and
wherein the software module issues a second command for a CVP shift position based at least in part on the brake pedal position.

Aspect 40: The computer-implemented system of Aspect 39, wherein the software module is activated when the sensors detect a minimum position setting for both the brake pedal position and the accelerator pedal position.

Aspect 41: The computer-implemented system of Aspect 39 or 40, wherein the software module commands an engine speed override limit to reduce the engine torque if the vehicle speed is in excess of speed limits set for the inching mode when transitioning into the inching maneuver .

Aspect 42: The computer-implemented system of any one of Aspects 39-41, wherein the command for a CVP shift position is adjusted towards IVT speed ratio zero condition as the value of the brake pedal position increases.

Aspect 43: The computer-implemented system of any one of Aspects 39-42, wherein the commanded CVP shift position signal is adjusted to an IVT speed ratio zero condition when the brake pedal position signal reaches or exceeds a maximum inching position threshold value regardless of the accelerator pedal position.

Aspect 44: The computer-implemented system of any one of Aspects 39-43, wherein the software module calculates an effective inching range between a minimum brake pedal inching position threshold value and maximum brake pedal inching position threshold value.

Aspect 45: The computer-implemented system of any one of Aspects 39-44, wherein the software module controls the inching of the vehicle when the brake pedal position exceeds the maximum brake pedal inching position threshold value.

Aspect 46: The computer-implemented system of any one of Aspects 39-45, wherein the software module commands a reference shift position based on the quantized BPP value, each BPP quanta adding or subtracting a position delta between the position range of 0 and Position_{inchMax}.

Aspect 47: The computer-implemented system of any one of Aspects 39-46, wherein a resolution of the quantization is set when a code for the software module is compiled.

Aspect 48: The computer-implemented system of Aspects 39-47, wherein a hysteresis scheme is implemented to prevent excessive switching in the CVP shift position due to small oscillations in the brake pedal position.

Aspect 49: The computer-implemented system of Aspects 39 -48, wherein the maximum brake pedal inching position threshold value is a condition wherein a set of wheel brakes are engaged hard enough to prevent a vehicle from moving from a stand-still position.

Aspect 50: The computer-implemented system of any one of Aspects 39 -49, wherein a brake position value between the maximum brake pedal inching position threshold value and a fully depressed brake pedal position will generate reference shift position that is saturated to zero.

Aspect 51: The computer-implemented system of any one of Aspects 39-50, wherein the software module controls the inching maneuver in a forward or reverse vehicle direction.

Aspect 52: The computer-implemented system of any one of Aspects 39-51, wherein the command for a CVP shift position takes on negative values when the inching maneuver mode is performed in a reverse vehicle direction.

Aspect 53: The computer-implemented system of any one of Aspects 39-52, wherein a change in the commanded CVP shift position is a calibrateable value stored in the memory device. Aspect 54: The computer-implemented system of any one of Aspects 39-53, wherein an operator initiates the inching maneuver of the vehicle while it is not moving. Aspect 55: The computer-implemented system of any one of Aspects 39-54, wherein an operator initiates the inching maneuver of the vehicle while it is moving. Aspect 56: The computer-implemented system of any one of Aspects 39-55, wherein the software module controls the inching maneuver when the data received from the sensors consists of:
a detection of vehicle speed and direction,
a detection of engine speed,
a detection of CVP shift position,
a detection of a minimum accelerator pedal position (APP) setting greater than zero, and
a detection of a minimum brake pedal position (BPP) setting greater than zero; wherein the vehicle speed is within a preset limit less than full operation speed; and
wherein the engine speed is within a preset limit that will safely produce torque deliverable to the CVP that will allow a safe change in the command for a CVP shift position.

Aspect 57: The computer-implemented system of any one of Aspects 39-56, wherein:
the minimum detectable threshold value for the accelerator pedal position (APP) setting is greater than 5%; and
the minimum detectable threshold value for the brake pedal position (BPP) setting is greater than 6%.

Aspect 58: The computer-implemented system of any one of Aspects 39-57, wherein the executed inching maneuver comprises:
the vehicle movement in a forward direction, or
the vehicle movement in a reverse direction, or
the vehicle movement in either forward direction or reverse direction and simultaneously elevating or lowering the payload lift apparatus, or
elevating or lowering the payload lift apparatus alone without vehicle movement in either forward direction or reverse direction.

Aspect 59: A computer-implemented method for inching a vehicle in a controlled manner, wherein the vehicle comprises an engine coupled to an infinitely variable transmission (IVT) having a ball-planetary variator (CVP), a plurality of sensors, and a computer-implemented system comprising
a digital processing device comprising an operating system configured to perform executable instructions and a memory device, and
a computer program including the instructions executable by the digital processing device, wherein the computer program comprises a software module;

the method comprising: controlling an inching maneuver of the vehicle by
one or more of the plurality of sensors sensing vehicle parameters comprising: a vehicle direction, a vehicle speed, a brake pedal position, an accelerator pedal position, a CVP input speed, a CVP output speed, an IVT output speed, an engine speed, and a CVP shift position;
the software module monitoring the CVP shift position, a speed ratio of the CVP based on the CVP input speed and the CVP output speed, and an overspeed condition of the engine based one or more of the vehicle parameters sensed by the sensors;
commanding a first change in the engine speed and controlling an engine torque based at least in part on the vehicle direction, the vehicle speed, and the accelerator pedal position sensed by the sensors; and
commanding a second change in the CVP shift position based at least in part on the brake pedal position sensed by one or more of the sensors.

Aspect 60: The method of Aspect 59, comprising activating the software module when the sensors detect a minimum position setting for both the brake pedal position and the accelerator pedal position.

Aspect 61: The method of Aspect 59or 60, comprising the software module commanding an engine speed override limit to reduce the engine torque if the vehicle speed is in excess of a speed limit set for the inching maneuver mode when transitioning into the inching maneuver mode.

Aspect 62: The method of any one of Aspects 59-61, comprising adjusting the second change towards an IVT speed ratio zero condition as a value of the brake pedal position increases.

Aspect 63: The method of any one of Aspects 59-62, comprising adjusting the second change to the IVT speed ratio zero condition when the brake pedal position reaches or exceeds a maximum inching position threshold value regardless of the accelerator pedal position.

Aspect 64: The method of any one of Aspects 59-63, comprising generating an effective inching maneuver range between a minimum threshold value of the brake pedal position and maximum threshold value of the brake pedal position.

Aspect 65: The method of any one of Aspects 59-64, wherein controlling the inching maneuver occurs when the brake pedal position exceeds the maximum threshold value brake pedal position.

Aspect 66: The method of any one of Aspects 59-65, wherein a hysteresis scheme is implemented to prevent excessive switching in the CVP shift position due to small oscillations in the brake pedal position.

Aspect 67: The method of any one of Aspects 59-66, wherein the maximum threshold value of the brake pedal position exists when a set of wheel brakes are engaged hard enough to prevent the vehicle from moving from a stand-still position.

Aspect 68: The method of any one of Aspects 59-67, wherein the brake pedal position between the maximum threshold value and a fully depressed brake pedal position will generate a reference shift position that is saturated to zero.

Aspect 69: The method of any one of Aspects 59-68, wherein controlling the inching maneuver occurs in a forward or reverse vehicle direction.

Aspect 70: The method of any one of Aspects 59-69, wherein the CVP shift position takes on a negative value when the method is performed in a reverse vehicle direction.

Aspect 71: The method of any one of Aspects 59-70, wherein the second change is a calibrateable value stored in the memory device.

Aspect 72: The method of any one of Aspects 59-71, wherein controlling the inching maneuver occurs when initiated by an operator while the vehicle is not moving.

Aspect 73: The method of any one of Aspects 59-72, wherein controlling the inching maneuver occurs when initiated by an operator while the vehicle is moving.

Aspect 74: The method of any one of Aspects 59-73, wherein controlling the inching maneuver occurs when:
the vehicle speed is within a first preset limit less than a full operation speed,
the engine speed within a second preset limit that will safely produce torque deliverable to the CVP that will allow a safe change in the CVP shift position,
the sensors sense the vehicle direction,
the sensors sense the CVP shift position,
the accelerator pedal position is at a first minimum setting greater than zero, and
the brake pedal position is at a second minimum setting greater than zero.

Aspect 75: The method of any one of Aspects 59-74, wherein:
the first minimum setting for the accelerator pedal position (APP) 5%; and
the second minimum setting for the brake pedal position (BPP) is greater than 6%.

Aspect 76: The method of any one of Aspects 59-75, wherein controlling the inching maneuver comprises:
moving the vehicle in a forward direction; or
moving the vehicle in a reverse direction; or
moving the vehicle in either forward direction or reverse direction and simultaneously elevating or lowering a payload lift apparatus; or
elevating or lowering the payload lift apparatus alone without moving the vehicle in either a forward direction or a reverse direction.

Aspect 77: A computer-implemented control system for controlling a speed ratio droop of an infinitely variable transmission (IVT) having a ball planetary variator (CVP) operably coupled to gears, said IVT operably coupled to an engine of a vehicle, the computer-implemented control system comprising:

a digital processing device comprising an operating system configured to perform executable instructions and a memory device;

a computer program including the instructions executable by the digital processing device, the computer program comprising a software module configured to control the engine and the CVP;
a plurality of sensors comprising:
   a CVP input speed sensor configured to sense a CVP input speed and provide the CVP input speed to the software module, and
   a CVP output speed sensor configured to sense a CVP output speed and provide the CVP output speed to the software module, wherein the software module determines a current CVP speed ratio based on the CVP input speed and the CVP output speed, and
   a CVP shift position sensor adapted to sense a current CVP shift position and provide the current CVP shift position to the software module, wherein the software module calculates a speed ratio droop based on the CVP input speed, the CVP output speed, and the CVP shift position;
   wherein the software module is configured to compare the speed ratio droop to a first warning fault threshold, wherein the first warning fault threshold is a calibrateable parameter stored in the memory device;
   wherein the software module is configured to detect a gross slip of the ball planetary variator by comparing the speed ratio droop to a second (critical) warning fault threshold, wherein the second (critical) warning fault threshold is a calibrateable parameter stored in the memory device;
   wherein the software module transmits a first command for a change in the CVP shift position based on the comparison of the speed ratio droop to the first warning fault threshold and the second (critical) warning fault threshold;
   wherein the software module transmits a second command for a change in CVP input speed based on the comparison of the speed ratio droop signal to the first warning fault threshold; and
   wherein the software module transmits a third command to shut down the vehicle and disengage the IVT from the downstream drivetrain based on the comparison of the speed ratio droop signal to the second warning fault threshold.

Aspect 78: The computer-implemented control system of Aspect 77, wherein the speed ratio droop module regulates the input power to the IVT by issuing an engine torque-speed limit override command (TSC1 CAN) to a vehicle electronic control unit provided on the vehicle, wherein the vehicle electronic control unit commands an adjustment to a plurality control parameters to thereby limit the power produced by the engine per the TSC1 request to regulate the speed ratio droop.

Aspect 79: The computer-implemented control system of any one of Aspects 77-78, wherein an engine torque-speed limit is set to a current measured engine speed at which the first warning fault threshold was detected.

Aspect 80: The computer-implemented control system of any one of Aspects 77-78, wherein the first warning fault threshold is a warning, which occurs if: |δ_{droop}|>ε_{w}, continuously over a period of Δt_{w} seconds, wherein ε_{w} is a warning speed ratio droop threshold parameter.

Aspect 81: The computer-implemented control system of any one of Aspects 77-80, wherein the default value for ε_{w} is a nominal value within a range of about 0.04 and 0.15 and the default value for the time threshold Δt_{w} is a nominal value within a range of about 0.15 sec and 0.5 sec.

Aspect 82: The computer-implemented control system of any one of Aspects 77-81, wherein the speed ratio droop is monitored to determine if the speed ratio droop continues to exceed the warning speed ratio droop threshold ∈_{w} and wherein if the speed ratio droop continues to exceed ∈_{w}, then an engine torque-speed limit value is decremented at a rate within a range of about 200-600 rpm/sec depending on the current engine speed.

Aspect 83: The computer-implemented control system of any one of Aspects 77-82, wherein the speed ratio droop is monitored to determine if the speed ratio droop falls below ∈_{w}, and wherein if the speed ratio droop falls below ∈_{w}, then the engine torque-speed limit value is incremented at a rate within a range of about 40 to 100 rpm/sec. depending on the current engine speed.

Aspect 84: The computer-implemented control system of any one of Aspects 77-83, wherein the engine torque-speed limit value is monitored to determine when it reaches a max threshold, wherein the engine torque-speed override command is removed.

Aspect 85: The computer-implemented control system of any one of Aspects 77-84, wherein when the engine torque-speed override command is removed, the speed ratio droop regulation process is complete.

Aspect 86: The computer-implemented control system of any one of Aspects 77-85, wherein the second (critical) warning fault threshold is a warning which occurs if:
   |δ_{droop}|>ε_{c}, continuously over a period of Δt_{c} seconds, wherein ε_{c} is the second (critical) speed ratio droop threshold parameter.

Aspect 87: The computer-implemented control system of any one of Aspects 77-86, wherein the default value for ε_{c} is a nominal value within a range of about 0.04 and 0.20 and the default value for the time threshold Δt_{c} is a nominal value within a range of about 0.15 sec and 0.5 sec.

Aspect 88: The computer-implemented control system of any one of Aspects 77-87, wherein when the second (critical) warning fault threshold is detected, the vehicle is shut down and the IVT is disengaged from a downstream drivetrain.

Aspect 89: A computer-implemented method for regulating an engine torque-speed limit of a vehicle and a speed ratio droop an infinitely variable transmission (IVT) having a ball planetary variator (CVP) operably coupled to gears, said IVT operably coupled to an engine of the vehicle, the vehicle comprising a plurality of sensors and a computer-implemented system comprising
a digital processing device comprising an operating system configured to perform executable instructions and a memory device, and
a computer program including the instructions executable by the digital processing device, wherein the computer program comprises a software module configured to control the engine and the CVP,

the method comprising controlling the engine and the CVP by:
the software module receiving a plurality of signals from one or more sensors reflecting vehicle parameters sensed by the one or more sensors, the vehicle parameters comprising a CVP input speed, a CVP output speed, and a current CVP shift position;
calculating a speed ratio droop of the ball planetary variator based on the CVP input speed, the CVP output speed, and the current CVP shift position;
comparing the speed ratio droop to a first warning fault threshold, wherein the first warning fault threshold is a calibrateable parameter stored in the memory device;
comparing the speed ratio droop to a second (critical) warning fault threshold, wherein the second (critical) warning fault threshold is a calibrateable parameter stored in the memory device; and
transmitting a first command for a change in the CVP shift position based on the comparison of the speed ratio droop to the first warning fault threshold and the second (critical) warning fault threshold; and
transmitting a second command for a change in the CVP input speed based on the comparison of the speed ratio droop signal to the first warning fault threshold.

Aspect 90: The computer-implemented method of Aspect 89, further comprising:
measuring the speed ratio droop of the ball planetary variator (CVP) and comparing the speed ratio droop to a first warning fault threshold;
regulating the speed ratio droop of the ball planetary variator (CVP) based on the first comparison;
detecting gross slip based on a second comparison of the speed ratio droop to a second (critical) warning fault threshold; and
further regulating the speed ratio droop of the ball planetary variator (CVP) based on the second comparison.

Aspect 91: The computer-implemented method of Aspects 89 or 90, comprising regulating the input power to the IVT by issuing an engine torque-speed limit override command to the electronic control unit, which commands a plurality of control signals to the engine and limits the power from the engine per the TSC1 request to regulate the speed ratio droop.

Aspect 92: The computer-implemented method of any one of Aspects 89, 90, or 91, wherein an engine torque-speed limit is set to a current measured engine speed at which a first warning fault threshold was detected.

Aspect 93: The computer-implemented method of any one of Aspects 89-92, wherein the first warning fault threshold is a warning which occurs if:
   |δ_{droop}|>ε_{w}, continuously over a period of Δt_{w} seconds, wherein ε_{w} is a warning speed ratio droop threshold parameter.

Aspect 94: The computer-implemented method of any one of Aspects 89-93, wherein a first default value for ε_{w} is a first nominal value within a first range of about 0.04 and 0.15 and a second default value for a time threshold Δt_{w} is a second nominal value within a second range of about 0.15 sec and 0.5 sec.

Aspect 95: The computer-implemented method of any one of Aspects 89-94, comprising monitoring the speed ratio droop to determine if the speed ratio droop continues to exceed the first default value ∈_{w} and wherein if the speed ratio droop continues to exceed ∈_{w}, then the engine torque-speed limit value is decremented at a rate within a range of about 200-600 rpm/sec depending on a current speed of the engine.

Aspect 96: The computer-implemented method of any one of Aspects 89-95, wherein the speed ratio droop is monitored to determine if the speed ratio droop falls below the first default value ∈_{w}, and wherein if the speed ratio droop falls below ∈_{w}, then the engine torque-speed limit value is incremented at a rate within a range of about 40 to 100 rpm/sec. depending on a current speed of the engine.

Aspect 97: The computer-implemented method of any one of Aspects 89-96, wherein the second (critical) warning fault threshold occurs if: |δ_{droop}>ε_{c} continuously over a period of Δt_{c} seconds, wherein ε_{c} is a second (critical) speed ratio droop threshold parameter.

Aspect 98: The computer-implemented method of any one of Aspects 89-97, wherein a first default value for ε_{c} is a first nominal value within a range of about 0.04 and 0.20 and a second default value for the time threshold Δt_{c} is a second nominal value within a range of about 0.15 sec and 0.5 sec.

Aspect 99: The computer-implemented control method of any one of Aspects 89-98, wherein when the second (critical) warning fault threshold is detected, the vehicle is shut down and the Infinite Variable Transmission (IVT) is disengaged from a downstream drivetrain.

Aspect 100: A computer-implemented control system for a vehicle having an engine coupled to an infinitely variable transmission having a ball-planetary variator (CVP), the computer-implemented control system comprising:
a digital processing device comprising an operating system configured to perform executable instructions and a memory device;
a computer program including the instructions executable by the digital processing device, the computer program comprising a software module configured to control a plurality of operating conditions of the CVP;
a plurality of sensors comprising:
   a vehicle direction sensor configured to sense a direction of the vehicle and provide the vehicle direction to the software module,
   a vehicle speed sensor configured to sense a vehicle speed and provide the vehicle speed to the software module,
   a brake pedal position sensor configured to sense a brake pedal position and provide the brake pedal position to the software module,
   an accelerator pedal position sensor configured to sense an accelerator pedal position and provide the accelerator pedal position to the software module,
   an engine speed sensor configured to sense an engine speed and provide the engine speed to the software module,
   a CVP input speed sensor configured to sense a CVP input speed and provide the CVP input speed to the software module, and
   a CVP output speed sensor configured to sense a CVP output speed and provide the CVP output speed to the software module, wherein the software module determines a current CVP speed ratio based on the CVP input speed and the CVP output speed,
wherein the software module is configured to determine a target CVP speed ratio signal based on the accelerator pedal position, wherein the software module is configured to transmit a commanded CVP speed ratio signal based on the target CVP speed ratio signal to thereby adjust the operating condition of the CVP, wherein the software module comprises:
   a normal operation control sub-module configured to calculate the target CVP speed ratio based on the vehicle speed and the accelerator pedal position;
   an inching control sub-module configured to calculate the target CVP speed ratio based on the vehicle direction, the brake pedal position, and the engine speed;
   a power reversal control sub-module configured to calculate the target CVP speed ratio based on the current CVP speed ratio and the engine speed; and
   an automatic deceleration control sub-module configured to calculate the target CVP speed ratio based on the current CVP speed ratio, the vehicle speed, and the engine speed.

Aspect 101: The computer-implemented control system of Aspect 100, wherein the software module further comprises a transition control sub-module configured to calculate the target CVP speed ratio based on the engine speed and the current CVP speed ratio.

Aspect 102: The computer-implemented control system of Aspects 100 or 101, wherein the software module further comprises a hold control sub-module configured to calculate a target CVP speed ratio based on the accelerator pedal position, the brake pedal position, and the vehicle speed.

Aspect 103: The computer-implemented control system of any one of Aspect 100-102, wherein the software module further comprises a vehicle braking control sub-module configured to calculate a target CVP speed ratio based on the brake pedal position , the vehicle direction , and the current CVP speed ratio.

Aspect 104: The computer-implemented control system of any one of Aspect 100-103, wherein the normal operation control sub-module comprises a driving ratio map configured to determine a target CVP speed ratio based at least in part on the accelerator pedal position and the vehicle speed.

Aspect 105: The computer-implemented control system of any one of Aspect 100-104, wherein the normal operation control sub-module comprises a rate limit function configured to limit a rate of change of the target CVP speed ratio based at least in part on the vehicle speed.

Aspect 106: The computer-implemented control system of any one of Aspect 100-105, wherein the power reversal control sub-module further comprises an engine overspeed protection sub-module configured to command a hold of the commanded CVP speed ratio based at least in part on the engine speed and the vehicle direction.

Aspect 107: The computer-implemented control system of any one of Aspect 100-106, wherein the inching control sub-module comprises at least one calibration table defining a relationship between the brake pedal position and the vehicle speed.

Aspect 108: The computer-implemented control system of any one of Aspect 100-107, wherein the inching control sub-module comprises a function configured to determine the target CVP speed ratio based at least in part on a target vehicle speed and the engine speed.

Aspect 109: The computer-implemented control system of any one of Aspect 100-108, wherein the inching control sub-module comprises a rate limit function configured to limit a rate of change of the target CVP speed ratio based at least in part on the vehicle speed.

Aspect 110: The computer-implemented control system of any one of Aspect 100-109, wherein the automatic deceleration control sub-module comprises an engine overspeed protection sub-module configured to command a hold of the commanded CVP speed ratio based at least in part on the engine speed and the vehicle direction.

Aspect 111: The computer-implemented control system of any one of Aspect 100-110, wherein the automatic deceleration control sub-module comprises a rate limit function configured to limit a rate of change of the target CVP speed ratio based at least in part on the vehicle speed.

Aspect 112: The computer-implemented control system of any one of Aspect 100-111, wherein the vehicle direction, vehicle speed, brake pedal position, and accelerator pedal position are received from a vehicle CAN bus.

Aspect 113: The computer-implemented control system of any one of Aspect 100-112, wherein the normal operation control sub-module comprises a vehicle speed calibration map, the vehicle speed calibration map configured to store values of a target vehicle speed based at least in part on the accelerator pedal position.

Aspect 114: The computer-implemented control system of any one of Aspect 100-113, wherein the normal operation control sub-module comprises an engine speed calibration map, the engine speed calibration map configured to store values of a target engine speed based at least in part on the accelerator pedal position.

Aspect 115: The computer-implemented control system of any one of Aspect 100-114, wherein the inching control sub-module comprises an engine speed calibration map, the engine speed calibration map configured to store values for a target engine speed based at least in part on the accelerator pedal position.

Aspect 116: The computer-implemented control system of any one of Aspect 100-115, wherein the power reversal control sub-module comprises an engine speed calibration map, the engine speed calibration map configured to store values of a target engine speed based at least in part on the accelerator pedal position.

Aspect 117: The computer-implemented control system of any one of Aspect 100-116, wherein the transition control sub-module comprises an engine speed calibration map, the engine speed calibration map configured to store values for a target engine speed based at least in part on the accelerator pedal position.

Aspect 118: The computer-implemented control system of any one of Aspect 100-117, wherein the inching control sub-module further comprises an inching shift rate calibration map, the inching shift rate calibration map configured to store values of a commanded shift rate based at least in part on a shift error, wherein the shift error is calculated by the software module based at least in part on the current CVP speed ratio.

Aspect 119: The computer-implemented control system of any one of Aspect 100-118, wherein the normal operation control sub-module further comprises an inching shift rate calibration map, the inching shift rate calibration map configured to store values of a commanded shift rate based at least in part on a shift error, wherein the shift error is calculated by the software module based at least in part on the current CVP speed ratio.

Aspect 120: The computer-implemented control system of any one of Aspect 100-119, wherein the power reversal control sub-module further comprises a plurality of shift rate calibration maps, each shift rate calibration map configured to store values of a commanded shift rate based at least in part on a vehicle speed and a shift rate level, wherein the shift rate level is a calibratable value stored in the memory device.

Aspect 121: A computer-implemented system for controlling an auto-deceleration of a vehicle having an engine coupled to an infinitely variable transmission having a ball-planetary variator (CVP), the computer-implemented system comprising:
a digital processing device comprising an operating system configured to perform executable instructions and a memory device;
a computer program including the instructions executable by the digital processing device, the computer program comprising a software module configured to control the auto-deceleration of the vehicle;
a plurality of sensors comprising:
   a vehicle speed sensor adapted to sense a vehicle speed and provide the vehicle speed to the software module,
   a brake pedal position sensor adapted to sense a brake pedal position and provide the brake pedal position to the software module,
   an accelerator pedal position sensor adapted to sense an accelerator pedal position and provide an accelerator pedal position to the software module,
   an engine speed sensor adapted to sense an engine speed and provide an engine speed to the software module,
   a CVP input speed sensor configured to sense a CVP input speed and provide the CVP input speed to the software module, and
   a CVP output speed sensor configured to sense a CVP output speed and provide the CVP output speed to the software module, wherein the software module determines a current CVP speed ratio based on the CVP input speed and the CVP output speed,
wherein the software module determines a commanded CVP speed ratio during the auto-deceleration of the vehicle, wherein the commanded CVP speed ratio signal is based on a current operating state of vehicle, the vehicle speed, the brake pedal position, the accelerator pedal position, the engine speed, and the current CVP speed ratio; and
wherein the software module is configured to control the current speed ratio of CVP based on the commanded CVP speed ratio.

Aspect 122: The computer-implemented system of Aspect 121, wherein the vehicle direction, vehicle speed, brake pedal position, and accelerator pedal position are received from a vehicle CAN bus.

Aspect 123: The computer-implemented system of Aspects 121 or 122, wherein the software module further comprises a rate limit function configured to limit a rate of change of the commanded CVP speed ratio based at least in part on the vehicle speed.

Aspect 124: A computer-implemented system for changing direction of a vehicle having an engine coupled to an infinitely variable transmission having a ball-planetary variator (CVP), the computer-implemented system comprising:
a digital processing device comprising an operating system configured to perform executable instructions and a memory device;
a computer program including the instructions executable by the digital processing device, the computer program comprising a software module configured to control the change of direction of the vehicle;
a plurality of sensors comprising:
   a vehicle direction sensor adapted to sense a vehicle direction and provide the vehicle direction to the software module,
   a vehicle speed sensor adapted to sense a vehicle speed and provide the vehicle speed to the software module,
   an engine speed sensor adapted to sense an engine speed and provide the engine speed to the software module,
   a CVP input speed sensor configured to sense a CVP input speed and provide the CVP input speed to the software module, and
   a CVP output speed sensor configured to sense a CVP output speed and provide the CVP output speed to the software module, wherein the software module determines a current CVP speed ratio based on the CVP input speed and the CVP output speed,
wherein the software module determines a commanded CVP speed ratio during the change of the direction of the vehicle, wherein the commanded CVP speed ratio is based at least in part on the vehicle direction, the vehicle speed, the engine speed, and the current CVP speed ratio;
wherein the software module is configured to command an engine speed limit based at least in part on the vehicle direction and the vehicle speed; and
wherein the software module is configured to control the current speed ratio of CVP based on the commanded CVP speed ratio.

Aspect 125: The computer-implemented system of Aspect 124, wherein the vehicle speed is received from a vehicle CAN bus.

Aspect 126: The computer-implemented system of Aspects 124 or 125, wherein the software module further comprises a rate limit function configured to limit a rate of change of the commanded CVP speed ratio based at least in part on the vehicle speed.

Aspect 127: A computer-implemented system for generating an inching maneuver mode in a vehicle having an engine coupled to an infinitely variable transmission having a ball-planetary variator (CVP), the computer-implemented system comprising:
a digital processing device comprising an operating system configured to perform executable instructions and a memory device;
a computer program including the instructions executable by the digital processing device, the computer program comprising a software module configured to control the vehicle during the inching maneuver;
a plurality of sensors comprising:
   a vehicle direction sensor adapted to sense a vehicle direction and provide the vehicle direction to the software module,
   a brake pedal position sensor adapted to sense a brake pedal position and provide the brake pedal position to the software module,
   an engine speed sensor adapted to sense an engine speed and provide the engine speed to the software module,
wherein the software module determines a commanded CVP speed ratio during the inching maneuver, wherein the commanded CVP speed ratio is based at least in part on the vehicle direction, the brake pedal position, the accelerator pedal position, and the engine speed; and
wherein the software module is configured to control the CVP based on the commanded CVP speed ratio.

Aspect 128: The computer-implemented system of Aspect 127, wherein the vehicle direction and brake pedal position are received from a vehicle CAN bus.

Aspect 129: The computer-implemented system of Aspects 127 or 128, wherein the software module further comprises a rate limit function configured to limit a rate of change of the commanded CVP speed ratio based at least in part on the vehicle speed.

Aspect 130: A computer-implemented control system for regulating a deceleration of a vehicle having an engine coupled to an infinitely variable transmission (IVT) having a ball-planetary variator (CVP), the computer-implemented control system comprising:
a digital processing device comprising an operating system configured to perform executable instructions and a memory device;
a computer program including the instructions executable by the digital processing device, the computer program comprising a software module configured to control vehicle deceleration;
a plurality of sensors comprising:
   a vehicle speed sensor adapted to sense a vehicle speed and provide the vehicle speed to the software module,
   a brake pedal position sensor adapted to sense a brake pedal position and provide the brake pedal position to the software module,
   a CVP input speed sensor configured to sense a CVP input speed and provide the CVP input speed to the software module, and
   a CVP output speed sensor configured to sense a CVP output speed and provide the CVP output speed to the software module, wherein the software module determines a current CVP speed ratio based on the CVP input speed and the CVP output speed;
wherein the software module determines a commanded CVP speed ratio during the deceleration of the vehicle, wherein the commanded CVP speed ratio is based at least in part on the vehicle speed and the brake pedal position; and
wherein the software module is configured to control the CVP based on the commanded CVP speed ratio.

Aspect 131: The computer-implemented system of Aspect 130, wherein the vehicle speed and brake pedal position are received from a vehicle CAN bus.

Aspect 132: The computer-implemented system of Aspects 130 or 131, wherein the software module further comprises a rate limit function configured to limit a rate of change of the commanded CVP speed ratio based at least in part on the vehicle speed.

1-33 (canceled)

34. A method for changing direction of a vehicle comprising an engine coupled to an infinitely variable transmission (IVT) having a ball-planetary variator (CVP), a direction switch, a plurality of sensors, and a computer-implemented system, the method comprising changing direction of the vehicle by:
receiving signals from the direction switch indicating a desired vehicle direction;
receiving signals from one or more of the sensors configured to sense a current vehicle direction, a vehicle speed, a brake pedal position, an accelerator pedal position, an engine speed, and a CVP shift position;
detecting a power reversal condition based on the desired vehicle direction, the vehicle speed, the brake pedal position, the accelerator pedal position, the engine speed and the CVP shift position;
commanding an engine speed limit based at least in part on the current vehicle direction, the vehicle speed, the accelerator pedal position, and the brake pedal position;
monitoring an overspeed condition of the engine; and
commanding a change in the CVP shift position based at least in part on the engine speed.

35. The method of claim 34, wherein commanding a change in CVP shift position comprises adjusting the engine speed below the overspeed condition.

36. The method of claim 34, wherein the change in CVP shift position is an incremental value or amount based on a desired deceleration rate.

37. The method of claim 36, wherein the desired deceleration rate is a user adjustable input value.

38. The method of claim 34, wherein the change in the CVP shift position is based at least in part on the accelerator pedal position.

39. The method of claim 34, wherein the change in the CVP shift position is a calibrateable value.

40. The method of claim 34, further comprising commanding an engine speed corresponding to an engine idle speed and reducing engine torque transmitted to the infinitely variable transmission.

41. The method of claim 34, wherein the method further comprises initiating a change of direction of the vehicle by an operator of the vehicle while the vehicle is moving.

42. The method of claim 41, wherein the change of direction of the vehicle is initiated when signals received from the direction switch and the sensors comprises:
an operator-commanded change in direction, the accelerator pedal position being greater than zero, and the brake pedal position being equal to zero.

43. The method of claim 41, wherein the operator-commanded change in direction comprises:
movement of the vehicle in a forward direction and the direction switch is set to reverse by the operator, or
movement of the vehicle in a reverse direction and the direction switch is set to forward by the operator, or
movement of the vehicle is either in the forward direction or the reverse direction and the direction switch is set to neutral by the operator.

44. A computer-implemented system for changing direction of a vehicle having an engine coupled to an infinitely variable transmission having a ball-planetary variator (CVP), the computer-implemented system comprising:
a digital processing device comprising an operating system configured to perform executable instructions and a memory device;
a computer program including the instructions executable by the digital processing device, the computer program comprising a software module configured to control the change of direction of the vehicle;
a plurality of sensors comprising:
a vehicle direction sensor adapted to sense a vehicle direction and provide the vehicle direction to the software module,
a vehicle speed sensor adapted to sense a vehicle speed and provide the vehicle speed to the software module,
an engine speed sensor adapted to sense an engine speed and provide the engine speed to the software module,
a CVP input speed sensor configured to sense a CVP input speed and provide the CVP input speed to the software module, and
a CVP output speed sensor configured to sense a CVP output speed and provide the CVP output speed to the software module, wherein the software module determines a current CVP speed ratio based on the CVP input speed and the CVP output speed,
wherein the software module determines a commanded CVP speed ratio during the change of the direction of the vehicle, wherein the commanded CVP speed ratio is based at least in part on the vehicle direction, the vehicle speed, the engine speed, and the current CVP speed ratio;
wherein the software module is configured to command an engine speed limit based at least in part on the vehicle direction and the vehicle speed; and
wherein the software module is configured to control the current speed ratio of CVP based on the commanded CVP speed ratio.

45. The computer-implemented system of claim 44, wherein the vehicle speed is received from a vehicle CAN bus.

46. The computer-implemented system of claim 44, wherein the software module further comprises a rate limit function configured to limit a rate of change of the commanded CVP speed ratio based at least in part on the vehicle speed.

47. A computer-implemented control system for a vehicle having an engine coupled to an infinitely variable transmission having a ball-planetary variator (CVP), the computer-implemented control system comprising:
a digital processing device comprising an operating system configured to perform executable instructions and a memory device;
a computer program including the instructions executable by the digital processing device, the computer program comprising a software module configured to control a plurality of operating conditions of the CVP;
a plurality of sensors comprising:
a vehicle direction sensor configured to sense a direction of the vehicle and provide the vehicle direction to the software module,
a vehicle speed sensor configured to sense a vehicle speed and provide the vehicle speed to the software module,,
a brake pedal position sensor configured to sense a brake pedal position and provide the brake pedal position to the software module,
an accelerator pedal position sensor configured to sense an accelerator pedal position and provide the accelerator pedal position to the software module,
an engine speed sensor configured to sense an engine speed and provide the engine speed to the software module,
a CVP input speed sensor configured to sense a CVP input speed and provide the CVP input speed to the software module, and
a CVP output speed sensor configured to sense a CVP output speed and provide the CVP output speed to the software module, wherein the software module determines a current CVP speed ratio based on the CVP input speed
and the CVP output speed,
wherein the software module is configured to determine a target CVP speed ratio signal based on the accelerator pedal position, wherein the software module is configured to transmit a commanded CVP speed ratio signal based on the target CVP speed ratio signal to thereby adjust the operating condition of the CVP, wherein the software module comprises:
a normal operation control sub-module configured to calculate the target CVP speed ratio based on the vehicle speed and the accelerator pedal position;
an inching control sub-module configured to calculate the target CVP speed ratio based on the vehicle direction, the brake pedal position, and the engine speed;
a power reversal control sub-module configured to calculate the target CVP speed ratio based on the current CVP speed ratio and the engine speed; and
an automatic deceleration control sub-module configured to calculate the target CVP speed ratio based on the current CVP speed ratio, the vehicle speed, and the engine speed.

48. The computer-implemented control system of claim 47, wherein the power reversal control sub-module further comprises an engine overspeed protection sub-module configured to command a hold of the commanded CVP speed ratio based at least in part on the engine speed and the vehicle direction.

49. The computer-implemented control system of claim 47, wherein the power reversal control sub-module comprises an engine speed calibration map, the engine speed calibration map configured to store values of a target engine speed based at least in part on the accelerator pedal position.

50. The computer-implemented control system of claim 47, wherein the power reversal control sub-module further comprises a plurality of shift rate calibration maps, each shift rate calibration map configured to store values of a commanded shift rate based at least in part on a vehicle speed and a shift rate level, wherein the shift rate level is a calibratable value stored in the memory device.

51. A computer-implemented system for changing direction of a vehicle having an engine coupled to an infinitely variable transmission having a ball-planetary variator (CVP), the computer-implemented system comprising:
a digital processing device comprising an operating system configured to perform executable instructions and a memory device;
a computer program including the instructions executable by the digital processing device, the computer program comprising a software module configured to control the change of direction of the vehicle;
a plurality of sensors comprising:
a vehicle direction sensor adapted to sense a vehicle direction and provide the vehicle direction to the software module,
a vehicle speed sensor adapted to sense a vehicle speed and provide the vehicle speed to the software module,
an engine speed sensor adapted to sense an engine speed and provide the engine speed to the software module,
a CVP input speed sensor configured to sense a CVP input speed and provide the CVP input speed to the software module, and
a CVP output speed sensor configured to sense a CVP output speed and provide the CVP output speed to the software module, wherein the software module determines a current CVP speed ratio based on the CVP input speed and the CVP output speed,
wherein the software module determines a commanded CVP speed ratio during the change of the direction of the vehicle, wherein the commanded CVP speed ratio is based at least in part on the vehicle direction, the vehicle speed, the engine speed, and the current CVP speed ratio;
wherein the software module is configured to command an engine speed limit based at least in part on the vehicle direction and the vehicle speed; and
wherein the software module is configured to control the current speed ratio of CVP based on the commanded CVP speed ratio.

52. The computer-implemented system of claim 51, wherein the vehicle speed is received from a vehicle CAN bus.

53. The computer-implemented system of claim 51, wherein the software module further comprises a rate limit function configured to limit a rate of change of the commanded CVP speed ratio based at least in part on the vehicle speed.
